(19) United States
(12) Patent Application Publication
(10) Pub. No.: US 2011/0208822 A1
(43) Pub. Date: Aug. 25, 2011

(54) Method and system for customized, contextual, dynamic and unified communication, zero click advertisement and prospective customers search engine

(76) Inventor: Yogesh Chunilal Rathod, Mumbai (IN)

(21) Appl. No.: 13/032,611

(22) Filed: Feb. 22, 2011

Related U.S. Application Data
(63) Continuation-in-part of application No. 13/001,785.

(30) Foreign Application Priority Data
Feb. 22, 2010 (IN) 467/MUM/2010

(51) Int. Cl. G06F 15/16

(52) U.S. Cl. 709/206

(57) ABSTRACT

The present invention relates device, system and method for facilitating receiving active note(s) from active note(s) provider(s) from the client device and responding multidimensional active resources & actions(s) for said active note(s) by multidimensional active resources & actions(s) provider(s) to the client device. A real time and/or near real communication mechanism such as online, smart and mobile communication applications like web site, smart client, instant messaging, e-mail may be used to communicate with a client device and a community of responders or multidimensional active resources & actions(s) provider(s). One or more Active Note(s) are received from client devices, processed, and sent to responders. Responses from the responders are received, and response is sent to the client device.

### PRIORITY CLAIM

This application is a continuation-in-part application of U.S. patent application Ser. No. 13/001,785, filed on Dec. 28, 2010, which is a national stage application under 35 U.S.C. §371 of PCT application number PCT/IN2010/000122, filed on Mar. 3, 2010, which claims the benefit of Indian patent application no. 467/MUM/2010, filed on Feb. 22, 2010, the disclosures of each of which are incorporated herein by reference in their entireties.

### COPYRIGHTS INFORMATION

A portion of the disclosure of this patent document contains material that is subject to copyright protection. The copyright owner has no objection to the facsimile reproduction by anyone of the patent document or the patent disclosure, as it appears in the Patent and Trademark Office patent file, but otherwise reserves all copyright rights whatsoever. The applicant acknowledges the respective rights of various Intellectual property owners.

### FIELD OF INVENTION

The present invention relates generally to submitting active note(s) to system and system selects and/or matches relevant multidimensional active resources & actions providers(s) and route said active note(s) to said matched or selected or subscribed multidimensional active resources & actions provider(s) and facilitating said multidimensional active resources & actions providers(s) for creating multi dimensional environment based on user's profiles, updated information and historical notes or life stream related resources for interpreting user's active note(s) and based on that identifying one or more concept(s) associated with said active note(s) and providing multiple suggested resources & action(s) on each concept(s) for each said active note(s) including one or more actions, suggestions, solution, queries & answers, direction, guidance, execution plan, step by step procedures, to do, tips & tricks, more particularly, but not exclusively to using a community to provides personalized or customized multi model or multidimensional active resources & actions for active note(s). User can select or use or like or execute or follow said one or more multidimensional active resources & actions for said active note(s) and provide comments and/or assign rank(s) to said multidimensional active resources & actions and submit to the central server for making them searchable for other similar users.

### BACKGROUND OF THE INVENTION

The internet provides a number of mechanisms that allow a user to find solution for particular problems. Search engines allow a user to search for web pages by using keywords or other criteria. A search engine typically uses algorithms to retrieve and order relevant results, such as web pages or other documents. Typically, a user of a search engine reads one or more of the document results, in order to determine the solution to a particular problem.

Many types of Social networks and communication systems are facilitating users for sharing, searching, communicating and solving some problems.

Answering system in which a user may submit a question. One or more people from an answering community may submit an answer to the question. Answers can be submitted over a period of hours or days. The user can return to the site hours or days after submitting a question to view the submitted answers.

All above method required lot of efforts and user have to use proper search keyword(s) or query or question and search method and sources for finding solution. But all users are not known or able to provide all dimensions or environment or context or concept(s) related with said active note(s) and metadata or search keyword(s). But present invention creates multidimensional environment around said active note(s) or statement and multiple domain or subject specific multidimensional active resources & actions providers(s) analyze said user's active note(s) or statement(s) and provides multi dimensional analysis from multiple angels or viewpoints including creating multiple concepts and provides each relevant concept specific resources like actions, experience, how to do, when & where to go for what, questions & answers, directions, solutions, suggestions, knowledge, information, tips & tricks, procedures, helps, executing actions. Therefore, it is with respect to these considerations and others that the present invention has been made.

### OBJECT OF THE INVENTION

The principal object of the present invention is to recording each user's or any types of entity's life stream as per taxonomy classification or categories with metadata including all useful information & knowledge, experience, domain specific profiles, comments, reviews, messages, blogs, articles, book marks, problems and related solutions, day to day notes related to health (all types of personal health reports, medicines used, information & experience related to hospitals, doctors, dispensaries, medical store etc.), education (school, college, class, courses, results, awards or achievements etc.), travel (experience, locations, flights, tours, hotels, motels, restaurants, foods, visiting tourist places, problem faced and solution, best things), entertainment, jobs (about all employers, job experience, co-workers or professionals, clients experience, each problems and solutions), business (start to current related to experience, execution, clients, workers or staffs related, growth, each problems and related one or more solutions), events, parties, participations, sports (sports likes, clubs, events, participation, achievements), hobbies, story, connected people like friends, family, social, class mates, co-workers or professionals, neighbors' public & shared life stream, social networks connection, products and services used (brands prefer, why, experience, best things, features, comments, reviews, price, comparison, new or useful products & services, availability etc.), shopping, money spending, news, life style, complaints, images, videos, photos, albums, presentation, flow charts, files, resources, solution or execution plan for day to day small things or problems and all active resources useful for similar or like minded users or similar activities specific users for saving users wastes of time, money, energy and resources for providing right direction in each step of life.

Another significant objective of the present invention is to provides in real or near real time relevant and useful Multidimensional Active Resources & Actions by Provider(s) to Active Note(s) Provider(s) or users including actions, what to do, better way to do, more ways, questions & related answers, answers, suggestions, solution, guidance, help, finance, supplies, information, knowledge, tips & tricks, training, learning, match making, ideas, what, where, when, why and how like information.

Yet another important objective of the present invention is to provide user's complete current environment to providers for understanding user, user's behavior, user's active note(s) or statement(s) for providing multidimensional viewpoints & active resources from plurality of providers including actions, guidance, supports, direction, helps in execution, practical information, suggestion, solution, suggested more ways, tips & tricks, complete experience for particular problem or queries or task or work or job or procedure or plan or project or business or any types of knowledge or information or resources related to before doing anything which are related to user or user's connected people or environment and thus saving user's time, money and energy.

Yet another important objective of the present invention is to provide personal and customized encyclopedia of user's each active note(s) with active resources & actions which are useful or current or live or important or active to user.

Yet another important objective of the present invention is to provide all possible concept specific ranked multidimensional active resources & actions to user(s) for each active note(s) form multiple matched sources of multidimensional active resources & actions providers comprising result-oriented actions, positive steps, active resources designed to actively promote and advance the status, any measures taken to rectify conditions, acts or deeds used to remedy a situation, remove an error, or adjust a condition, carry out a task, execute the things, planned series of actions, tasks or steps designed to achieve an objective or goal, guide the implementation or improvements of any types of process including task assignments, milestones, timelines, resource allocations, data collection methodology, and evaluation, step or series of steps to be taken, detailed description of the steps used to implement a strategic plan, a plan to determine what information is missing or pending, where and when to collect this information, and who will need the information e.g. series of instructions given by your doctor to follow based on symptoms.

Yet another important objective of the present invention is to store or update or index or create or develop all types and categories of all possible activities and related all types of actions & experience specific ontology for all types of people, companies, manufacturing, processing, education, qualification, learning, locations, languages, countries (world), religions, societies, casts, jobs, works, businesses, services, fields, career, courses, professionals, branded products and services, procedures, knowledge domains, activities, purposes, age group, income group, qualification group, hobby, interest and like.

### DETAIL DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “receiving” an item, such as a request, response, or other message, from a device or component includes receiving the message indirectly, such as when forwarded by one or more other devices or components. Similarly, “sending” an item to a device or component includes sending the item indirectly, such as when forwarded by one or more other devices or components.

As used herein, the term “client application” refers to an application that runs on a client computing device. A client application may be written in one or more of a variety of languages, such as ‘C’, ‘C'+’, ‘J2ME’, Java, ASP.Net, VB.Net and the like. Browsers, email clients, text messaging clients, calendars, and games are examples of client applications. A mobile client application refers to a client application that runs on a mobile device.

As used herein, the term “network application” refers to a computer-based application that communicates, directly or indirectly, with at least one other component across a network. Web sites, email servers, messaging servers, and game servers are examples of network applications.

Briefly stated, the present invention is directed towards providing users with quick multidimensional active resources, view points, actions and resources provided by multidimensional active resources & actions provider(s) to active note(s) provided or publish by active note(s) provider(s). Mechanisms of the invention may enable a community of responders to receive an active note(s) and submit responses or multidimensional active resources & actions. A server may receive and aggregate the responses, and send an aggregated response or multidimensional active resources & actions to the user or active note provider.

Moreover, the present invention makes use of the following terms, definitions, acronyms, and abbreviations for describing the invention or Connected Life or Multidimensional Active resources & Actions or Central Server, System, Network, Platform and Framework:

Active Note(s) OR Active Statement(s): is interpreted in multidimensional ways or modes by plurality of relevant active resources & actions providers for judging user and user's note or statement or related acts or works or tasks or procedures or goals or issues or topic or meaning or needs or problems or queries or requirements or importance or behaviors and based on that multidimensional active resources & actions providers creates or builds or invent or construct or generate multiple concepts, queries, angles and provides multiple types of viewpoints, knowledge or information or resources or directions or actions or advise or guidance or suggestions or tips & tricks or answers or solutions to users or active note(s) provider(s). Recording or storing important Active Note or Active Statement and related ranked or selected or implemented active resources & actions and details notes on executed or implemented or successfully used or acquired said resources for said active notes will create user's useful active life stream. Active Notes OR Active Statements covers every small to big important things or points or notes or events or incidence of user's (including any entity) life and providers are directed the said user for said active note(s) in each step of user's life and that active and successfully used or implements resources are useful for other similar or like minded user or user's of similar active note(s) and again that resources filtered for other similar types of users up to (N) depths or times. So complete right directions or actions for all activities are created and updated for all types of users' active note(s). User can submits any types of notes that matters to user or user's life covering what user want to do next or what user currently doing or what user in near future or in future want to do and updates active note(s) for life stream related to what currently do (progressive note), what did successfully or what was important for life stream including any types of activities or acts or actions or event or proceedings or dealings or procedures or achievements or do something, before doing or want to do, current status, before spent money, before using any brands (products & services) or things, important decisions, career, selection, match making, location updates, do something, take steps, take action, undertaking, function, perform, start something or commence and like.

Active Sub Note OR Active Sub Statement(s): is based on and relates to parent or main active note(s) and can up to (N) numbers of depths e.g. Main Active Note (1) then Sub Active Note (1.1) then Sub-Sub Active Note (1.2 to 1.N)

Active Note OR Active Statement Provider(s): Various entities may perform actions, or assume particular roles. While typically, an entity may assume a single role, the invention is not so constrained, and an entity may also assume a plurality of roles or personae. Thus, within the present invention, a “User” is an active note(s) provider or “User” is “Friends” of or “Connected” to other user or “User” is enterprise active note(s) provider's administrator or “User is “Experts” or “User” is developer of the applications and services or “User” is advertiser or content partner and like. The terms “administrator” or “admin” refer to those entities whose primary role includes managing the active note(s) and/or providing multidimensional active resources and actions, establishing the editorial workflows and/or creating accounts, and managing the life stream. The terms “end-user,” and “user” refer to those entities that may register for use of the Connected Life or Multidimensional Active Resources & Actions or Central Server or Platform or System or Network or Framework or any feature(s) or service(s) or application(s) or device(s), and typically provide “user generated contents”. While an entity typically represents a person, the invention is not so limited and including one or more individuals, team or association, collaboration of one or more pre-identified individuals and one or more entities including but not limited to company, associations, organization, professional bodies, social bodies, shops, manufacturer, wholesaler, supplier, dealers and distributor, web site, portal, research agency, governmental bodies and enterprises or an entity that exists as a particular and discrete unit. Thus, an entity may include virtually any person, group of persons, businesses, organizations, or even a computing structure including a program, or the like. Intended user or groups of individual or volunteer or experts or service providers or any entity like company or organization can register as multidimensional active resources & actions with one or more service profile(s) to the central server. Service profile may comprise one or more expertise area of provider(s), service details, service type, keywords, taxonomies, ontology, rank, points, levels, payment details, availability timings and like. Central server make said service profile(s) searchable for users or active note(s) provider(s) for subscribing or selecting or matching said one or more provider(s) for active note(s) specific multidimensional active resources & actions.

Multidimensional Active Resources & Actions: is resources provided by one or more Multidimensional Active Resources & Actions Providers based on active note(s) submit or sent or publish or advertise or broadcast or updates by active note(s) provider(s) and said active note(s) provider(s)' public or shared or selected life stream resources. Multidimensional Active Resources & Actions comprising any types of resources contributed or shared or provided by one or more Multidimensional Active Resources & Actions Providers individually or collaboratively including multiple angles of viewpoints, information, knowledge, help like finance or money or physical resources, resources related to any types of active notes including actions, activities, acts, work, task, job, order, promotion, loan or financing, e-commerce, shopping, supplies, development, production, contract, business process, knowledge process, information process, procedure, assignment, solution for problem, need, requirement, goal, target, enquiry, tracking, follow-up, presentation, sales, marketing, advertising by providing support, help, answer, feedback, reference, experience, guess, logic, consulting & advising, survey, research, analysis, data mining & processing, review, comments, ranking, guidance, opinions, decision making, comparing, planning, suggestions, tips, tricks, education, learning, training, tutoring, testing, collection, organizing, projection, referring, agent or mediation, support services, discussion, content authoring & management and like.

Multidimensional Active Resources & Actions Provider(s): is provider of Multidimensional Active Resources & Actions includes any individual or person or administrator or any entity. While an entity typically represents a person, the invention is not so limited and including one or more individuals, team or association, collaboration of one or more pre-identified individuals and one or more entities including but not limited to company, associations, organization, professional bodies, social bodies, shops, manufacturer, wholesaler, supplier, dealers and distributor, web site, portal, research agency, governmental bodies and enterprises or an entity that exists as a particular and discrete unit. Thus, an entity may include virtually any person, group of persons, businesses, organizations, or even a computing structure including a program, or the like.

Central Server or Multidimensional Active Resources & Actions Server or Connected Life Server: facilitating active note(s) provider(s) and Multidimensional Active Resources & Actions Provider(s). The main role of the central server is receiving, validating, processing, updating, storing, formatting, indexing one or more or plurality of active note(s) from plurality of active note(s) providers and route said active note(s) to selected or matched or subscribed Multidimensional Active Resources & Actions Provider(s) and receiving, validating, processing, updating, storing, indexing one or more or plurality of Multidimensional Active Resources & Actions from plurality of Multidimensional Active Resources & Actions Provider(s) and route said Multidimensional Active Resources & Actions to related active note(s) provider(s) and make all said public active note(s) and related Multidimensional Active Resources & Actions with rank and comments searchable for other users for similar active note(s) related active resources & actions.

Life Stream: is all categories active note(s) and associated one or more ranked Multidimensional Active Resources & Actions which are used or executed or best matched or preferred or selected or implemented or tried or liked or selected and satisfied to the user or selected & successfully implemented by user or choose, buy or purchase or subscribed by user including any branded or un-branded products and services, solve the user's problem(s), provides right direction or help to the user for any types of important action(s), activities, act(s), deed(s), behavior, steps, before doing, buying, subscribing, selecting, experimenting something, before going, traveling, migrating somewhere, how to do something, purpose, event, pursuit, search, match making, tracking, alerts, matter, affair, question, puzzle, doings, hobby, difficulty, trouble, struggle, decision, subject, topic, thing, problem, issue, interest, procedure(s), task(s), job(s), pastime, work(s), service(s), professional(s), occupation, business, manufacturing, processing, diversion change, alteration, transformation, shift, migration, career, goal, plan, project, target, consulting, situation, duty, mission, responsibility, function, construction, deal, transaction, arrangement, matter, operation, contract, undertaking, enterprise, scheme, development, exercises, assignment, obligation, industry, selling, marketing, production, company, firm, organization, establishment, news, travels, health, education, finance and like. Life stream covers all chronological user generated or created or provided or updated active note(s) with metadata including taxonomy categories, date & time, rank, review notes or comments and like.

Subscribe Life Stream (Following of Life Stream): User or active note(s) provider(s) can follow one or more categories of one or more life stream of one or more other like minded or matched users or connected people or active notes providers.

Subscriptions of My Life Stream (Followers of Life Stream): Other like minded or matched users or active notes providers can subscribe or follow user's one or more categories of one or more life stream with permissions. Multidimensional Active Resources & Actions Provider(s) can also follow one or more categories of one or more life stream of one or more matched users or active notes providers for providing one or more Multidimensional Active Resources & Actions for one or more active note(s) in which Multidimensional Active Resources & Actions Providers are experts or have experience in that subject or field or domain or topics or active note(s).

Life Stream List(s): is categories list of other users life stream related to particular taxonomy wise category of age groups, income range groups, professional(s), activities, actions, act(s), hobby, interest, education, qualification, work, school, college, work, task, destination, location, language, occupation, similar preferences, problems or like minded users and like. Categories Life Stream List(s) can be private or public or shared and facilitates user's to subscribe plurality of other users' life stream.

Domain Specific User's or Active Note OR Active Statement Provider's Profiles: is provided, created, submitted and updated by active note(s) provider(s) or user to the central server. Central server receives, stores, updates, validates, process and indexes all said one or more user's one or more domain or field or subject specific profile(s) and make said public profile(s) searchable for other users and Multidimensional Active Resources & Actions Provider(s). Mainly profile(s) are used for match making and understanding active note(s) or active note(s) provider(s).

Domain Specific Active Resources & Actions Provider's Profiles: is provided, created, submitted and updated by Multidimensional Active Resources & Actions Provider(s) to the central server. Central server receives, stores, updates, validates, process and indexes all said one or more Multidimensional Active Resources & Actions Provider's one or more domain or field or subject specific profile(s) and make said public profile(s) searchable for users for matching Multidimensional Active Resources & Actions Provider(s) for Multidimensional Active Resources & Actions and Multidimensional Active Resources & Actions Provider(s) for collaboration.

Applications & Services attachments with Active Resources & Actions: Multidimensional Active Resources & Actions Provider(s) can attach one or more matched or related application(s) and/or service(s) with one or more active note(s) of one or more active note(s) provider(s). E.g. active note “Travel to Goa” attached with travel related full features application(s) and service(s) like e-commerce of travel related products and services (e.g. ticket booking, books and like), travel related social network(s) and like.

Reviews or Comments on Active Note(s): User can note down each note(s) and related resource including text, messages, publications, links, video, audio, voice, photos, images, connections and make some important note(s) as active note(s) and sent to connected or subscribed or matched Multidimensional Active Resources & Actions Provider(s) for Multidimensional Active Resources & Actions which provides plurality of and multiple types of viewpoints, resources and directions. User can use or implement or experiment selected or all of the Multidimensional Active Resources & Actions and after using or implementing or experimenting said one or more Multidimensional Active Resources & Actions for said related one or more active note(s), user can assign rank and give comments or reviews to said one or more successful Multidimensional Active Resources & Actions and manually or automatically sent or submit to the central server for storing, validating, processing, updating and indexing said active note(s) and related all ranked Multidimensional Active Resources & Actions. Central server makes them searchable for other similar or like minded or similar active note(s) related users or active notes providers. So other users can get more relevant and filtered Multidimensional Active Resources & Actions from the central server's search engine. Again same procedures take place up to (N) numbers of depths and times and said filtered resources become more relevant and successful for other later users.

A typical present invention works in a following manner which is presented as example only and does not limit the scope of its working: e.g. User “Yogesh Rathod” sent or submit an Active Note: “I will visit New York City” with metadata includes date & time, one or more taxonomies, categories, details and associate user's full or partial or selected resources or links as per user's public, private and shared settings including one or more profile(s), past active note(s) and associated active resources & action(s) & related reviews, comments, ranks, status, execution details, updated information by user and like to one or more selected or subscribed or matched active resource(s) & actions provider(s). So one or more active resources & actions provider(s) can search filtered or uses all or selected said user's resources for understanding user and said active note(s) specific concepts or multi dimensional environment and can provides or suggests one or more relevant concepts specific one or more active resources & action(s) which may useful to users. So said note(s) provider(s) can get multi dimensional relevant analysis, view points or personalized or customized note(s) specific active & updated dynamic encyclopedia from plurality of sources like visa procedures, different experiences from different users for visiting New York City, suggested new products or gift items shopping addresses and features or details, best restaurant & hotels, tourist places, best season to visit, new types of activities in New York City like sports, entertainment, festival, fair, parties, programs, events, providing news related to New York City, weather conditions, about local people, business scope, job opportunities, to do at air port like shopping, food, facilities, experience, in-flight experience, clearance procedures or experience, transport related information, experience, suggestion, directions, products and services related information from brands or providers e.g. hotel or cruise booking, discounted hotels, visit advertisers hotel, buy clothes from particular mall, expert information related to particular sub-note(s) e.g. after some time user submit new sub or child note(s) related to parent note(s) like “I am pure vegetarian” and user may get suggested active resources & action(s) or multidimensional analysis like address & directions of pure vegetarian restaurants in New York city, taste and cost of foods, experience of restaurants and like for achieving goal i.e. “I am pure vegetarian and currently in New York City, so it is hard to find hotel, I am new so I do not know about food taste, food price, restaurant location and like. So said information are useful for said note(s) provider user. User use said knowledge for executing the said statements i.e. “I am pure vegetarian” and after visiting said restaurant user can provide or write comments on said note(s), assign ranks to said active resource & actions and/or active resources & actions provider(s). Central server or system receives, stores, updates, process, validates and indexes all said resources related to main and sub note(s) and make them searchable for other users or active resources providers for similar active note(s).

Another example is user “Yogesh Rathod” submits or updates or sent an Active Note: “My plan is to start software business in Mumbai” with metadata includes date & time, one or more taxonomies, categories, details and user's resources including one or more profile(s), past active note(s) and associated active multidimensional resources & action(s) and related comments, reviews, ranks, execution details, updated information by user and like to one or more selected or subscribed or matched active resource(s) & actions provider(s). So one or more active resources & actions provider(s) can search, select or filtered all said user's resources for understanding user specific multi dimensional environment and can provides or suggest one or more relevant active multidimensional resources & action(s), thus creating encyclopedia related to said main and sub note(s). So said note(s) provider can get multi dimensional relevant analysis, view points or personalized or customized note(s) specific encyclopedia from plurality of sources like manpower, salary scale of particular positions, finance, marketing, location, realty, office space, furniture, computer hardware and software for development, company procedure, NASCOM membership benefits, other employers experience and guidance, patent importance, field or domain specific resources, IT related news, products and service providers resources, further details or clarification or communication for suggesting products and services, updated information for each active resources by active resources providers.

Custom commands & search syntax: User can use one or more or group(s) or combinations or series or sequence of custom commands & syntax or command templates or scripts with search operators and parameters for searching, matching, two way matching, selecting, filtering, subscribing, mapping, downloading, accessing, invoking, programming, book marking, attaching, detaching, assigning, federating, aggregating, integrating, distributing, collaborating & communicating, composing, comparing, co-coordinating, orchestrating, choreographing, organizing, recording, configuring or customizing, classifying & grouping, connecting, disconnecting, removing, adding, alternating or changing or modifying, updating, replicating or synchronizing, transacting, binding with 3rd party applications, networks, services & devices, routing or redirecting, forwarding, transferring, merging, joining, listing, linking, arranging, scheduling, automating, sequencing and ordering as per workflow & rule based, collecting, receiving, managing, monitoring, registering, accounting & metering, reporting, logging and executing one or more or group or combinations or series or sequences of Multidimensional Active Resources & Actions Provider(s), real or near real time updated Multidimensional Active Resources & Actions, contents from database(s) and service applications from plurality of sources via command scripting language and integrate with any 3^{rd} parties applications, services, devices and networks via web services, APIs, SDK, plug-ins, plug & play and any programming & scripting languages.

User can also use one or more or combinations of search Boolean operators including AND (+), OR, NOT (−), Phrases, multiple brackets for multiple inner searches, domain specific semantic and ontology syntax and parameters including one or more domain(s) list, Multidimensional Active Resources & Actions Provider(s) list, service(s) name list, source(s) type, taxonomy categories or classification(s) or cluster(s) list, service type(s) including free or paid or sponsored, preferences including bookmark or save results or export results, rank & hits range, data range, language(s) list, location(s) list, safe search, two way match making preferences, set number of results per page & search up to number of depth(s) of sources, apply one or more filter(s) including ALL, EXACT, ANY, NONE words and one or more or combination of sorting type(s) including ascending & descending order, rank wise, category wise, date & time wise, hit wise, location wise, language wise, availability status wise, price wise (free or paid) with one or more search or command syntax string(s).

User can also concurrently searching for one or more or multiple search string(s) of one or more or multiple fields or categories or taxonomy classifications or clusters and each search results presented in one or more pages via categories tabbed interfaces and each result of each said search results comprising source URL or profile link, full or partial or abstract of content or message or multidimensional active resources & actions or resource or data or source details & URL, category, date & time, ranks & reviews, hit statistics, online status, subscription status, metadata & properties and sorting as per date & time, source, rank, hits, location, language, status and ascending & descending order and presenting individually or in one or more categories group or filtering and user can select one or more search result of said one or more search results related to said one or more search strings and take one or more group actions on said selected one or more search result(s) including bookmarking, filtering, comparing, sorting & ordering, saving, subscribing, un-subscribing, inviting for subscriptions, blocking sources, send messages.

Taxonomy wise Active Note(s) Project Management: User can use project management and workspace for managing plurality of Active Note(s) or request or communication or messaging with plurality of known as well as unknown Multidimensional Active Resources & Actions Provider(s) including searching, matching, book marking, subscribing, attaching, detaching, assigning, federating, planning, aggregating, integrating, distributing, collaborating & communicating, composing, comparing, co-coordinating, orchestrating, classifying & grouping, connecting, disconnecting, removing, adding, alternating or changing or modifying, testing or trialing, updating & upgrading, replicating or synchronizing, transacting, ranking & grading, analyzing, invoking, mapping, binding with 3^{rd} party applications, networks, services & devices, filtering, routing or redirecting, forwarding, transferring, merging, joining, listing, linking, arranging, scheduling, automating, sequencing and ordering as per workflow & rule based, choreographing, organizing, recording, configuring or customizing, collecting, receiving, selecting, assigning, managing or administrating, monitoring, programming, registering, certifying, accounting & metering, reporting, logging and subscribing plurality of services of Multidimensional Active Resources & Actions Provider(s) and said project management and workspace & workflow works in multiple users & accounts, multiple messaging to multiple users, multiple remote users, multiple roles or rights & privileges, multiple members, multiple administrators levels, multiple communication clients or applications or services or networks or devices, multiple communication & collaboration channels, multiple scaling and multiple interface styles modes.

### The Present Invention May Uses Ontology and Rule Based Systems and the Same is Described Hereunder.

Ontology ((computer science) a rigorous and exhaustive organization of some knowledge domain that is usually hierarchical and contains all the relevant entities and their relations). In computer science and information science, an ontology is a formal representation of a set of concepts within a domain and the relationships between those concepts. It is used to reason about the properties of that domain, and may be used to define the domain. In theory, ontology is a “formal, explicit specification of a shared conceptualization. An ontology provides a shared vocabulary, which can be used to model a domain—that is, the type of objects and/or concepts that exist, and their properties and relations. Ontologies are used in artificial intelligence, the Semantic Web, systems engineering, software engineering, biomedical informatics, library science, enterprise bookmarking, and information architecture as a form of knowledge representation about the world or some part of it. The creation of domain ontologies is also fundamental to the definition and use of an enterprise architecture framework.

The core meaning within computer science is a model for describing the world that consists of a set of types, properties, and relationship types. Exactly what is provided around these varies, but they are the essentials of an ontology. There is also generally an expectation that there be a close resemblance between the real world and the features of the model in an ontology. What ontology has in common in both computer science and in philosophy is the representation of entities, ideas, and events, along with their properties and relations, according to a system of categories. Historically, ontologies arise out of the branch of philosophy known as metaphysics, which deals with the nature of reality—of what exists. This fundamental branch is concerned with analyzing various types or modes of existence, often with special attention to the relations between particulars and universals, between intrinsic and extrinsic properties, and between essence and existence. The traditional goal of ontological inquiry in particular is to divide the world “at its joints”, to discover those fundamental categories, or kinds, into which the world's objects naturally fall.

Ontology components: Contemporary ontologies share many structural similarities, regardless of the language in which they are expressed. As mentioned above, most ontologies describe individuals (instances), classes (concepts), attributes, and relations. In this section each of these components is discussed in turn.

### Common Components of Ontologies Include:

Individuals: instances or objects (the basic or “ground level” objects)
Classes: sets, collections, concepts, classes in programming, types of objects, or kinds of things.
Attributes: aspects, properties, features, characteristics, or parameters that objects (and classes) can have
Relations: ways in which classes and individuals can be related to one another
Function terms: complex structures formed from certain relations that can be used in place of an individual term in a statement
Restrictions: formally stated descriptions of what must be true in order for some assertion to be accepted as input
Rules: statements in the form of an if-then (antecedent-consequent) sentence that describe the logical inferences that can be drawn from an assertion in a particular form
Axioms: assertions (including rules) in a logical form that together comprise the overall theory that the ontology describes in its domain of application. This definition differs from that of “axioms” in generative grammar and formal logic. In those disciplines, axioms include only statements asserted as a priori knowledge. As used here, “axioms” also include the theory derived from axiomatic statements.
Events: the changing of attributes or relations

Domain ontologies and upper ontologies: A domain ontology (or domain-specific ontology) models a specific domain, or part of the world. It represents the particular meanings of terms as they apply to that domain. For example the word card has many different meanings. An ontology about the domain of poker would model the “playing card” meaning of the word, while an ontology about the domain of computer hardware would model the “punch card” and “video card” meanings. An upper ontology (or foundation ontology) is a model of the common objects that are generally applicable across a wide range of domain ontologies. It contains a core glossary in whose terms objects in a set of domains can be described. Since domain ontologies represent concepts in very specific and often eclectic ways, they are often incompatible. As systems that rely on domain ontologies expand, they often need to merge domain ontologies into a more general representation. This presents a challenge to the ontology designer. Different ontologies in the same domain can also arise due to different perceptions of the domain based on cultural background, education, ideology, or because a different representation language was chosen.

At present, merging ontologies that are not developed from a common foundation ontology is a largely manual process and therefore time-consuming and expensive. Domain ontologies that use the same foundation ontology to provide a set of basic elements with which to specify the meanings of the domain ontology elements can be merged automatically. There are studies on generalized techniques for merging ontologies, but this area of research is still largely theoretical.

Present invention helps in creating and updating or developing all types and categories of human related all possible activities and related all types of actions & experience specific ontology for all types of domains, people, companies, manufacturing, processing, education, qualification, learning, locations, languages, countries (world), religions, societies, casts, jobs, works, businesses, services, fields, career, courses, professionals, branded products and services, procedures, knowledge domains, activities, purposes, age group, income group, qualification group, hobby, interest and like which are based on collaborative filtering and ranking and provides all types of human activities specific ready to use reusable list of all possible concept specific all types of actions or knowledge or suggestions or ways or directions or guidance or steps or procedures or to do and like. Various types of humans of various fields or locations or behavior or qualification or age group or income group or job or professional can do many types of day to day activities and needs solutions or tips or guidance or suggestion or helps or supports in doing each said activity of each said type of each human or individual or person or entity.

Ontology engineering (or ontology building) is a subfield of knowledge engineering that studies the methods and methodologies for building ontologies. It studies the ontology development process, the ontology life cycle, the methods and methodologies for building ontologies, and the tool suites and languages that support them. Ontology engineering aims to make explicit the knowledge contained within software applications, and within enterprises and business procedures for a particular domain. Ontology engineering offers a direction towards solving the interoperability problems brought about by semantic obstacles, such as the obstacles related to the definitions of business terms and software classes. Ontology engineering is a set of tasks related to the development of ontologies for a particular domain.

Individuals: Individuals (instances) are the basic, “ground level” components of an ontology. The individuals in an ontology may include concrete objects such as people, animals, tables, automobiles, molecules, and planets, as well as abstract individuals such as numbers and words (although there are differences of opinion as to whether numbers and words are classes or individuals). Strictly speaking, an ontology need not include any individuals, but one of the general purposes of an ontology is to provide a means of classifying individuals, even if those individuals are not explicitly part of the ontology.

Classes: Classes—concepts that are also called type, sort, category, and kind—can be defined as an extension or an intension. According to an extensional definition, they are abstract groups, sets, or collections of objects. According to an intentional definition, they are abstract objects that are defined by values of aspects that are constraints for being member of the class. The first definition of class results in ontologies in which a class is a subclass of collection. The second definition of class results in ontologies in which collections and classes are more fundamentally different. Classes may classify individuals, other classes, or a combination of both.

### Some Examples of Classes:

Person, the class of all people, or the abstract object that can be described by the criteria for being a person.
Vehicle, the class of all vehicles, or the abstract object that can be described by the criteria for being a vehicle.
Car, the class of all cars, or the abstract object that can be described by the criteria for being a car.
Class, representing the class of all classes, or the abstract object that can be described by the criteria for being a class.
Thing, representing the class of all things, or the abstract object that can be described by the criteria for being a thing (and not nothing).

Ontologies vary on whether classes can contain other classes, whether a class can belong to itself, whether there is a universal class (that is, a class containing everything), etc. Sometimes restrictions along these lines are made in order to avoid certain well-known paradoxes. The classes of an ontology may be extensional or intentional in nature. A class is extensional if and only if it is characterized solely by its membership. More precisely, a class C is extensional if and only if for any class C′, if C′ has exactly the same members as C, then C and C′ are identical. If a class does not satisfy this condition, then it is intentional. While extensional classes are more well-behaved and well-understood mathematically, as well as less problematic philosophically, they do not permit the fine grained distinctions that ontologies often need to make. For example, an ontology may want to distinguish between the class of all creatures with a kidney and the class of all creatures with a heart, even if these classes happen to have exactly the same members. In most upper ontologies, the classes are defined intentionally. Intentionally defined classes usually have necessary conditions associated with membership in each class. Some classes may also have sufficient conditions, and in those cases the combination of necessary and sufficient conditions makes that class a fully defined class.

Importantly, a class can subsume or be subsumed by other classes; a class subsumed by another is called a subclass (or subtype) of the subsuming class (or super type). For example, Vehicle subsumes Car, since (necessarily) anything that is a member of the latter class is a member of the former. The subsumption relation is used to create a hierarchy of classes, typically with a maximally general class like anything at the top, and very specific classes like 2002 Ford Explorer at the bottom. The critically important consequence of the subsumption relation is the inheritance of properties from the parent (subsuming) class to the child (subsumed) class. Thus, anything that is necessarily true of a parent class is also necessarily true of all of its subsumed child classes. In some ontologies, a class is only allowed to have one parent (single inheritance), but in most ontologies, classes are allowed to have any number of parents (multiple inheritance), and in the latter case all necessary properties of each parent are inherited by the subsumed child class. Thus a particular class of animal (HouseCat) may be a child of the class Cat and also a child of the class Pet.

A partition is a set of related classes and associated rules that allow objects to be classified by the appropriate subclass. The rules correspond with the aspect values that distinguish the subclasses from the superclasses. For example, to the right is the partial diagram of an ontology that has a partition of the Car class into the classes 2-Wheel Drive Car and 4-Wheel Drive Car. The partition rule (or subsumption rule) determines if a particular car is classified by the 2-Wheel Drive Car or the 4-Wheel Drive Car class. If the partition rule(s) guarantee that a single Car cannot be in both classes, then the partition is called a disjoint partition. If the partition rules ensure that every concrete object in the super-class is an instance of at least one of the partition classes, then the partition is called an exhaustive partition.

Attributes: Objects in an ontology can be described by relating them to other things, typically aspects or parts. These related things are often called attributes, although they may be independent things. Each attribute can be a class or an individual. The kind of object and the kind of attribute determine the kind of relation between them. A relation between an object and an attribute express a fact that is specific to the object to which it is related. For example the Ford Explorer object has attributes such as:
<has as name> Ford Explorer
<has by definition as part> door (with as minimum and maximum cardinality: 4)
<has by definition as part one of > {4.0 L engine, 4.6 L engine}
<has by definition as part> 6-speed transmission

The value of an attribute can be a complex data type; in this example, the related engine can only be one of a list of subtypes of engines, not just a single thing.

Relationships: Relationships (also known as relations) between objects in an ontology specify how objects are related to other objects. Typically a relation is of a particular type (or class) that specifies in what sense the object is related to the other object in the ontology. For example in the ontology that contains the concept Ford Explorer and the concept Ford Bronco might be related by a relation of type <is defined as a successor of>. The full expression of that fact then becomes: Ford Explorer is defined as a successor of: Ford Bronco This tells us that the Explorer is the model that replaced the Bronco. This example also illustrates that the relation has a direction of expression. The inverse expression expresses the same fact, but with a reverse phrase in natural language.

Much of the power of ontologies comes from the ability to describe relations. Together, the set of relations describes the semantics of the domain. The set of used relation types (classes of relations) and their subsumption hierarchy describe the expression power of the language in which the ontology is expressed. The most important type of relation is the subsumption relation (is-a-superclass-of, the converse of is-a, is-a-subtype-of or is-a-subclass-of). This defines which objects are classified by which class. For example we have already seen that the class Ford Explorer is-a-subclass-of 4-Wheel Drive Car, which in turn is-a-subclass-of Car: The addition of the is-a-subclass-of relationships creates a hierarchical taxonomy; a tree-like structure (or, more generally, a partially ordered set) that clearly depicts how objects relate to one another. In such a structure, each object is the ‘child’ of a ‘parent class’ (Some languages restrict the is-a-subclass-of relationship to one parent for all nodes, but many do not). Another common type of relations is the meronymy relation, written as part-of, that represents how objects combine together to form composite objects. For example, if we extended our example ontology to include concepts like Steering Wheel, we would say that a “Steering Wheel is-by-definition-a-part-of-a Ford Explorer” since a steering wheel is always one of the components of a Ford Explorer. If we introduce meronymy relationships to our ontology, we find that this simple and elegant tree structure quickly becomes complex and significantly more difficult to interpret manually. It is not difficult to understand why; a class of which is described that there is always a member that is a part of a member of another class might also have a member that is part of a member of a third class. Consequently, classes may be part of more than one whole class. The structure that emerges is known as a directed acyclic graph.

As well as the standard is-a-subclass-of and is-by-definition-a-part-of-a relations, ontologies often include additional types of relations that further refine the semantics they model. Ontologies might distinguish between different categories of relation types. For example:
relation types for relations between classes
relation types for relations between individuals
relation types for relations between an individual and a class
relation types for relations between a single object and a collection
relation types for relations between collections

Relation types are sometimes domain-specific and are then used to store specific kinds of facts or to answer particular types of questions. If the definitions of the relation types are included in an ontology, then the ontology defines its own ontology definition language. For example in the domain of automobiles, we might need a made-in type relationship which tells us where each car is built. So the Ford Explorer is made-in Louisville. The ontology may also know that Louisville is-located-in Kentucky and Kentucky is-classified-as-a state and is-a-part-of the U.S. Software using this ontology could now answer a question like “which cars are made in the U.S.?”

Controlled vocabularies provide a way to organize knowledge for subsequent retrieval. They are used in subject indexing schemes, subject headings, thesauri and taxonomies. Controlled vocabulary schemes mandate the use of predefined, authorized terms that have been preselected by the designer of the vocabulary, in contrast to natural language vocabularies, where there is no restriction on the vocabulary.

Taxonomy is the practice and science of classification. A taxonomy, or taxonomic scheme, is a particular classification (“the taxonomy of . . . ”), arranged in a hierarchical structure. Typically this is organized by supertype-subtype relationships, also called generalization-specialization relationships, or less formally, parent-child relationships. In such an inheritance relationship, the subtype by definition has the same properties, behaviors, and constraints as the supertype plus one or more additional properties, behaviors, or constraints. For example, car is a subtype of vehicle. So any car is also a vehicle, but not every vehicle is a car. Therefore, a type needs to satisfy more constraints to be a car than to be a vehicle. Almost anything—animate objects, inanimate objects, places, concepts, events, properties, and relationships—may then be classified according to some taxonomic scheme. In an even wider sense, the term taxonomy could also be applied to relationship schemes other than parent-child hierarchies, such as network structures with other types of relationships. Taxonomies may then include single children with multi-parents, for example, “Car” might appear with both parents “Vehicle” and “Steel Mechanisms”; to some however, this merely means that ‘car’ is a part of several different taxonomies. A taxonomy might also be a simple organization of kinds of things into groups, or even an alphabetical list. In current usage within Knowledge Management, taxonomies are considered narrower than ontologies since ontologies apply a larger variety of relation types. Mathematically, a hierarchical taxonomy is a tree structure of classifications for a given set of objects. It is also named Containment hierarchy. At the top of this structure is a single classification, the root node that applies to all objects. Nodes below this root are more specific classifications that apply to subsets of the total set of classified objects. The progress of reasoning proceeds from the general to the more specific.

Rule-based systems: In computer science, rule-based systems are used as a way to store and manipulate knowledge to interpret information in a useful way. They are often used in artificial intelligence applications and research. A classic example of a rule-based system is the domain-specific expert system that uses rules to make deductions or choices. For example, an expert system might help a doctor choose the correct diagnosis based on a cluster of symptoms, or select tactical moves to play a game.

Rule-based programming attempts to derive execution instructions from a starting set of data and rules, which is a more indirect method than using a programming language which lists execution steps straightforwardly.

A typical rule-based system has four basic components:
A list of rules or rule base depending upon the knowledge base.
A rule engine or semantic reasoner, which infers information or takes action based on the interaction of input and the rule base.
Temporary working memory.
A user interface or other connection to the outside world through which input and output signals are received and sent.

An expert system is software that attempts to reproduce the performance of one or more human experts, most commonly in a specific problem domain, and is a traditional application and/or subfield of artificial intelligence. A wide variety of methods can be used to simulate the performance of the expert however common to most or all are 1) the creation of a so-called “knowledgebase” which uses some knowledge representation formalism to capture the Subject Matter Experts (SME) knowledge and 2) a process of gathering that knowledge from the SME and codifying it according to the formalism, which is called knowledge engineering. Expert systems may or may not have learning components but a third common element is that once the system is developed it is proven by being placed in the same real world problem solving situation as the human SME, typically as an aid to human workers or a supplement to some information system

There are two main methods of reasoning when using inference rules: backward chaining and forward chaining.

Forward chaining starts with the data available and uses the inference rules to conclude more data until a desired goal is reached. An rule engine using forward chaining searches the inference rules until it finds one in which the if clause is known to be true. It then concludes the then clause and adds this information to its data. It would continue to do this until a goal is reached. Because the data available determines which inference rules are used, this method is also called data driven.

Backward chaining starts with a list of goals and works backwards to see if there is data which will allow it to conclude any of these goals. A rule engine using backward chaining would search the inference rules until it finds one which has a then clause that matches a desired goal. If the if clause of that inference rule is not known to be true, then it is added to the list of goals. For example, suppose a rule base contains
1. If Fritz is green then Fritz is a frog.
2. If Fritz is a frog then Fritz hops.

Suppose a goal is to conclude that Fritz hops. The rule base would be searched and rule (2) would be selected because its conclusion (the then clause) matches the goal. It is not known that Fritz is a frog, so this “if” statement is added to the goal list. The rule base is again searched and this time rule (1) is selected because its then clause matches the new goal just added to the list. This time, if clause (Fritz is green) is known to be true and the goal that Fritz hops is concluded. Because the list of goals determines which rules are selected and used, this method is called goal driven.

### Expert System Architecture

The following general points about expert systems and their architecture have been illustrated.

1. The sequence of steps taken to reach a conclusion is dynamically synthesized with each new case. It is not explicitly programmed when the system is built.

2. Expert systems can process multiple values for any problem parameter. This permits more than one line of reasoning to be pursued and the results of incomplete (not fully determined) reasoning to be presented.

3. Problem solving is accomplished by applying specific knowledge rather than specific technique. This is a key idea in expert systems technology. It reflects the belief that human experts do not process their knowledge differently from others, but they do possess different knowledge. With this philosophy, when one finds that their expert system does not produce the desired results, work begins to expand the knowledge base, not to re-program the procedures.

There are various expert systems in which a rule base and a rule engine cooperate to simulate the reasoning process that a human expert pursues in analyzing a problem and arriving at a conclusion. In these systems, in order to simulate the human reasoning process, a vast amount of knowledge needed to be stored in the knowledge base. Generally, the knowledge base of such an expert system consisted of a relatively large number of “if then” type of statements that were interrelated in a manner that, in theory at least, resembled the sequence of mental steps that were involved in the human reasoning process.

A Subject Matter Expert (SME) is a person who is an expert in a particular area. In software engineering environments, the term is used to describe professionals with expertise in the field of application but without technical project knowledge. SMEs is often asked to review, improve and approve technical work, to guide others, and to teach.

A production system (or production rule system) is a computer program typically used to provide some form of artificial intelligence, which consists primarily of a set of rules about behavior. These rules, termed productions, are a basic representation found useful in AI planning, expert systems and action selection. A production system provides the mechanism necessary to execute productions in order to achieve some goal for the system.

Productions consist of two parts: a sensory precondition (or “IF” statement) and an action (or “THEN”). If a production's precondition matches the current state of the world, then the production is said to be triggered. If a production's action is executed, it is said to have fired. A production system also contains a database, sometimes called working memory, which maintains data about current state or knowledge, and a rule interpreter. The rule interpreter must provide a mechanism for prioritizing productions when more than one is triggered.

System provides default domain specific readymade or customize top level ontology to all users and based on that user can create or submit one or more or plurality of Active Notes and associate one or more ontology. Thus top system ontology and user generated active note(s) ontology and related ranked multidimensional resources & actions comprising all types of activities and associated actions related to life of all types of users or people or entities will create complete life specific ontology (activities & actions) and system stores, updates and indexes all ranked resources of said all users and make them searchable for other users.

### Step by Step Details:

Present invention provides a device, system and method of processing active note(s) and associated active resources & actions related to life stream using a network device in communication with a client device comprising:
identifying the note as active note(s) by active note(s) provider(s);
determining a set of at least one target responders or active resources & actions provider(s) by active note(s) provider(s);
send or submit the said active note(s) by active note(s) provider(s) to the central server;
receiving, from the client device, the active note(s) of active note(s) provider(s) by the central server;
determining a set of at least one target responders or active resources & actions provider(s) by the central server;
sending or presenting, to each target responder or active resources & actions provider(s), a representation of the active note(s);
receiving by each target responder or active resources & actions provider(s), a representation of the active note(s) to providing a multidimensional active resources & actions for the active note(s);
identifying a resource utilized for a multidimensional active resources & actions and produce multidimensional active resources & actions;
determining at least one concept based on an analysis of the one or more active note(s);
optionally clarify the active note(s) and related one or more concept(s) by active resources & actions provider(s) with the active note(s) provider(s);
optionally performing a search of active resources & actions over each of the one or more concept based at least on the active note(s) to generate a plurality of multidimensional active resources & actions;
identifying and drafting one or more concept-specific active resources & actions based on the at least one concept;
submitting said one or more multidimensional active resources & actions for said active note(s) to the central server;
receiving, storing, updating, validating, formatting, processing and indexing from each of at least a portion of the target responders or active resources & actions provider(s), a response or multidimensional active resources & actions;
sending the response or active resources & actions with advertisements to the client device;
receiving, viewing, organizing, categorizing, sharing, selecting and using active note(s) related one or more multidimensional active resources & actions and assign rank and provide comments to selected or used said one or more multidimensional active resources & actions by active note(s) provider(s);
updating said one or more multidimensional active resources & actions related rank and comments to the central server; and
providing search engine for searching said active note(s) specific ranked multidimensional active resources & actions based on one or more search criteria to the searchers by the central server.

Wherein said receiving, selecting, presenting and supplying may be performed in real or near real time.

System allow the user or active note(s) provider(s) to creating and updating connections list(s) based on contacts, invitation, find people, searching & matching, subscribing, book marking and match making preferences.

Systems and methods of the invention allows the active note(s) provider(s) or active resources & actions provider(s) to submit one or more public, private or shared domain or subject or purpose or categories specific profile(s) from the client device to the central server for storing, indexing and updating of said submitted profile(s) for matchmaking of active note(s) and/or active note(s) provider(s) with the active resources & actions providers and/or active resources & actions by the central server.

Systems and methods of the invention allows the user or active note(s) provider(s) to updating life stream timeline related note(s) & resources including text, messages, emails, communication related messages & resources, web links, connections, videos, images, photos, albums, graphics, multi medias, audio, voice, any types of files, documents, databases, applications & services, updated resources from connected people or internal or external sources & services, any types of free form or scanned or structured resources, user's or connected users' generated contents like publications, blogs, news, events, updates, notes, experiences, reviews, discussion, likes & dislikes, activities, solutions, sharing, purchases, brands use and want to use, history and everything related to user's and connected users' life which are useful to user's and other like minded or similar users for similar activities.

Systems and methods of the invention allows the user or active note(s) provider(s) to associate one or more taxonomies, ontology, categories, semantic syntax, meaning, controlled vocabulary, keyword(s), comments, notes and metadata to one or more life stream, wherein associating one or more taxonomies to said life stream for organizing life stream comprising allowing user or active note(s) provider(s) to download or synchronize or update one or more default top level or parent system taxonomies from the central server and allow user to append or update one or more user created taxonomies of one or more levels to said default top levels or main system taxonomies.

Systems and methods of the invention allows the user or active note(s) provider(s) to sharing or synchronizing one or more categories or taxonomies specific life stream or selected one or more active note(s) and related multidimensional active resources & actions with one or more selected or matched users or contacts or connections or subscribers.

Systems and methods of the invention allows the user or active note(s) provider(s) to subscribing one or more categories or taxonomies or list(s) specific public or shared life stream(s) of other users or active notes providers based on one or more search criteria and connections with permission.

Systems and methods of the invention allows the user or active note(s) provider(s) to allow other users to subscribe user's one or more categories or taxonomies or list(s) specific public or shared life stream(s) with permission.

Systems and methods of the invention allows the user or active note(s) provider(s) to subscribe other users' one or more categories list(s) of public or shared life stream(s) and/or create one or more categories list(s) of other users' public or shared life stream(s) and make the list(s) as public, private or shared and allow other users to subscribe said one or more list(s).

Active note(s) provider(s) can identify the note as active note(s) comprising allowing user or active note(s) provider(s) to make any note(s) of life stream(s) as active or create new active note(s) and determining target responders or active resources & actions provider(s) or select default auto match option for submitting or sending or updating or synchronizing said one or more active note(s) to one or more selected or subscribed or bookmarked or matched multidimensional active resources & actions provider(s) for multidimensional active resources & actions by active note(s) provider(s) via central server.

Any active note(s) may comprising one or more statement(s), details, story, blog, details, descriptions, message(s), text, image(s), video(s), query, keyword(s), phrase(s), Boolean operators, rules, condition(s), meanings, semantic syntax, ontology with metadata including categories, taxonomies, keyword(s), source id, source profile(s), date & time, location and like.

Active notes provider(s) can determining the set of at least one target responders or active resources & actions provider(s) for submitting or sending or publishing or updating one or more active note(s) to one or more active resources & actions provider(s) comprises allowing user or active notes provider(s) to selectively including one or more responder(s) or active resources & actions provider(s) in the set based on contacts, connections, group(s) or list(s), subscriptions, bookmarks, searching & selection, two way auto match making preferences, publishing in public or one or more filtered cluster(s) or domain(s) or categories or keyword(s) or like.

Any active note(s) may related to any types of activities, purpose, updated status, reason, thought, motive, logic, act, intention, point, idea, what are doing currently, want to do something, did something, aim, goal, ambition, desire, want, wish, need, activity, requirement, request, query, question, appeal, end, object, matter, plan, target, task, issue, subject, topic, project, case, event, problem, attempt, try, what next thing user do, what happen next, likes & dislikes, hobby, selection or choice, around anything related to user's or entity's environment like brands & services using, brands & services want to use, before spent money, before or currently doing something, likes or dislike, every types of experiences, reviews, interest, relation, connected people, all types of works, activities, actions, jobs, procedures, to do, about user, user's life, health, education, travel, entertainment, life style, finance, job, business, career, learning, training, food, habit, hobby and like.

Wherein the said active notes provider(s) and multidimensional active resources & actions provider(s) may including one or more persons or individuals, team or association, collaboration of one or more pre-identified individuals and one or more entities including but not limited to company, associations, organization, professional bodies, social bodies, shops, manufacturer, wholesaler, supplier, dealers and distributor, web site, portal, research agency, governmental bodies and enterprises, virtually any person, group of persons, businesses, organizations, service providers, data providers, application developer or even a computing structure including a program, data & service source, or an entity that exists as a particular and discrete unit and like.

The central server can receiving, storing, updating, validating, formatting, indexing and processing said each active note(s) from said one or more active note(s) providers.

The central server can determining the set of at least one target responders or active resources & actions provider(s) for routing or submitting or sending or publishing or updating one or more active note(s) of one or more active note(s) provider(s) to one or more active resources & actions provider(s) comprises searching a database for a multidimensional active resources & actions providers matching the active note(s) based on associated metadata, rank, two way auto match making preferences of active note(s) provider(s) including one or more taxonomies, categories, keywords, ontology, meaning, semantic syntax, metadata, controlled vocabulary, thesaurus, phrases, Boolean operators, rules, conditions and active note(s) provider(s)' one or more selections or subscriptions or connections of active resources & actions providers.

Systems and methods of the invention allows the active resources & actions provider(s) to collaborating with one or more other active resources & actions provider(s) based on contacts, connections, invitation, searching & matching, subscribing, book marking and two way auto match making preferences and find public active resources & actions provider(s) from central server or internal or external social or other networks & services.

Systems and methods of the invention allows each target responders or active resources & actions provider(s) to receive all active note(s) with metadata & system data automatically from all pre defined or subscribed or connected active note(s) providers via central server or receive one or more active note(s) with metadata & system data from one or more selected or connected or subscribed or two way auto match making preference based active note(s) provider(s) or search, book mark, select and receive active note(s) or received active note(s) assigned from other active resources & actions provider(s) for collaboration from the central server and presenting said received one or more active note(s) as per multidimensional active resources & actions provider's choice and categories as per sources including all or public or expert or subscribers or connected or group(s) or list(s) or assigned sources.

Multidimensional active resources & actions providers can identify the resource utilized for a multidimensional active resources & actions comprising identifying a resource utilized for a multidimensional active resources & actions in association with a keyword(s) contained in the active note(s); and distributing, providing, sharing, synchronizing, updating, displaying the resource to said active resources & actions providers registered to accept active note(s) related to the one or more keywords) or profile(s) or taxonomies or ontology or categories like field, subject, topic, domain, expertise, interest, services and like.

Multidimensional active resources & actions providers can determining at least one concept based on an analysis of the one or more active note(s) comprising determining the one or more concept(s) base on analysis of the active note(s), active note(s) provider's one or more part of life stream, past active note(s) & related ranked resources, active note provider's profile(s) covering preferences, personal profile, rank, points, levels, domain specific updated profiles and like.

One or more multidimensional active resources & actions providers can clarify the said active note(s) and related one or more concept(s) with the said related active note(s) provider(s) before providing multidimensional active resources & actions.

Systems and methods of the invention allows active note(s) provider(s) or active resources & actions provider(s) to search active note(s) and/or concept specific one or more active resources & actions based on one or more concepts, search criteria, keyword(s), categories, meanings, taxonomies, ontology, semantic syntax, conditions, rules, Boolean operators, phrases, search query and messages from local and/or online central server and/or external sources & services integrated by API and/or connected social or personal networks or from any selected connections.

Systems and methods of the invention allows active resources & actions provider(s) to search active note(s) specific one or more active resources & actions or active note(s) provider(s) specific public or shared or filtered life stream based on one or more search criteria, keyword(s), categories, meanings, taxonomies, ontology, semantic syntax, conditions, rules, Boolean operators, phrases, search query and messages.

wherein said one or more multidimensional active resources & actions provider(s) can identifying and drafting one or more concept-specific active resources & actions based on the at least one concept based on active resources & actions provider's experience, analysis, human mind and sources of knowledge, information, database(s), resources from connected users and other Active Resources & Actions, connections, experts, paid services, one or more applications, services, online web sites, books and like.

Systems and methods of the invention allows one or more active resources & actions provider(s) to sent or update or synchronize one or more active resource(s) & action(s) related to one or more active note(s) of one or more active note(s) provider(s) to the client device via central server.

The said multidimensional active resources & actions may comprising any types of resources including text, messages, emails, communication messages & resources, web links, connections, videos, images, photos, albums, graphics, multi medias, audio, voice, any types of files, documents, databases, applications, services, internal or external sources of updated resources, any types of free form or scanned or structured resources by active resources & actions provider(s) or connected active resources & actions provider(s) including articles, publications, blogs, news, events, experiences, reviews, discussion, actions, sharing, suggested brands, providing multiple suggested resources & action(s) including one or more actions, what to do, better way to do, more ways, questions & related answers, answers, suggestions, solutions, guidance, helps, finance, supplies, information, knowledge, tips & tricks, training, learning, match making, ideas, what, where, when, why and how like information, one or more actions, suggestions, solution, direction, guidance, execution plan, step by step procedures, to do, tips & tricks, more particularly, but not exclusively to using a community to provides personalized or customized multi model or multidimensional active resources & actions for active note(s), result-oriented actions, positive steps, active resources designed to actively promote and advance the user's status, any measures taken to rectify conditions, acts or deeds used to remedy a situation, solution for removing an error, or adjust a condition, how to carry out a task, how to execute the things, planned series of actions, tasks or steps designed to achieve an objective or goal, guide the implementation or improvements of any types of process including task assignments, milestones, timelines, resource allocations, data collection methodology, and evaluation, step or series of steps to be taken, detailed description of the steps used to implement a strategic plan, a plan to determine what information is missing or pending, where and when to collect this information, and who will need the information and anything related to active note(s) which are useful to active note(s) provider(s) and like.

Systems and methods of the invention allows multidimensional active resources & actions provider(s) to associate one or more application(s) and/or service(s) and metadata including date & time, resources type, resource structured tag type, source, one or more categories, taxonomies, controlled vocabulary, keyword(s), ontology with said active resource(s) & action(s).

Central server can receiving, storing, updating, validating, formatting, processing and indexing from each of at least a portion of the target responders or active resources & actions provider(s), a response or multidimensional active resources & actions for sending said active resources & actions related to said active note(s) to said active note(s) provider's client device.

Systems and methods of the invention allows user or active note(s) provider(s) to submit and updates one or more public, private or shared active note(s) and related active resources & actions with rank, comments, details and metadata from the client device to the central server for storing, indexing and updating said active note(s) and related ranked active resources & actions.

The central server can route or send or update the said active note specific response or active resources & actions with advertisements to the user on the client device.
Systems and methods of the invention allows the user or active note(s) provider(s) to receive manually or automatically all or one or more selected multidimensional active resources & actions with metadata & system data from all or one or more selected active resources & actions providers related to one or more selected active note(s) from the central server and presenting as per user's choice or categories as per sources including all or public or expert or subscribed or connected sources.

Systems and methods of the invention allows the user or active note(s) provider(s) to set status to one or more one or more multidimensional active resources & actions like “Accept” or “Selected” or “Pending”, “Doing”, “Done”, “Do not like”, “Not Possible” “Reject”, “Suggest Alternate”, “Like” and like, assign ranks and provide details of use or experience or comments on one or more multidimensional active resources & actions and submit said updates to the central server for updating, storing, validating, processing and indexing said updates and making them searchable for other users.

Systems and methods of the invention allows the active resources & actions provider(s) to assign rank to selected one or more active note(s) from one or more active note(s) provider(s).

In one embodiment, at least one of receiving the active note(s), sending the representation of the active note(s), receiving the response or active resource(s) & action(s), or sending the response or active resource(s) & action(s) is performed using an instant messaging mechanism.

Systems and methods of the invention allows the multidimensional active resources & actions provider(s) to set status to one or more active note(s) like “Select”, “Reject”, “Like”, “Pending”, “Sent” and like, assign ranks and provide details or comments to one or more active note(s) and submit, update, store, validate, process and indexes said ranked active note(s) with multidimensional active resources & actions to the central server for making them searchable for searchers.

In one embodiment, each of receiving the active note(s), sending the representation of the active note(s), receiving the response or active resource(s) & action(s), and sending the response or active resource(s) & action(s) is performed using a communication mechanism to facilitate the client device sending the active note(s) and receiving the response or active resource(s) & action(s) within an instant messaging session.

Wherein sending the representation of the active note(s) and receiving the response or active resource(s) & action(s) is performed within an instant messaging session.

The active note(s) source may comprises one of a user computer system, a digital active note(s) source, a user or active note(s) provider(s) application, a telephone or mobile, a smart device, an automated active note(s) source, a sensor systems, a human mind, any types of languages, a image, a video, a file, a translation system and a speech or voice active note(s) source.

In the present system either the active note(s) provider or the active resources & actions provider(s) can modify the active note(s) during the request and response process.

Present system further comprising transcribing a speech active note(s) into a text active note(s) and providing a voice message as multidimensional active resources & actions.

The active note(s) source may comprise a cellular telephone or a mobile device and the active note(s) comprises a text message.

The multidimensional active resources & actions comprise a text message, images, videos displayed by the cellular telephone.

Systems and methods of the invention further comprising presenting an advertisement to a user or active note(s) provider(s) during the receiving, selecting, presenting and supplying and allowing an active resources & actions provider(s) accepting an active note(s) to designate the advertisement. Advertisers may bid for position and placement and timing of advertisements associated with keywords on a user's or active note(s) provider's GUI. Advertisers may bid for position and placement and timing of ads associated with keywords on the active resources & actions provider's GUI and the active resources & actions providers can optionally pick which advertisement is presented.

System can determine whether the active note(s) has been previously responded; and providing previous responses responsive to the determining.

A system for processing a active note(s) of active note(s) provider(s) from a client device comprising: at least one network device containing program logic to perform the method; and a plurality of responder(s) or active resource(s) & action(s) provider(s) devices in communication with the at least one network device, containing program logic to perform actions including: receiving and displaying a active note(s); and sending an active resource(s) & action(s) in an instant message.

A system for processing a active note(s) from a client device, comprising: a transceiver to send and receive data over the network; and a processor that is operative to perform actions, including: receiving a active note(s) from the client device; sending, to each of a plurality of target responders or active resource(s) & action(s) provider(s), a representation of the active note(s); receiving a plurality of responses or active resource(s) & action(s) from the plurality of target responders or active resource(s) & action(s) provider(s); aggregating the plurality of responses or active resource(s) & action(s) to produce an aggregated response including at least two or active resource(s) & action(s) items; and sending the aggregated response or active resource(s) & action(s) to the client device, wherein at least one of receiving the active note(s), sending the representation of the active note(s), receiving the plurality of responses or multidimensional active resources & actions, or sending the aggregated response is performed using an instant messaging mechanism.

A network device for processing a active note(s) from a client device, comprising: means for communicating with a client device; means for communicating with a plurality of responder or active resource(s) & action(s) provider(s) devices; means for responding to an active note(s) from the client device by communicating with the plurality of responder or active resource(s) & action(s) provider(s) devices, said means including logic to aggregate responses or active resource(s) & action(s) from the responder or active resource(s) & action(s) provider(s) devices and provide an indication of a number of received responses corresponding to at least one active resource & action in the aggregated response, wherein the means for communicating with the client device of active note(s) provider(s) and the means for communicating with the plurality of responder devices of active resource(s) & action(s) provider(s) facilitate providing the aggregate response or active resource(s) & action(s) in real time.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a client device that may be employed in a system implementing the invention;

FIG. 3 shows one embodiment of a network device that may be employed in a system implementing the invention;

FIG. 4 is a logical flow diagram generally showing one embodiment of a process for providing active resources & actions by active resources & actions provider(s) to user or active note(s) provider(s) based on active note(s);

FIG. 5 illustrates example of graphical user interface (GUI) for Active Note(s) Provider(s);

FIG. 6 illustrates example of graphical user interface (GUI) for Active Resources & Action(s) Providers; and

FIG. 7 illustrates example of graphical user interface (GUI) for the central server search engine.

FIG. 8 is a detail logical flow diagram generally showing one embodiment of a process for providing active resources & actions by active resources & actions provider(s) to active note(s) provider(s) based on active note(s);

FIG. 9 is a logical flow diagram of example generally showing one embodiment of a process for providing active resources & actions by active resources & actions provider(s) to active note(s) provider(s) based on active note(s);

FIG. 10 is a high level block diagram illustrating a system environment suitable for operation of a social networking website;

FIG. 11 illustrates an exemplary view for the home page of an example site where guests or registered and unregistered users without login can search public contents or browse directories of ranked public contents including active notes, related responses, associate active links, and user actions;

FIG. 12 illustrates an exemplary view for user home and profile editing where the system provides settings for editing user accounts, profiles, and other parameters;

FIG. 13 illustrates a plurality of exemplary views for searching, sorting, and viewing various system parameters;

FIG. 14 illustrates a process for zero click advertisement in accordance with one embodiment of the subject matter described herein;

FIG. 15 illustrates a process for dynamic ecommerce in which an offer does not come valid until associate dynamic rules and conditions obtained in accordance with one embodiment of the subject matter described herein;

FIG. 16 illustrates an exemplary view for managing all types of dynamic publications and other aspects of the system relating to publications according to an embodiment of the subject matter described herein; and

FIG. 17 illustrates an exemplary view that enables the user to select one or more publishing types and managing various aspects of publication according to an embodiment of the subject matter described herein.

### DETAILED DESCRIPTION OF THE DRAWINGS

### Illustrative Operating Environment

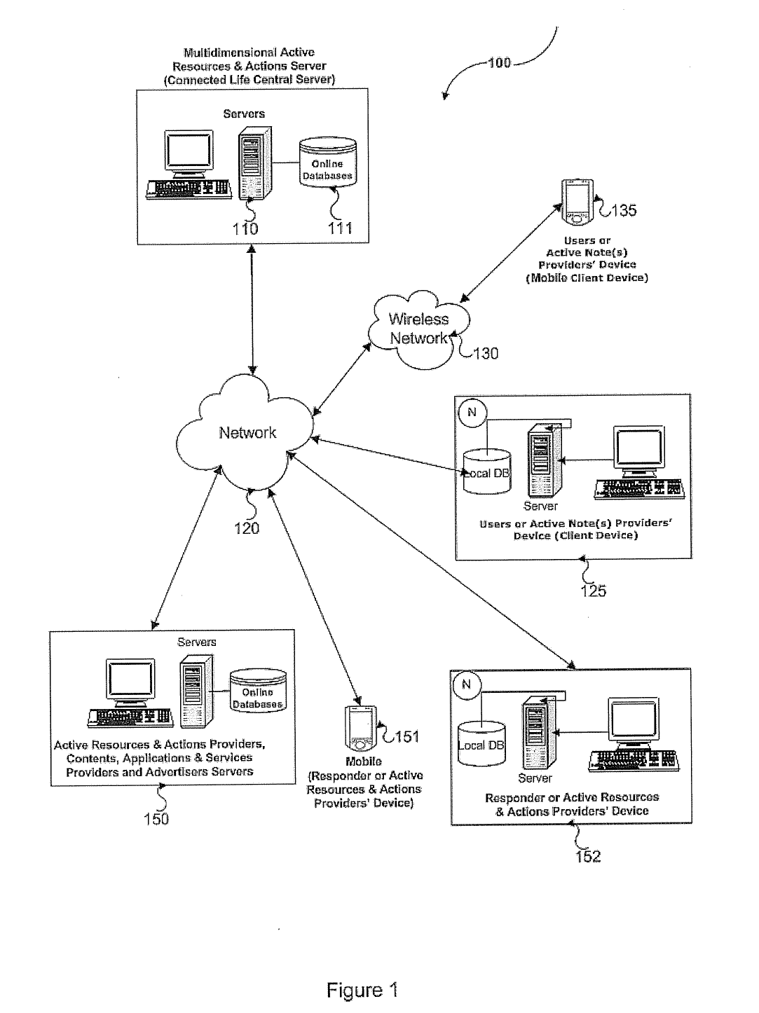

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes a client device, in particular mobile device 135 and personal computer 125. The system also includes wireless network 130, central server 110, Active Resources & Actions Providers, Contents, Applications & Services Providers and Advertisers Servers 150, network 120, and responder or active resources & actions provider(s) client devices 150-152.

A variety of client devices may be employed in accordance with the invention. The client devices may include mobile devices, digital home clients such as personal computers and media centers, and other client devices. Generally, mobile device 135 may include virtually any portable computing device capable of receiving and sending a message over a network, such as network 130, or the like. Mobile device 135 may also be described generally as a client device that is configured to be portable. Mobile device 135 may have the capability of connecting to a network using wireless technology, wired technology, or a combination of both wired and wireless technologies. Thus, mobile device 135 may include virtually any portable computing device capable of connecting to another computing device and receiving information. Such devices include portable devices such as cellular telephones, smart phones, display pagers, radio frequency (RF) devices, infrared (IR) devices, Personal Digital Assistants (PDAs), handheld computers, sensors, laptop computers, wearable computers, tablet computers, integrated devices combining one or more of the preceding devices, and the like. As such, mobile device 135 typically ranges widely in terms of capabilities and features. For example, a cell phone may have a numeric keypad and a few lines of monochrome LCD display on which only text may be displayed. In another example, another cell phone or web-enabled mobile device may have a touch sensitive screen, a stylus, and several lines of color LCD display in which both text and graphics may be displayed.

A web-enabled mobile device may include a browser application that is configured to receive and to send web pages, web-based messages, and the like. The browser application may be configured to receive and display graphics, text, video, multimedia, and the like, employing virtually any web based language or protocol, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile device 135 may include one or more other client applications that are configured to receive content from another computing device. The client application may include a capability to provide and receive textual content, graphical content, audio content, video content, and the like. The client application may further provide information that identifies itself, including a type, capability, name, and the like. In one embodiment, mobile device 135 may uniquely identify itself through any of a variety of mechanisms, including a phone number, Mobile Identification Number (MIN), an electronic serial number (ESN), or other mobile device identifier. The information may also indicate a content format that the mobile device is enabled to employ. Such information may be provided in a message, or the like, sent to central server 110 or other computing devices.

Mobile device 135 may also be configured to communicate a message, such as through Short Message Service (SMS), Multimedia Message Service (MMS), instant messaging (IM), interne relay chat (IRC), Mardam-Bey's IRC (mIRC), Jabber, and the like, between another computing device, such as central server 110, another web server, or the like. However, the present invention is not limited to these message protocols, and virtually any other message protocol may be employed.

Mobile device 135 may be further configured to enable a user to participate in communications sessions, such as IM sessions. As such, mobile device 135 may include a client application that is configured to manage various actions on behalf of the client device. For example, the client application may enable a user to interact with the browser application, email application, IM applications, SMS application, and the like. Generally, instant messaging provides ability for at least two computing devices to exchange messages in real time.

Mobile device 135 may further be configured to include a client application that enables the end-user to log into an end-user account that may be managed by a network application. Such an end-user account, for example, may be configured to enable the end-user to receive emails, send/receive IM messages, SMS messages, access selected web pages, maintain a digital wallet, or the like.

Network 130 is configured to couple mobile device 135 & Personal Computer 125, as well as other client devices not illustrated, and their components, with other network devices, such as central server 110, and the like. Network 130 is configured to couple responder client devices 150-152 with central server 110.

Though for illustrative purposes network 130 and network 120 are shown separately, in various environments employing the present invention, network 130 and network 120 may be the same network, different networks, or different networks including a combination of overlapping components and distinct components. The discussion herein that describes network 130 may therefore be applicable to describe network 120.

Network 130 may include any of a variety of wired or wireless sub-networks that may further overlay stand-alone ad-hoc networks, and the like, to provide an infrastructure-oriented connection for mobile device 135. Such sub-networks may include mesh networks, Wireless LAN (WLAN) networks, cellular networks, and the like. Additionally, network 130 may connect to mobile devices with a wired connection, such as cable, phone lines, Ethernet wires, and the like. Network 130 may include wide area networks, such as the Internet. The invention may be used either generally with networks, specifically with wireless networks, or with various combinations of wireless and wired networks.

Network 130 may further include an autonomous system of terminals, gateways, routers, and the like connected by wireless radio links, and the like. These connectors may be configured to move freely and randomly and organize themselves arbitrarily, such that the topology of network 130 may change rapidly.

Network 130 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as mobile device 135 with various degrees of mobility. For example, network 130 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, network 130 may include virtually any communication mechanism by which information may travel between mobile device 135 and another computing device, network, and the like.

Network 130 may further include or employ one or more network gateways (not shown) that serve as intermediaries between mobile device 135 and other network devices, such as central server 110. A network gateway may receive data from a device or network, transform the data, and forward the data to another device or network. A network gateway may perform a transformation in more than one direction. Transformation may, for example, include modifying protocols or communications mechanisms in order to facilitate communication between two devices or two networks, each of which may employ differing protocols. A WAP gateway is one type of network gateway. A WAP gateway may facilitate communication between a first device that uses the Wireless Application Protocol (WAP), and a second device. The second device may, for example, communicate using the HyperText Transfer Protocol (HTTP). An SMS gateway is a network gateway that facilitates communication between a device using the Short Message Service (SMS) protocol and another device, such as one using HTTP. A WAP and SMS gateway combines the features of a WAP gateway and an SMS gateway.

In one embodiment, network 130 may include one or more components of an instant messaging service that operates to facilitate communication of instant messaging between mobile device 135 and central server 110.

FIG. 1 shows mobile device 135 communicating with central server 110, and central server 110 communicating with Active Resources & Actions Providers, Contents, Applications & Services Providers and Advertisers Servers 150. FIG. 1 also shows central server 110 communicating with responder client devices 150-152. Each of these communications may employ a direct connection, or one or more networks, or a combination thereof. For illustrative purposes, FIG. 1 does not show communication between central server 110 and Active Resources & Actions Providers, Contents, Applications & Services Providers and Advertisers Servers 150 employing network 120, however environments that include this communication may be employed with the present invention. In particular, central server 110 and Active Resources & Actions Providers and Contents, Applications & Services Providers and Advertisers Servers 150 may employ any one or more of direct communication, a local area network, or a wide area network, such as network 120.

A network enabling any one or more of the above communications may employ any form of computer readable media for communicating information from one electronic device to another. Also, the network may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, the network includes any communication method by which information may travel between central server 110, Active Resources & Actions Providers and Contents, Applications & Services Providers and Advertisers Servers 150, responder client devices 150-152, and other computing devices.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” include a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Responder clients 150-152 are computing devices that may be employed by a user, referred to as a responder, for receiving and responding to active note(s). A variety of responder client devices may be employed in accordance with the invention. Responder client devices may include mobile devices, digital home clients such as personal computers and media centers, and other client devices. Generally, responder clients may include virtually any computing device, portable or non-portable, capable of receiving and sending a message over a network, such as network 120, or the like. Responder clients may include devices such as mobile device 151 (135) described herein. Though FIG. 1 illustrates only four responder clients 150-152, it is envisioned that the invention may be practiced in an environment that include a large community of responder clients. Thus, responder clients may number in the hundreds, thousands, hundreds of thousands, millions, or virtually any number.

Though FIG. 1 illustrates an embodiment of a system having each of network central server(s) 110 and Active Resources & Actions Providers, Contents, Applications & Services Providers and Advertisers server(s) 150 as separate computing devices, the invention is not so limited. Software, hardware, or hardware-software combinations implementing any portion of these components may be combined with any other component on a single computing device, or arranged in a different manner among multiple computing devices. Some portion or all of the functionality of any component may be distributed or duplicated among multiple computing devices.

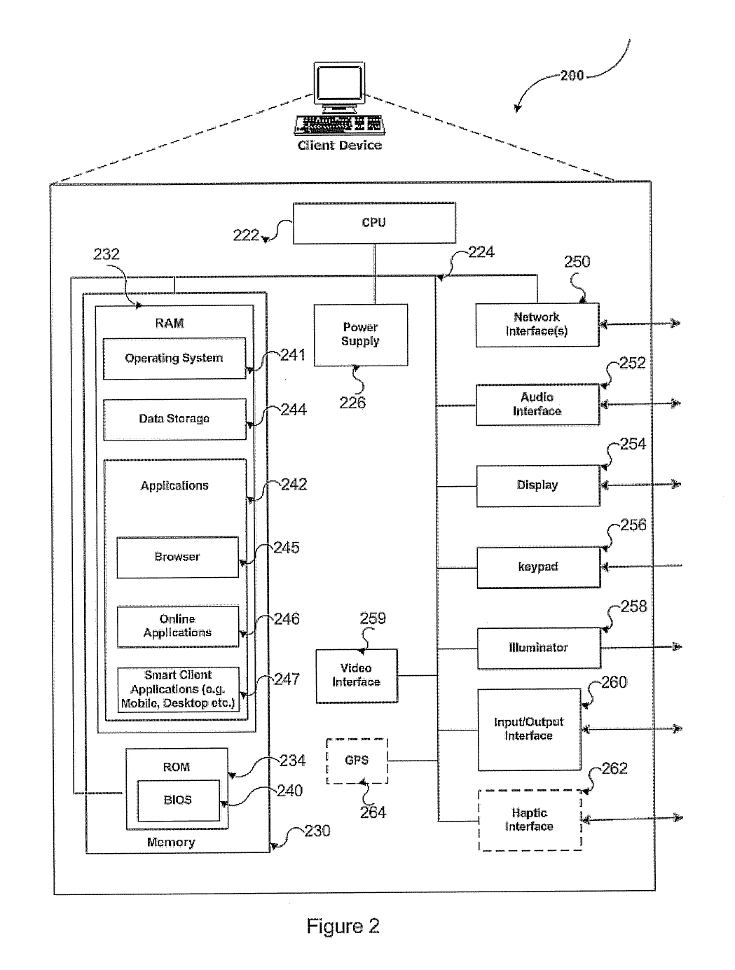

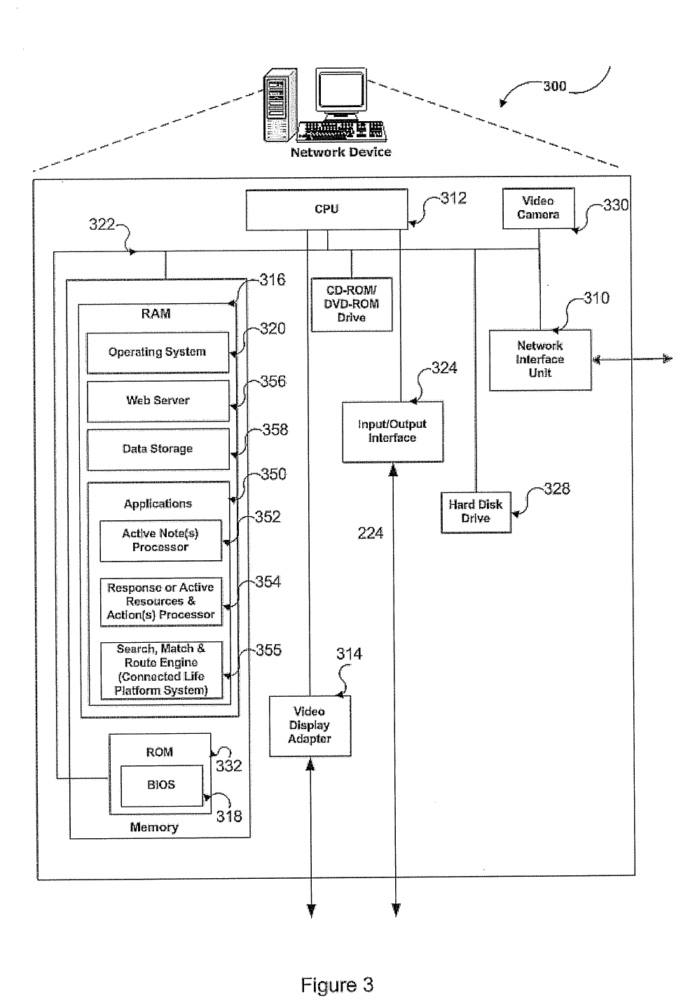

One embodiment of a network device that may be used to implement any one or more of central server 110 or Active Resources & Actions Providers, Contents, Applications & Services Providers and Advertisers Servers 150 is described in more detail below in conjunction with FIG. 3. Briefly, however, such network devices may include any computing device capable of communicating with other network devices to enable network applications or web sites to process and respond to requests from client devices, such as mobile device 135 is described in more detail below in conjunction with FIG. 2. Devices that may operate as these network devices include personal computers desktop computers, multiprocessor systems, microprocessor-based or programmable consumer electronics, network PCs, servers, and the like, or any combination thereof.

FIG. 1 illustrates an embodiment of a system having an ads server 150. Briefly, an advertisings server provides advertisements, such as banner advertisings, application advertisings or other types of advertisements. An application advertisement is an advertisement that is associated with an interaction with an application. It is typically integrated with the application presentation in some way. A search advertising is an example of an application advertisings. When a search is performed, a search application may select one or more ads based on the keywords of the search. The search application may combine search ads with the search results, and present them in an integrated manner. In some embodiments, the integration may be so complete that there is not a clear distinction between the search ads and the search results. In some embodiments, one or more ways of indicating the search ads may be included, such as text, color, line separators, and the like. Similarly, other applications may generate application ads. A mapping application, for example, may use the location specification in a request to generate advertisements based on the location, such as those of businesses in the area, and may display an advertisement on the map.

A banner advertisement typically is placed in a location that is separate from, or more distinguishable from, an application's results. For example, it may be at the top or bottom of a page, or along the margin. A banner advertisement may be selected based on criteria similar to those for an application ad, based on different criteria, or randomly selected

Ads server 150 may have an associated ads database, which may be integrated or in communication with ads server 150. An ads database may store data pertaining to advertisement contents, constraints, and rules pertaining to the use of each advertisement. At least a portion of the data stored in ads server 150 may be specified by an advertiser. An advertiser may specify data describing the advertisement contents, constraints, and rules pertaining to the use of each advertisement.

Ads server 150 may receive data or a set of parameters to use for determining whether to provide an advertisement, selecting and generating an advertisement, including data upon which various determinations are made. Selecting and generating an advertisement may include selecting an advertiser, selecting an advertisement associated with the advertiser, or selecting content to include in an advertisement. The data upon which these and other determinations may be based may include information derived from a active note(s) received by the central server, one or more responses or active resources & actions received from a responder or active resources & actions provider(s) device, an aggregated response, and the like. The data upon which these and other determinations may be based may also include information about the user or mobile device, actions that the user or mobile device have taken, data pertaining to one or more advertisers, relevant events, and a variety of other types of information.

FIG. 1 illustrates an embodiment in which mobile device 135 communicates with central server 110. A user of mobile device 135, referred to as an “active note(s) provider,” may employ mobile device 135 to send an active note(s) to central server 110. Central server 110 may receive and process the active note(s) from mobile device 135. Central server 110 may select a set of responders or responder devices 150-152. A responder is a person who employs a responder device to receive active note(s) and respond to them. Central server 110 may employ identifiers or addresses of responders, responder devices, or both. It may, for example, employ a login name or email address of a responder. It may employ an IP address, MIN, or other identifier of a responding device. Central server 110 may employ any one or more of these identifiers or addressing mechanisms when communicating with a responder or responding device. As used herein, unless the context clearly indicates otherwise, the term “responder” may be used to refer to a person, a responder device, or a combination of a person and a responder device.

### Illustrative Client Device

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, user client devices 150 to 152 and responder client device 135 and 125 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, video interface 259, a display 254, a keypad 256, an illuminator 258, an input/output interface 260, an optional haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Optional haptic interface 262 is arranged to provide tactile feedback to a user of the client device. For example, the optional haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, mobile device may, through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® Operating system. The operating system may include, or interface with a Java virtual machine module that enables control of hardware components and/or operating system operations via Java application programs.

Memory 230 further includes one or more data storage 244, which can be utilized by client device 200 to store, among other things, applications 242 and/or other data. For example, data storage 244 may also be employed to store information that describes various capabilities of client device 200. The information may then be provided to another device based on any of a variety of events, including being sent as part of a header during a communication, sent upon request, or the like. Moreover, data storage 244 may also be employed to store multimedia information and/or content for later publication, editing, or the like, as well as other information including address lists, contact lists, personal preferences, or the like. At least a portion of the content may also be stored on a disk drive or other storage medium (not shown) within client device 200.

Applications 242 may include computer executable instructions which, when executed by client device 200, transmit, receive, and/or otherwise process messages (e.g., SMS, MMS, IM, email, and/or other messages), content, and enable telecommunication with another user of another client device. Other examples of application programs include calendars, editors, email clients, IM applications, SMS applications, VOIP applications, contact managers, task managers, transcoders, database programs, word processing programs, security applications, spreadsheet programs, games, search programs, and so forth. Applications 242 may further include browser 245. Browser 245 may include virtually any of a variety of client applications configured to receive and/or provide communications of web pages, and other content over a network. Browser 245 typically provides for a graphical display of various web pages, including user interfaces provided, in part, by another computing device over the network. Browser 245 may include a variety of security features, and/or other plug-in applications, modules, applets, scripts, or the like, to enable display of animation, videos, playing of audio files, or the like. Browser 245 and applications 242 are configured to enable a user or active note(s) provider(s) and active resources & actions provider(s) to communicating with or prepare content for sending to central server 110 of FIG. 1. Moreover, through one or more of applications 242, the user or active note(s) provider(s) and active resources & actions provider(s) may receive content or messages or active note(s) or active resources & actions or notifications.

### Illustrative Network Device Environment

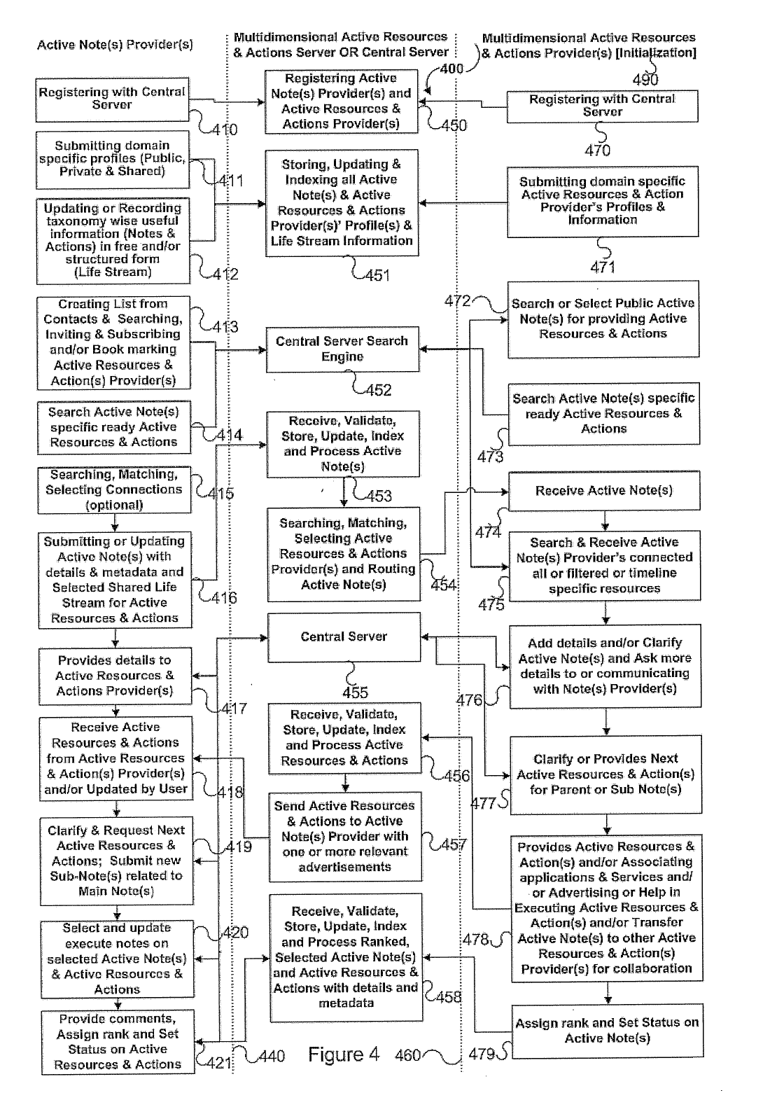

FIG. 3 shows one embodiment of a network device 300, according to one embodiment of the invention. The embodiment of network device 300 illustrated in FIG. 3 may be used to implement the multidimensional active resources & actions central server 110 or the ads server 150 of FIG. 1. Network device 300 may include many more components than those shown. It may also have less than all of those shown. The components shown, however, are sufficient to disclose an illustrative embodiment for practicing the invention. One or more network devices, and the application programs integrated with the devices, may be used to implement the processes of the present invention, as illustrated in FIGS. 4-6 and discussed herein.

In any event, network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account managers, and so forth. More detailed discussions of some application programs are included herein.

Mass memory further includes web server 356, data stores 358, and applications 350. Applications 350 are shown to include Active Note(s) Processor 352 and Active Resources & Action(s) Processor 354 and Search, Match & Route Engine, Applications & Services server (Connected Life Platform System) 355. Web server 356 includes virtually any application configured to delivers Web pages and other content to browsers and other client applications via at least the HTTP protocol. However, web server 356 may also be configured to provide scripts, user interfaces, accounting interfaces, editors, security, or the like, to the client application. Moreover, web server 356 may employ a variety of other communication protocols, beyond HTTP. For example, web server 356 may be configured to manage email communication protocols, SMS protocols, IM protocols, or the like. Moreover web server 356 may employ a variety of scripts, applets, programs, or the like, to enable communications of content with a client application.

Data stores 358 may include any of a variety of storage mechanisms, configured to store, and otherwise managed content, applications, scripts, applets, or the like. As such, data stores 358 may be a database, a file structure, or the like. Data stores 358 may store the content into a category structure, such as folders, albums, graphs, trees, or the like, based on a user account, a web service, or the like. In one embodiment, data stores 358 may represent the Data Management services illustrated in FIG. 1, and described in more detail below in conjunction with FIG. 4.

Connected Life Platform 355 is described in more detail below in conjunction with FIG. 4. Briefly, however, Connected Life Platform 352 includes a variety of components to provide web services to a user, including search tools, user interfaces, plug-and-play modules, or the like. Various embodiments of example user interface screens are described in more detail below.

In one embodiment, applications 352 may include an active note(s) processor 354. An active note(s) processor may include program logic that performs actions in response to receiving an active note(s) from active note(s) provider(s) client device. These actions may include determining a set of responders to solicit responses from, sending an active note(s) to the set of responders, or other actions relating to processing active note(s).

In one embodiment, applications 354 may include a response or Active Resources & Action(s) processor 356. A response or Active Resources & Action(s) processor may include program logic that performs actions relating to receiving and processing responses or active resources & action(s). These actions may include receiving and collecting responses or active resources & action(s), associating advertising, applying validation, spam control, limits & settings, preparing a response to be sent to the active note(s) provider(s), or other actions relating to processing responses. These actions are discussed in further detail herein. Though FIG. 3 illustrates an active note(s) processor and a response processor, the actions and logic of each component may be combined into a single component, divided into multiple components in a different manner, or distributed in a variety of ways across multiple network devices.

### Generalized Operation

FIG. 4 is a high-level flow diagram of a process 400 for processing and responding to one or more active note(s) in accordance with an embodiment of the invention. Process 400 may employ at least a portion of the system illustrated in FIG. 1. It may employ any of the system variations as discussed herein, or it may be performed with other systems.

FIG. 4 is divided into three areas by two vertical dotted lines 440 and 460. The area to the left of line 440 is labeled as the Active Note(s) Provider(s) area; the area between lines 440 and 460 is the central server area; and the area to the right of line 460 is the responder or Multidimensional Active Resources & Actions Provider(s) area. Each of the action blocks of FIG. 4 resides within one of the three areas. The areas illustrate, for one embodiment, a component corresponding to each action that may perform the action. The invention is not so limited, however. In various embodiments, each of the actions may be performed by a component other than that illustrated in FIG. 4. Unless clearly limited otherwise herein, any one or more of the actions may be performed by one or more of the components, or by components other than the active note(s) provider(s), the central server, or a responder.

As illustrated in FIG. 4, at block 410, a user or note(s) provider(s) and at block 470, a Multidimensional Active Resource(s) & Action(s) Provider(s) may initially register for use of the central server i.e. Connected Life Platform. In one embodiment, one username/password can be provided to a user or a note(s) provider(s) and a Multidimensional Active Resource(s) & Action(s) Provider(s) to allow access to all website properties of the central server i.e. Connected Life Platform including online or mobile website(s) or portal or smart desktop or mobile clients or other applications or services or devices or 3^{rd} parties' applications & services integration. In one embodiment, username and email addresses can be used as unique identifiers including trusted identifications like official e-mail id or mobile phone number or any other trusted id system for each registration. Moreover, a user or a note(s) provider(s) and a Multidimensional Active Resource(s) & Action(s) Provider(s) may perform multiple concurrent logins to the central server or Multidimensional Active Resources & Actions Server (Connected Life Server) System or Platform.

In one embodiment, a root level webpage for website can have a prominent button or link called “Log in or Register.” This link can be pervasive through all screens on the websites. Clicking on this button can generate the login screen, which can have a link or button to “Create a New Account”. Clicking on this button, in one embodiment, produces the Registration Page. In one embodiment, if a user or a note(s) provider(s) and a Multidimensional Active Resource(s) & Action(s) Provider(s) has not logged in and they attempt to submit an active note(s) or sent Multidimensional Active Resources & Actions to other users (for example, by clicking on “Active Note(s) Management” or “Multidimensional Active Resources & Actions Management” or the like.) the Login Page can appear. Logout links may take place of “Login” links after the user or a note(s) provider(s) and a Multidimensional Active Resource(s) & Action(s) Provider(s) has successfully logged in. After clicking on logout, the user may be taken to the one of the website's Home Page. In one embodiment, the user's browser can prompt the user whether it wants to remember the username/password for the next visit.

In one embodiment of a registration interface if a required field is left empty in the quick registration interface, or if the password fields do not match, the fields that are to be fixed may be indicated in some manner, e.g., red text, entry area highlighted, or the like. Users may choose to view the Terms of Use and Privacy Policy before proceeding, in one embodiment. If the user clicks on either of these links, a new daughter window can appear with a “Close” button at the bottom of the text. Moreover, users can be told that their registration request failed if the birth date that they enter makes them less than some defined age, after they click on “Continue.”

Thus, in one embodiment, after clicking on “Continue” on a previous page, an email is sent to the user's registered email account. Screen may then be displayed in the browser. All fields shown in screen may be optional. Clicking “Save” at bottom of a form generates an alert message interposed on the “Home Screen” for the site, telling the user to check their email for the confirmation message so they can log in.

If the user is not logged in after launching the confirmation page, then their first login can take place on their first attempt to submit active note(s) or receive user's active note(s) or sent Multidimensional Active Resources & Actions, whether it is a create new active note(s) or new Multidimensional Active Resources & Actions or an update to their profile. Moreover, the Multidimensional Active Resources & Actions Server provides for situations, where the user may have forgotten their password. Thus, a “Forgot Password?” link can appear next to the password entry field for login. Clicking on this link can produce a field requesting username OR email address they registered with and a submit button. Providing registered email address and clicking on “Submit” can cause the user's password to be sent to their registered email account.

Typically, collection of statistics begins for the registered user immediately upon completion of registration. All ratings, comments, publications submissions, or the like, may be traceable/displayable back to the user, as well as all revenue-generating activity related to the user (page views, click-through, or the like). In one embodiment, a mechanism for bulk importing a set of user registrations from an acquired company or other sources or partners may be provided. The process can flag duplicate usernames and can allow for the acquired user to change their username to something unique to preserve their account history. Moreover, in one embodiment, logging subsystems of the system may track abandoned registrations. User can also browse and search categories active notes and related Multidimensional Active Resources & Actions and resources and people or user or active note(s) providers or Multidimensional Active Resources & Actions provider(s) from home page (central server search engine).

As illustrated in FIG. 4, at block 411, a user or a note(s) provider(s) and at block 471, a Multidimensional Active Resource(s) & Action(s) Provider(s) may submit or update domain or subject specific one or more structured or free form profile(s) to the central server or Multidimensional Active Resources & Actions Server which are useful for understanding a user or a active note(s) provider(s) & active note(s) for providing Multidimensional Active Resources & Actions and relevant matching of active note(s) related Multidimensional Active Resources & Actions Provider(s).

As illustrated in FIG. 4, at block 412, a user or a note(s) provider(s) can update user's life stream related active note(s) and related ranked or executed Multidimensional Active Resources & Actions with metadata including date & time, sources, links, categories, taxonomies, keywords, rank, comments, status in structured or semi structured or free form to the central server or Multidimensional Active Resources & Actions server. Central server stores, updates, indexes all said resources and makes them searchable for other users or notes providers and Multidimensional Active Resources & Actions Providers.

As illustrated in FIG. 4, at block 413, a user or a note(s) provider(s) can create or update connections based on known contacts, find people, inviting known and/or unknown likeminded users from present network or from other one or more external network(s), subscribing sources, search and bookmark matched sources or setting preferences for auto matching of provider(s) by central server for receiving Multidimensional Active Resources & Actions from Multidimensional Active Resources & Actions providers. Central server stores user's all types of connections and preferences for selecting, matching and routing a user or active note(s) provider(s) one or more active note(s) to one or more Multidimensional Active Resource(s) & Action(s) Provider(s) for Multidimensional Active Resource(s) & Action(s).

As illustrated in FIG. 4, at block 413, a user or a note(s) provider(s) can search, match and receive active note(s) specific ready ranked Multidimensional Active Resource(s) & Action(s) from central server Multidimensional Active Resource(s) & Action(s) Search Engine.

As illustrated in FIG. 4, at block 490, an initialization action is performed. In one embodiment, this action is performed by a responder and a central server in communication with each other. The initialization action of block 490 may include any one or more of the following actions:

a responder registering as a member or a responder;
a responder logging in;
specification of content for active note(s) that the responder may respond to;
specification of other criteria to use for determining whether to solicit a response from the responder; or
specification of data for identifying or locating the responder, type or capabilities of the responder's client device, and the like.

Specification of content may include various levels of specificity. It may include geographic specifications, level of expertise, or other data that may assist a matching of an active note(s) with a set of responders. A responder may specify one or more areas of expertise.

Specification of other criteria may include criteria that may throttle, or otherwise limit the solicitation from the responder. This may include a desired limit to the frequency of active note(s); a desired time period between active note(s), times when active note(s) may be submitted or not submitted, or other such data. The action of block 490 may be performed by numerous responders. Responders may number in the thousands, millions, or virtually any other number.

At block 416, an active note(s) provider(s) may post an active note(s). Posting an active note(s) may include specifying an active note to be responding by Multidimensional Active Resources & Actions provider(s) and sending the active note(s) to the central server or Multidimensional Active Resources & Actions server. Before sending user can at block 415 select one or more destination or Multidimensional Active Resource(s) & Action(s) Provider(s) or sent to subscribed or directly sent to the central server for auto match making based on preferences and/or profile(s) and/or past active note(s) and/or other historical resources. An active note(s) may be specified in one or more of a number of ways. In one embodiment, an active note(s) is specified by entering text. As used herein, the term an active note refers to a specification of a matter that elicits a reply. It may take the form of an interrogatory, a statement, or a single word or phrase that represents a request for a response. Some examples of n active note(s) include: “I going to Goa”, “Today I m attending party”, “Want to purchase a mobile.” An active note(s) can be in the form, of text, video, graphics, photo, picture, an image, an audio segment, a document, or other forms, or any combination thereof.

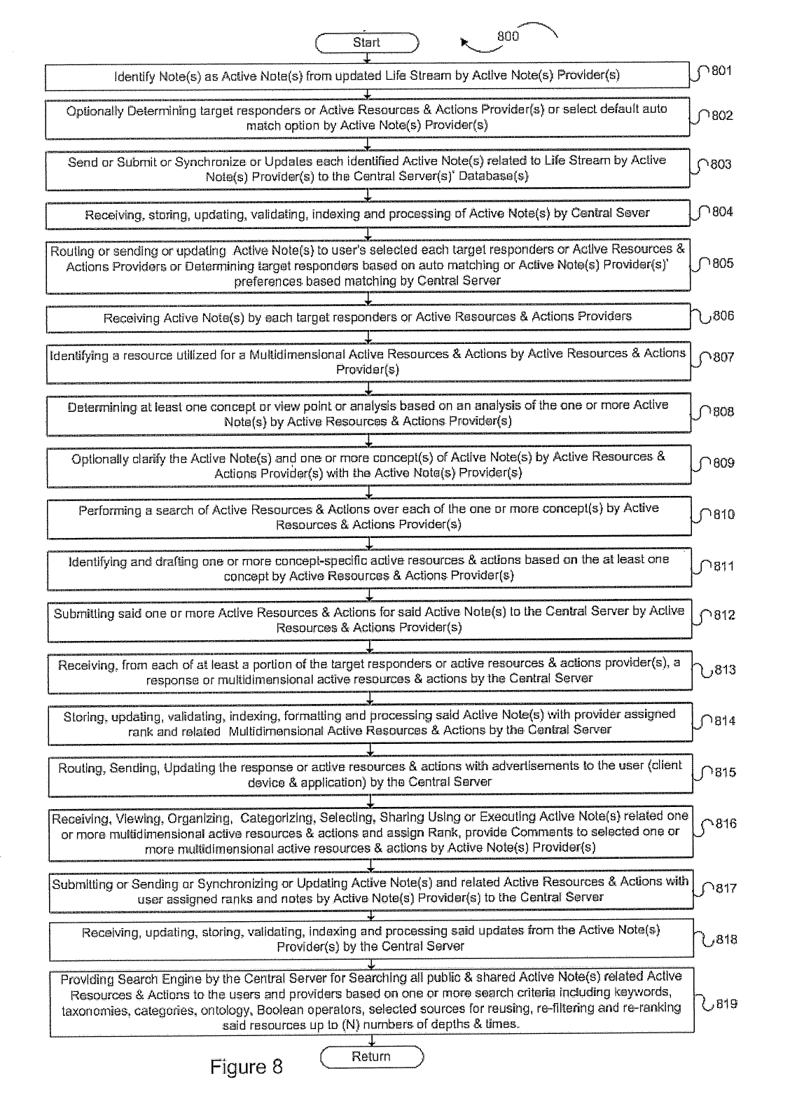

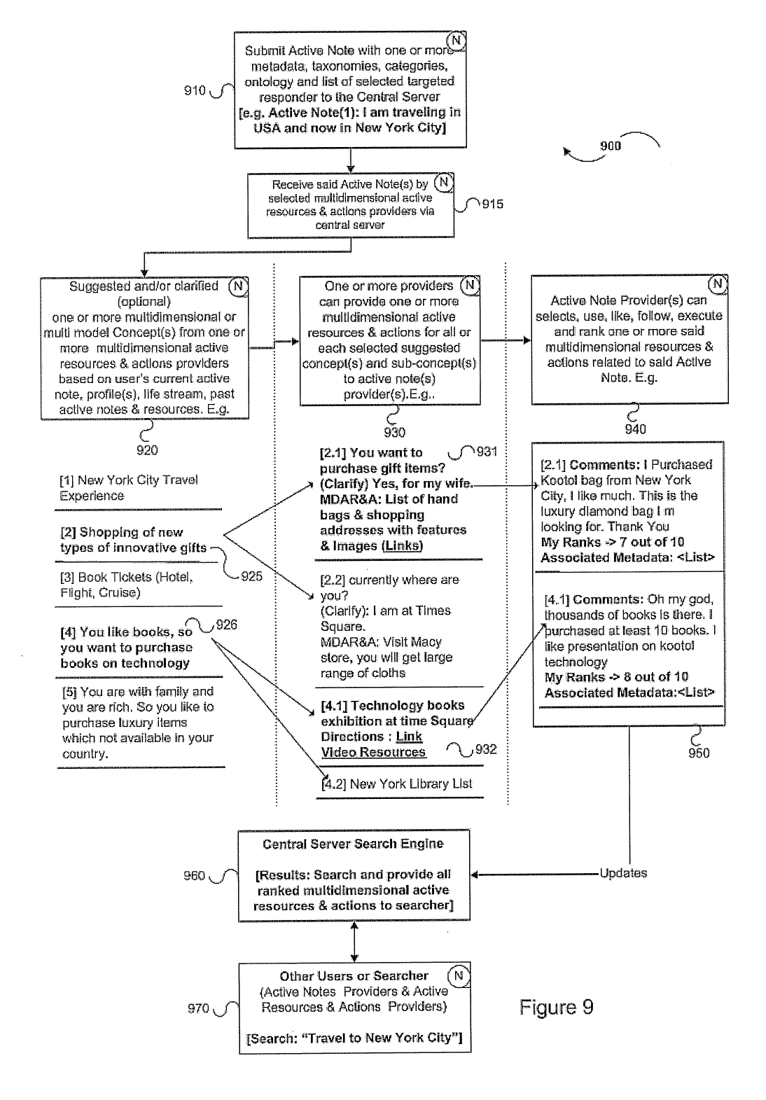

Process flow then proceeds to block 453, where the posted active note(s) is received and processed. In one embodiment, this action is performed by a central server. This action is illustrated in further detail in FIGS. 8 and 9, and the accompanying text. Briefly, processing an active note(s) includes preparing the active note(s) for transmitting to responders, determining a set of target responders, sending the active note(s) to the target responders, and initiating a timing operation. Processing an active note(s) may include adding supplementary information, details and metadata to the active note(s). As used herein, the term active note(s) may include supplementary information, details and metadata that are sent to a responder.

Process may then flow to block 474, where at least a portion of the target responders receive the processed active note(s). As discussed in the text accompanying FIGS. 8 and 9, the active note(s) may be transmitted to responders using any of a number of transmission mechanisms, including instant messaging (IM), SMS, or other communication mechanism. Responders may receive the active note(s) in an IM window, a browser window, an SMS window, and the like. An active note(s), including any supplementary information, details and metadata may be transmitted using more than one media or communication mechanism. For example, an IM message may include a link to a web page or audio segment containing a part of the active note(s).

Process may then flow to block 475, where Multidimensional Active Resource(s) & Action(s) Provider(s) may search Active Note(s) Provider's connected all or filtered or timeline specific resources for understanding active note(s) and active note(s) provider(s) in multiple ways and providing Multidimensional Active Resource(s) & Action(s) to active note(s) provider(s).

Process may then flow to block 476, where Multidimensional Active Resource(s) & Action(s) Provider(s) may add details to said active note(s) and/or clarifies active note(s) by communicating with active note(s) provider(s) and at block 417, a user or active note(s) provider(s) provides additional details or clarify the said active note(s) and/or establish communication with said Multidimensional Active Resource(s) & Action(s) providers.

Process may then flow to block 478, where one or more of the responders or Multidimensional Active Resource(s) & Action(s) Provider(s) may provide a response to the active note(s). This action may include a responder specifying a response and transmitting the selected response to a server such as the central server. The format of a response may vary, and may depend on the form of the active note(s). A response may include free text, an image, video, audio or voice, files, documents, web link, any types of contents, a link, applications, services, or another form, or any combination thereof. The responder or Multidimensional Active Resource(s) & Action(s) Provider(s) can assigned or transfer said active note(s) to other matched or subscribed or known or connected or public or groups or collaborate with other Multidimensional Active Resource(s) & Action(s) Provider(s) for providing Multidimensional Active Resource(s) & Action(s) to said active note(s) providers for said active note(s).

A response may be transmitted by a responder using the same or different communication mechanism as the one in which the active note(s) was received by the responder. The responder may transmit a response using IM, SMS, or other communication mechanism.

Process may then flow to block 456, where responses sent from responders are received and processed. Responses may be aggregated, and an aggregated and processed response may be sent to the Active Note(s) Provider(s). In one embodiment, at least some of these actions are performed by a central server. This may be the same or a different central server as the central server that performed the actions of block 453. The actions of block 456 are illustrated in further detail in FIGS. 8 and 9, and the accompanying text.

Process may then flow to block 418, where a processed response is received by the Active Note(s) Provider(s). A processed response may be presented to the Active Note(s) Provider(s) in a variety of forms.

A processed response received by an Active Note(s) Provider(s) may include one or more message(s), web links, text, video, audio or voice, images, photos, videos, files or documents or other types of information relating to the response. This information may be displayed on the Active Note(s) Provider(s)'s client device in any of a number of ways. In one embodiment, a response received by an Active Note(s) Provider(s) may include a sponsor advertisement. The advertisement may be selected by the central server, by another server, or another source.

Process may then flow to block 421, where the Active Note(s) Provider(s) may select, from the response, a Multidimensional Active Resource(s) & Action(s) item that the Active Note(s) Provider(s) considers to be the best or most desirable response. The active note(s) provider's selection may then be sent to a central server for additional processing. This server may be the Multidimensional Active Resources & Actions server that performed the actions of block 356, another Multidimensional Active Resources & Actions server, or another server. Sending the selected Multidimensional Active Resources & Actions item may be performed using the same or a different communication mechanism as was used to send the processed response to the active note(s) provider.

Process may then flow to block 458, where the selection of the best Multidimensional Active Resources & Actions item or other data may be stored or transmitted to another network device for processing or storage. Data that may be stored or transmitted may include the original active note(s), a processed active note(s), identification of the Active Note(s) Provider(s), responder responses or Multidimensional Active Resources & Actions, identification of responders or Multidimensional Active Resources & Actions Provider(s), an association between each responder or Multidimensional Active Resources & Actions Provider(s) and the response or Multidimensional Active Resources & Actions received from the responder or Multidimensional Active Resources & Actions Provider(s), the processed response or Multidimensional Active Resource(s) & Action(s), the number or percentage of responders or Multidimensional Active Resources & Actions provider(s) providing each Multidimensional Active Resource(s) & Action(s) item, the selected best Multidimensional Active Resource(s) & Action(s) item, additional information or details and metadata relating to the active note(s) or Multidimensional Active Resource(s) & Action(s) that may have been sent to the responders or to the active note(s) provider(s) or user, other related data, or any combination of these. In one embodiment, at least some of the stored data may be stored so that it is available for use in processing subsequent active note(s) or responses or Multidimensional Active Resources & Actions. For example, if a substantially identical active note(s) is asked a second time within a predetermined time period, a central server or Multidimensional Active Resources & Actions server may reply to the active note(s) provider(s) or user based on the prior active note(s) and Multidimensional Active Resource(s) & Action(s). It may forego at least some of the actions of sending the active note(s) to the responders or Multidimensional Active Resources & Actions Provider(s) and receiving responses or Multidimensional Active Resources & Actions.

In another example, at least some of the processing that is performed at block 353 or 356 may be used to process a subsequent active note(s) or responses i.e. Multidimensional Active Resources & Actions. In one embodiment responses i.e. Multidimensional Active Resources & Actions may be provided to sponsors or other entities that have an interest in the subject matter.

In one embodiment, an active note(s), a Multidimensional Active Resource(s) & Action(s), percentages of responders providing a Multidimensional Active Resources & Actions item, or other saved data may be presented on a web site in a variety of ways. Responses or associated data about products or services may be presented on a web site that reviews, discusses, or provides information about products or services.

The methods and mechanisms of the invention, discussed herein, facilitate a synchronous or a substantially synchronous active note(s) and related multidimensional active resources & actions session for a client device. That is, a user may submit an active note(s) and receive a very prompt response or multidimensional active resources & actions in a single session. This may be referred to as a real time communication, or a real time session. The user is not required to return to a web page or client program, or log in, at a later time. A user of a mobile device may have the expectation of receiving a prompt “while-you-wait” multidimensional active resources & actions to facilitate choices, such as a buying decision while in a store, a restaurant or movie decision while near a potential restaurant or theater, and the like.

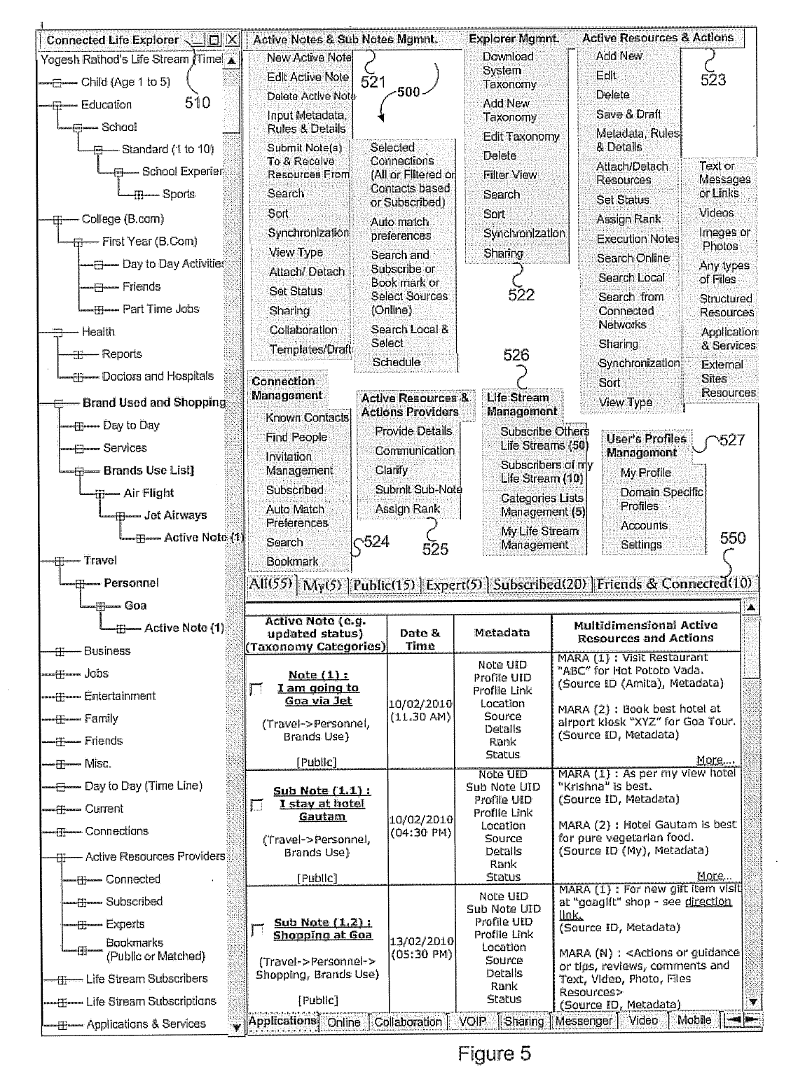

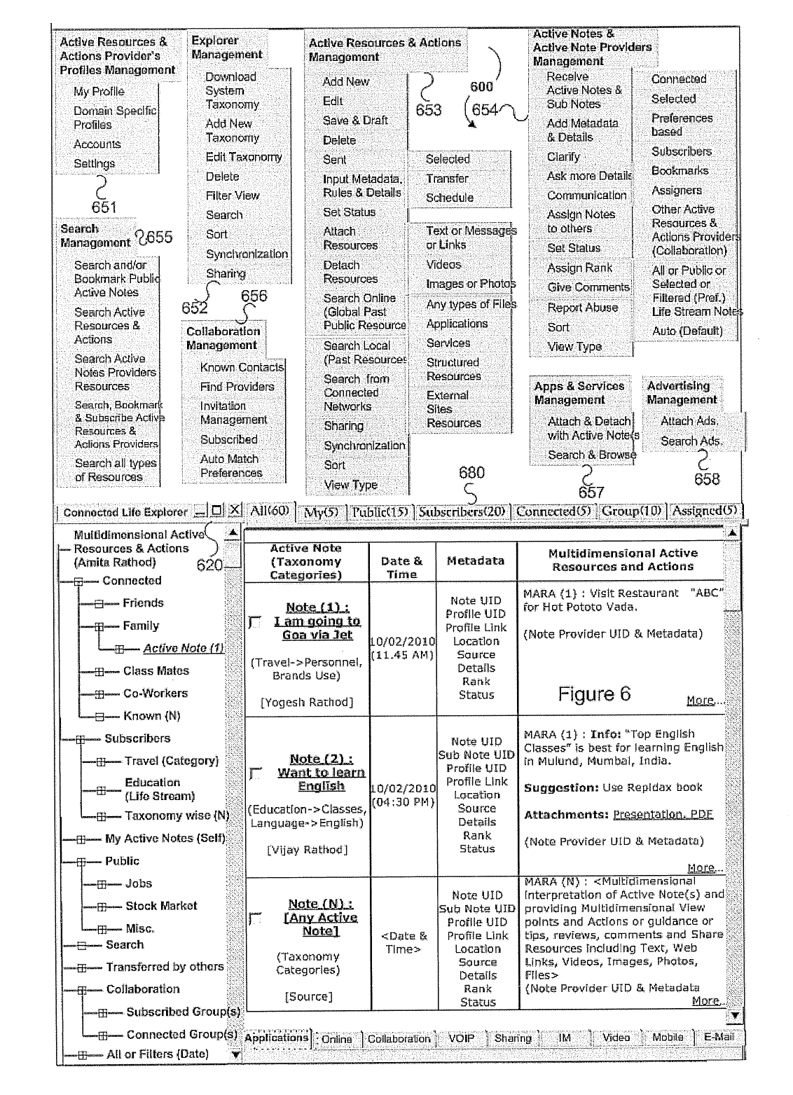

Many of these actions are described below in conjunction with FIGS. 5-6.

FIGS. 5 and 6 show different screen shots style drawings of various embodiments of user interfaces for employing the present invention i.e. Connected Life Platform, in accordance with the invention. It should be noted that the following illustrations are not intended to limit the invention. Instead, they are intended to merely provide an overview non-exhaustive understanding of how the invention may be employed.

In one embodiment, a user may interact with the Connected Life Platform using virtually any browser application or smart client or smart online applications, including, but not limited to Internet Explorer (IE), Firefox, Opera, Safari, or the like. Moreover, as described above in conjunction with FIGS. 1 and 2, the user may use any of a variety of client devices.

FIG. 5 illustrates one embodiment of a screen 500 configured as a possible home screen of Central Server's (Connected Life Server's) registered User or Active Note(s) Provider(s) managed by the platform. Screen 500 enables users to obtain an at-a-glance view into the parts of their presence on the site; and obtain a convenient means of managing Profile(s), Privacy and Account Settings, Active Note(s), Multidimensional Active Resources & Actions and Providers, Friends, Connections, Contents, Explorer Life Stream, Subscriptions and Subscribers, Applications and Services 521 to 527 and All Statistics including User's Ranks, Levels, Points and all types of Statistics. Explorer interface provide all types of functionalities comprising viewing complete or partial or filtered or categories or taxonomies wise life stream of active note(s) provider's or user's or any entities including any individual, group(s) of individuals, connected individuals, company, manufacturers, service providers, organization, government department(s), institute, shop, society, friends, family, social connections, like minded individuals, similar activities or actions or work or professionals or location or language or income group or age or education or hobbies or qualification or any other match making or preferences specific individuals or persons or people, school, college, class, employers, employee, professionals, workers and like. Life stream covers all user or Active Note Provider or 3^{rd} parties Multidimensional Active Resources & Actions Provider(s)' recorded or updated all types of multidimensional resources including all important things (active note(s) in life and related Multidimensional Active Resources & Actions including all chronological updated information, experience, solution, execution steps & right directions, rank, comments, reviews, procedures, best way to do, features, blogs, text, messages, videos, audio, voice, photos, images, structured information including tags or categories specific contents like which are useful to users and understanding user's any active note(s) by Multidimensional Active Resources & Actions Provider(s) providers. Other users or active note(s) provider(s) can subscribe to one or more users' or active note(s) provider(s)' all or selected or taxonomies or categories specific or filtered or preference based or matched life stream with permission or public life stream without permission. Categories Life Stream List(s) facilitates user's to subscribe plurality of other users' life stream.

Explorer 510 & Explore Management 522 provides user friendly interface for navigating user's life stream in chronological or category or taxonomy wise, user can jump to any part of life stream, 3^{rd} click menu provides all functions or operations in single or in group mode like searching & viewing active note(s) related to particular date & time or category or location or name or keyword(s) or one or more search phrases with Boolean operators and sort the results as per date & time or category or source. User can share or synchronizing one or more selected life stream with other connected users including friends, family, co-workers, co-professionals, class mates, colleagues, likeminded unknown people and like from explorer. User can make any one or more active note(s) or parts or category of life stream public or private or shared and attach or define privacy policies and rule or conditions for security. User can also add new active note(s) and related multidimensional active resource(s) & action(s) or edit or modified or delete or associate metadata including one or more categories, taxonomies, keyword(s), notes, comments, ranks, status and like with one or more active note(s) or parts or category of life stream. User can download or updates system all or domain or subject or categories wise one or more parent taxonomies (one or more levels or depths of categories) from the central server. Standard or system or default taxonomies provides compatibility with all users' life stream for sharing, data mining, synchronizing, sorting, organizing, viewing, comparing, searching, matching, categorizing, aggregating, filtering and like. User can add new user created or generated taxonomies or import from any sources and append to one or more parent system taxonomies or modify or delete user generated or created child taxonomies later at any time.

When user clicks on any tree like list of explorer, associate lists of active note(s) displayed to user 550 for managing one or more active note(s) or sub note(s) or N depths of sub note(s) for viewing the active note(s) and related Multidimensional Active Resources & Actions and metadata, user can select one or more active note(s) for group actions including organizing, aggregating, categorizing, sharing, assign rank or give comments or reviews and like. User can view updated Multidimensional Active Resources & Actions for active or current or open active note(s) in categories like Multidimensional Active Resources & Actions from subscription sources, public or expert or connected Multidimensional Active Resources & Actions Providers. User can delete one or more active note(s) and resources or modify selected active note(s). User can also communicate with selected active note(s) related one or more Multidimensional Active Resources & Actions Provider(s).

By using menu “Active Notes & Sub Notes Management” 521 user or active note(s) provider(s) can add new, edit or delete existing active note(s), associate metadata and details, search, sort, synchronizing, share, view one or more or group(s) of active note(s). User can submit one or more active note(s) to one or more selected sources of Multidimensional Active Resources & Actions or Multidimensional Active Resources & Actions Providers including known like friends, family, class mates, co-workers, colleagues or subscriptions of providers or unknown like minded or two way preference based match making or broadcast or make active note(s) as public and sent instantly or schedule the submissions. User can use template(s) for creating active note(s) from local or other remote sources. After submission of one or more active note(s) to one or more Multidimensional Active Resources & Actions Providers, user can set status of one or more active note(s) like “Current”, “Pending”, “Sent”, “Drafted”, “Open”, “Closed”, “Like”, “Important”, “VIP” and like. User can also attach and/or detach one or more active note(s) with any or one or more part(s) or categories of life stream.

By using menu “Active Resources & Actions” 523, user or active note(s) provider(s) can self add new or edit or delete or draft one or more Active Resources & Actions and associate metadata including date & time, category, author, types of resources, rank, execution note, comments or reviews, set status and like, attach or detach one or more resources including text, message(s), link(s), video(s), audio, voice, files, images, photos, application(s), service(s), structures resource(s) and resources from current networks or from other networks of user's friends or connected users, search resources from local network, connected social networks, central server's Active Resources & Actions Search Engine, shared or subscribed or updated (via synchronization) resources from friends or other connected users with one or more Active Resources & Actions related to selected one or more active note(s) or active sub note(s). User can sort (date, time, source and category wise) or search or order or organize or select view types of Active Resources & Actions.

By using menu “Connection Management” 524, user can create contacts by find people, inviting friends and known people, search, subscribe or book mark like minded users, set two way auto matching preferences, subscribed one or more public or expert or known Multidimensional Active Resources & Actions Provider(s).

By using menu “Active Resources & Actions Providers” 525, user can communicate with selected one or more Multidimensional Active Resources & Actions Provider(s) for provide requested more details or clarify provided Multidimensional Active Resources & Actions by Provider(s). User can assign rank or comments on one or more selected Multidimensional Active Resources & Actions Provider(s). User can also again submit one or more sub note(s) or sub-sub note(s) up to N depths to one or more Multidimensional Active Resources & Actions Provider(s) related to one or more selected main or parent active note(s).

By using menu “Life Stream Management” 526, user can subscribe to other known or unknown or like minded users' selected life stream with permission and allow others to subscribe users' selected life stream with permission. User can also create one or more categories list(s) of other users' life stream and allow other users to subscribe said one or more categories list(s) of life stream or user also can subscribe other users' categories list(s) of life stream. User or any entity or administrator can also manage their own life stream(s) including categorizing life stream(s), make one or more life stream(s) public or private or shared, allow other user's to subscribe one or more selected life stream(s) for using ready resources or providing Multidimensional Active Resources & Actions. Connecting others or allow others to connect with user's all or selected one or more or filtered life stream(s).

By using menu “User's Profiles Management” 527, user can manage or create or update one or more domain or field specific profile(s) to the central server. Central server stores, updates, indexes all public, private and shared profile(s) of user and make them searchable for all or selected users for understanding user's active note(s) and user. User can manage accounts and apply settings for security and personalization and customization.

FIG. 6 illustrates one embodiment of a screen 600 configured as a possible home screen of Central Server's (Connected Life Server's) registered Multidimensional Active Resources & Actions Provider(s) managed by the platform. Screen 600 enables Multidimensional Active Resources & Actions Provider(s) to obtain an at-a-glance view into the parts of their presence on the site; and obtain a convenient means of managing Profile(s), Privacy and Account Settings, Active Note(s) related Multidimensional Active Resources & Actions management, Other Multidimensional Active Resources & Actions Providers for collaboration, Friends, Contents, Explorer, Subscriptions and Subscribers, Applications & Services, Search Management 651 to 655 and All Statistics including Multidimensional Active Resources & Actions Provider(s)'s Ranks, Levels, Points and all types of Statistics. Explorer interface provide all types of functionalities comprising all active note(s) from all sources including one or more active note(s) from connected sources like friends, family, class mates, co-workers, colleagues and any connected & known people, category specific subscribers, public active note(s) and active note(s) provides(s), bookmarked active note(s) by Multidimensional Active Resources & Actions Provider and active notes from other Multidimensional Active Resources & Actions Providers for collaborative providing Multidimensional Active Resources & Actions to active note(s) provider(s) or transferred or assigned active note(s) for Multidimensional Active Resources & Actions. Multidimensional Active Resources & Actions Provider(s) includes any individual or entities including any individual or person or people, group(s) of individuals, connected individuals, company, manufacturers, service providers, organization, government department(s), institute, shop, society, friends, family, social connections, like minded individuals, similar activities or actions or work or professionals or location or language or income group or age or education or hobbies or qualification or any other match making or preferences specific individuals or persons or people, school, college, class, employers, employee, professionals, workers and like. Multidimensional Active Resources & Actions including all important things related to any types of active note(s) in user's life, all chronological updated information, experience, solution, execution steps & right directions, rank, comments, reviews, procedures, best way to do, features, blogs, text, messages, videos, audio, voice, photos, images, structured information including tags or categories specific contents like.

Explorer 620 & Explore Management 652 provides user friendly interface for navigating all active note(s) received or updated or downloaded or synchronized from all sources including connected or known, subscribed, public source via search & book mark, auto matched sources based on two way preferences in chronological or category or taxonomy wise, Multidimensional Active Resources & Actions Provider(s) can jump to any part of explorer, 3^{rd} click menu provides all functions or operations in single or in group mode like searching & viewing active note(s) related to particular date & time or category or location or user name or keyword(s) or one or more search phrases with Boolean operators and sort the results as per date & time or category or source. Multidimensional Active Resources & Actions Provider(s) can share or synchronizing or transferred or assigned one or more selected active note(s) with other connected Multidimensional Active Resources & Actions Provider(s) including groups, subscribed, connected or known like friends, family, co-workers, co-professionals, class mates, colleagues, likeminded unknown people and like from explorer. Multidimensional Active Resources & Actions Provider(s) can select any or more node of tree related to particular source or category of active note(s) provider(s) for providing Multidimensional Active Resources & Actions (add new or edit or modified or delete or associate metadata including one or more categories, taxonomies, keyword(s), notes, comments, ranks, status and like with one or more multidimensional active resource(s) & action(s) related to one or more active note(s). Multidimensional Active Resources & Actions Provider(s) can download or updates system all or domain or subject or categories wise one or more parent taxonomies (one or more levels or depths of categories) from the central server. Standard or system or default taxonomies provides compatibility with all users' life stream for sharing, data mining, synchronizing, sorting, organizing, viewing, comparing, searching, matching, categorizing, aggregating, filtering and like. Multidimensional Active Resources & Actions Provider(s) can add new user created or generated taxonomies or import from any sources and append to one or more parent system taxonomies or modify or delete user generated or created child taxonomies later at any time.

When Multidimensional Active Resources & Actions Provider(s) clicks on any tree like list of explorer, associate lists of active note(s) displayed to user 680 for managing one or more active note(s) or sub note(s) or N depths of sub note(s) for viewing the active note(s) and related Multidimensional Active Resources & Actions and metadata, Multidimensional Active Resources & Actions Provider(s) can select one or more active note(s) and Multidimensional Active Resources & Actions for group actions including organizing, aggregating, categorizing, sharing, assign rank or give comments or reviews and like. Multidimensional Active Resources & Actions Provider(s) can view updated active note(s) in categories like active note(s) from connected or known users or active notes providers or subscribers or from public sources or auto matched based on two way match making preferences. Multidimensional Active Resources & Actions Provider(s) can delete one or more Multidimensional Active Resources & Actions and resources or modify selected Multidimensional Active Resources & Actions and communicate with selected active note(s) related one or more active note(s) provider(s).

By using menu “Active Resources & Actions Provider's Profiles Management” 651, user can manage or create or update one or more domain or field specific profile(s) to the central server. Central server stores, updates, indexes all public, private and shared profile(s) and make them searchable for all or selected users for searching, book marking, subscribing Multidimensional Active Resources & Actions Provider(s). Multidimensional Active Resources & Actions Provider(s) can manage accounts and apply settings for security and personalization and customization.

By using menu “Active Resources & Actions Management” 653, Multidimensional Active Resources & Actions Provider(s) can create new or edit or delete or draft one or more Active Resources & Actions and associate metadata including date & time, category, author, types of resources, rank, set status and like, attach or detach one or more resources including text, message(s), link(s), video(s), audio, voice, files, images, photos, application(s), service(s), structures resource(s) and resources from other sources like search from current networks i.e. central server search engine (Global & public past Multidimensional Active Resources & Actions) or from other external networks, search resources from local network (past Multidimensional Active Resources & Actions), shared or subscribed or updated (via synchronization) resources from subscribed or collaboration sources i.e. other Multidimensional Active Resources & Actions Provider(s) with one or more Active Resources & Actions related to selected one or more active note(s) or active sub note(s). Multidimensional Active Resources & Actions Provider(s) can sort (date, time, source and category wise) or search or order or organize or select view types of Active Resources & Actions. Multidimensional Active Resources & Actions Provider(s) can sent or schedule all or selected one or more Multidimensional Active Resources & Actions to related one or more selected active note(s) provider(s). Multidimensional Active Resources & Actions Provider(s) can also transfer or assigned selected one or more active note(s) to other subscribed or group(s) of Multidimensional Active Resources & Actions Provider(s) and received Multidimensional Active Resources & Actions and route to said elated active note(s) provider(s).

By using menu “Active Notes & Active Note Providers Management” 654 Multidimensional Active Resources & Actions Provider(s) can receive one or more active note(s) from one or more active note(s) provider(s) including from connected or selected or subscribed or from central server search engine i.e. search from public sources, via bookmarks or auto matched based on two way match making preferences, transferred or assigned from other Multidimensional Active Resources & Actions Provider(s) or sources. Multidimensional Active Resources & Actions Provider(s) can clarify before providing Multidimensional Active Resources & Actions and communicate with active note(s) provider(s). Multidimensional Active Resources & Actions Provider(s) can assign rank & give comments to active note and/or to active note(s) provider(s), set status for active note(s), report abuse, sort and view as per choice or selection.

By using menu “Search Management” 655 Multidimensional Active Resources & Actions Provider(s) can search various things from the central server search engine including search domain or subject or keyword(s) or search query specific one or more public active note(s) and bookmark them for providing Multidimensional Active Resources & Actions to active note(s) provider(s). Multidimensional Active Resources & Actions Provider(s) can also search relevant Multidimensional Active Resources & Actions for particular active note(s) and update or sent to said active note(s) provider(s). For understanding user or active note(s) providers and related one or more active note(s) and providing relevant or contextual Multidimensional Active Resources & Actions, Multidimensional Active Resources & Actions Provider(s) can search and view all public or shared or filtered life stream and resources of active note(s) provider(s). Multidimensional Active Resources & Actions Provider(s) can search and/or bookmark and/or subscribe other related Multidimensional Active Resources & Actions Provider(s) for collaboration.

By using menu “Collaboration Management” 656, Multidimensional Active Resources & Actions Provider(s) can collaborate with other Multidimensional Active Resources & Actions Provider(s) including known or connected or like minded public sources or find people for current or existing or internal or external sources or networks or social networks and inviting them or subscribe Multidimensional Active Resources & Actions Provider(s) or set two way match making preferences for auto matching Multidimensional Active Resources & Actions Provider(s) by central server.

By using menu “Applications & Services” 655, Multidimensional Active Resources & Actions Provider(s) can search and associate or attach or detach one or more related application(s) and/or service(s) for particular or one or more active note(s) and sent to active note(s) provider(s).

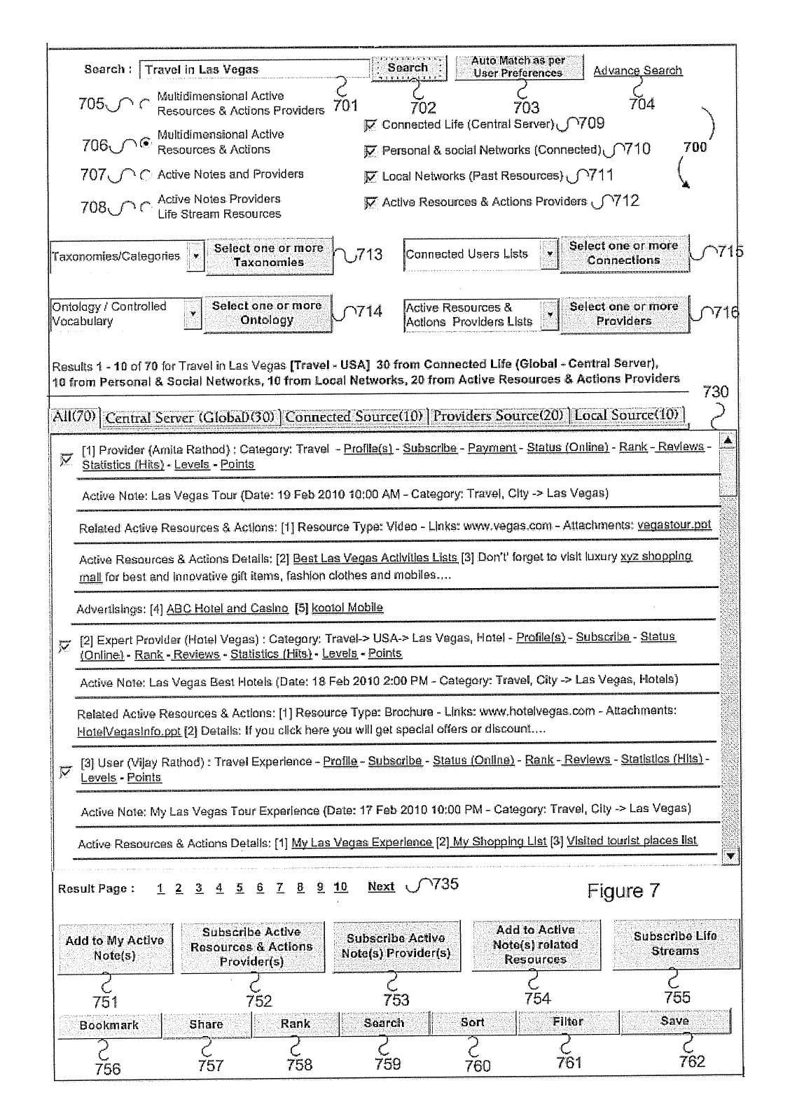

Registered user or active note(s) provider(s) and active resources & actions provider(s) or viewers (Non-Members), and other uses may employ a search interface; one embodiment of screen 700 is illustrated in FIG. 7 as an example.

Active note(s) provider(s) can search 702 or match as per preferences 703 one or more multidimensional active resources & actions 706 and active resources & actions providers 705 by entering one or more keyword(s), User name or ID, search query, phrases, Boolean operators or commands or conditions or rules to the search box 701. User can also filter or further limit what is displayed. Just use the filters available on the page to target results. Using the filters will limit results related to one or more selected categories, taxonomies 713, ontology, metadata, controlled vocabulary 714, connected users 715, active resources & actions providers 716. User can also select one or more sources of searches including search from global central server 709 and/or user's personal or social network(s) 710 and/or local network(s) 711 and/or selected one or more connected users and/or active resources & actions providers 712. Then user can select one or more active resources & actions providers for bookmarking 756 and/or subscribing the selected sources 752. User can search and select active note(s) specific one or more active resources & actions 706 and add to the active note(s) related list of multidimensional active resources & actions 751. User can also share 757, rank 758, sort 760, save 762 and filter 761 the said selected multidimensional active resources & actions and providers. Search results 730 display as per source clusters including central server, selected connected users, providers and local sources and tab interface facilities the user for switching from one tab to other tabs. Each search result of search results related to multidimensional active resource(s) & action(s) shows profile(s) link(s), name or user ID, categories, online status, rank, reviews or comments, hit statistics, levels & points and associate active note and related one or more multidimensional active resources & actions with metadata including date & time, resource type, one or more taxonomies, ontology, categories, attachments, web links, source, advertisements and like. Search results divided as per number of search results per page in to number of pages and user can navigate from one page to others 735. User can Sort 758 results 730 by recently updated, category wise, time & date wise, location wise and popularity wise including hits, visits, ranks. Searches can also allow wildcards. User or Providers can also employ advance search engine for providing one or more parameters or criteria like location(s), language(s), date & time range, one or more categories or selection for lists, rank and like 704.

User can click-through entry on search results list, resources from central server can then appear under “Central Server” tab, resources from selected connections can appear under “Connected Source” tab, resources from providers appear under “Providers Source” tab and resources from local pc or application or network can appear under “Local Sources” tab. Moreover, administrators, or the like, are able to search for users by username, or by email address (either of these can allow wildcard searches), or by some combination of Type (user, member, expert or admin) and Source, as defined by drop downs, or the like.

User can also search other users public life stream(s) sources & contents 708 and subscribe to one or more selected life stream(s) updates 755.

Multidimensional active resources & actions provider(s) can search 702 one or more active note(s) and/or active note(s) provider(s) 707 by entering one or more keyword(s), User name or ID, search query, phrases, Boolean operators or commands or conditions or rules to the search box 701. Provider's can also filter or further limit what is displayed. Just use the filters available on the page to target results. Using the filters will limit results related to one or more selected categories, taxonomies 713, ontology, metadata, controlled vocabulary 714. Provider's can select one or more active note(s) or subscribe to active note(s) provider's active note(s) updates for providing one or more multidimensional active resources & actions 753.

Multidimensional active resources & actions provider(s) can also search multidimensional active resources & actions provider(s) 705 for collaboration and search, select and add active note(s) specific multidimensional active resources & actions 706 and can search active note(s) provider's profile(s) 707 & public life stream 708 from the central for better understanding active note(s) and active note(s) provider(s). Provider can also share 757, rank 758, sort 760, save 762 and filter 761 the said selected multidimensional active resources & actions and providers and/or active notes and providers. Provider can sort 758 results 730 by recently updated, category wise, time & date wise, location wise and popularity wise including hits, visits, ranks.

Each search result of search results related to active note(s) shows profile(s) link(s), name or user ID, categories, online status, rank, reviews or comments, hit statistics, levels & points and associate active note and related one or more multidimensional active resources & actions with metadata including date & time, resource type, one or more taxonomies, ontology, categories, attachments, web links, source, advertisements and like. Search results divided as per number of search results per page in to number of pages and user can navigate from one page to others 735.

FIG. 8 is a logical flow diagram generally showing one embodiment of a process 800 for receiving and processing active notes from a client device, such as mobile device 135 of FIG. 1. Process 800 corresponds to FIG. 4, and illustrates at least some details that may be included in the actions of FIG. 4, or in other parts of the process 400.

Process 800 may employ at least a portion of the system illustrated in FIG. 1. It may employ any of the system variations as discussed herein, or it may be performed with other systems. In one embodiment, all, or at least a portion of the actions of process 800 may be performed by active note processor component 352 of FIG. 3.

Process 800 begins, after a start block, at block 801, where active note(s) provider(s) can identify any one or more note(s) of life stream as Active Note(s) or create new one or more Active Note(s) for one or more multidimensional resources & actions.

Process flow may then proceed to block 802 where active note(s) provider(s) can optionally determining one or more selected or subscribed or matched target responders or Active Resources & Actions Provider(s) or select default auto match option for submitting or sending or updating one or more active note(s).

Process flow may then proceed to block 803 where active note(s) provider(s) send or submit or synchronize or update one or more said identified Active Note(s) to the one or more selected or subscribed or matched multidimensional active resources & actions providers via Central Server(s) for one or more multidimensional active resources & actions.

Process flow may then proceed to block 804 where an active note(s) is received, stored, updated, validate, indexed and processed by the central server from a client device, such as mobile device 135 of FIG. 1. In one embodiment, the action of block 804 is performed by a Multidimensional Active Resources & Actions server, such as server 110 of FIG. 1. In one embodiment, the transmission of the active note(s) from the client device to the Multidimensional Active Resources & Actions server may include the use of an instant messaging mechanism. SMS and other messaging mechanisms or communication mechanisms may be used in the transmission or reception of the active note(s). Receiving the active note(s) may include extracting identifying information associated with the client device, such as a phone number, email address, location, or a user's identity. In one embodiment, the central server may process the active note(s) including language, content, meaning, check spelling, translation, decide priority, current location of user, source application(s) or device(s) or service(s) or network(s) information, associate one or more relevant matched resources including one or more part of life stream, past active note(s) & related ranked resources, active note provider's profile(s) covering preferences, personal profile, rank, points, levels, domain specific updated profiles like travel, health, education, jobs, food, entertainment, hobby, interest, business and metadata including one or more categories, taxonomies, ontology, keyword(s) and like related to the active note(s).

Process may then flow to block 805, where a target responder set is determined from a responder community. As discussed above, a responder may specify information, such as content areas of expertise, geographic areas, languages spoken, desired frequency of active note(s), or the like. Any one or more of these specifications may be used to determine an appropriate target responder set. A time since being sent a most recent active note(s) may also be used to determine a target responder set. A responder's history may be used; for example, the number of points a responder has received may be a factor. Central server routing or sending or updating said Active Note(s) to user's selected one or more target responders or Active Resources & Actions Providers or Determining target responders based on auto matching or Active Note(s) Provider(s)' preferences based matching.

In one embodiment, determining a target responder set may include selecting responders based on their geographic location or geographic locations in which each responder has expertise. A geographic area may be determined based on an Active Note(s) Provider's Active Note. An Active Note may explicitly state a geographic area, such as in an Active Note(s), “I am traveling in USA and now in New York City”. An Active Note(s) may suggest that the multidimensional active resources & actions is to be limited to a geographic area, and the area may be determined based on information received from a client device or from other knowledge of the Active Note Provider(s). For example, a client device may transmit a location based on a GPS or other location determination mechanism. In another example, a prior communication from an Active Note(s) Provider(s) may indicate the user's location. In one embodiment, an active note(s) is analyzed to determine whether a response is to be limited to a geographic area. An analysis may, for example, determine that active note(s) pertaining to certain types of businesses, products, or services are to be limited to a geographic area, while other businesses, products or services are not so limited. For example, an analysis of a an active note(s) about a hair oil may indicate a limited geographic area, while a active note(s) about foreign tour or a luxury brands may indicate a nationwide or worldwide geographic area.

Processing may then flow to block 806, where the processed & validated Active Note(s), which may include any supplementary information, is sent to each of the responders or multidimensional active resources & actions providers in the target responder or multidimensional active resources & actions providers set. Thus, each target responders or Active Resources & Actions Providers can receive one or more prepared active note(s) from the central server. A determined timeout period may be sent with the active note(s). In one embodiment, this is transmitted using an IM mechanism. In some embodiments, SMS or other communication mechanisms or protocols may be employed. A multidimensional active resources & actions server may use a first communication mechanism for a portion of the target responder or multidimensional active resources & actions providers set and a second communication mechanism for a second portion of the target responder or multidimensional active resources & actions providers set.

Processing may then flow to block 807, where one or more targeted Active Resources & Actions Provider(s) can identifying a resource utilized for a Multidimensional Active Resources & Actions for said received one or more active note(s) from one or more active note(s) provider(s) from the central server including searching or subscribing said active note(s) provider's related resources and public & shared life stream, one or more active note(s) domain or category or subject(s) related profile(s) and like.

Processing may then flow to block 808, where Active Resources & Actions Provider(s) can determine at least one concept based on an analysis of the one or more Active Note(s). At a decision operation, the active resources & actions providers determines whether any known concepts are identified from the submitted active note(s). The active resources & actions providers may perform a lookup operation for concepts associated with the active note(s), or may perform other interpretations, such as natural language processing, to determine concepts. Concepts generally identify categories of information related to the active note(s). For example, the active note(s) “New York City” is related to the concept of a city and the concept of a play. As another example, the search term “New York Shopping Mall” is related to the concept of a luxury branded products availability and the concept of shopping in the city of New York.

Domain or subject specific experts or experienced or qualified or known multidimensional active resources & actions providers can use active note(s) provider(s) all resources including matched domain specific profile(s), past active note(s) & related active resources & actions and ask more details or ask question(s) or clarify the active note(s) or communicate with active notes) provider(s) using any communication application(s), service(s), device(s) and networks like instant messenger (IM), mobile phone, e-mail, VOID, online web sites and search active note(s) specific other similar users active notes & related active resources and action(s) and analyze the said active note(s) from multiple view points or angles before determining the one or more relevant or contextual concept(s) or multidimensional view points.

Each concept may also associate with one or more particular data sources. For instance, play or movie schedules for local theaters may be in specific data sources that would not normally be searched unless it is determined that the user intends the search term to be associated with a play or movie. Other examples of concept-specific data sources may include, but are not limited to:

E.g. web stock quote data, photos, image, dictionary, plane schedules, podcasts, video, entertainment, local listings, encyclopedia, products, news, events, ringtones, weather, cruise, schedules, guides, multimedia, finance, address, books, flight status, shopping, astrology, games, sports, audio, music, cinema ticket booking, cricket match ticket bookings, products inventory, thesaurus, books, job, bus schedules, landmarks, time zones, celebrities, lottery, train schedules, cities, movie show times, translations, classifieds, movie theaters, traffic, TV show times, countries, currency, people, events or venues, and like.

Processing may then flow to block 809, where Active Resources & Actions Provider(s) can clarify the Active Note(s) and one or more identified concept(s) related to Active Note(s) with the Active Note(s) Provider(s) for better understanding user's active note(s), activities, requirements, interest, behavior, and like.

Processing may then flow to block 810, where Active Resources & Actions Provider(s) can performing a search of Active Resources & Actions over each of the one or more concept(s) from plurality of sources including central server search engine, online web sites, local hard drive, deep databases, paid data sources, services, collaboration of searching, human mind, peer to peer search, a bookshelf and a non-public sources and like.

Processing may then flow to block 811, where Active Resources & Actions Provider(s) can identifying and drafting relevant one or more concept-specific active resources & actions based on the at least one concept for active note(s). For drafting contextual Active Resources & Actions, Active Resources & Actions Providers can employ his/her experience, analysis, human mind, knowledge, information, database(s), multiple resources, sources, people including collaborations with other Active Resources & Actions, connections, experts, paid services, one or more applications, services, online web sites and like. Active Resources & Actions Provider(s) can be any types of individual or group of individuals (multi users) or paid or free or sponsored experts like individual or person or groups or any company or branded company or organization or volunteers or government departments or automated source(s) or service(s) or database(s) or device(s) or one or more or multiple artificial agents and like. Active Resources & Actions Provider(s) can integrate or embedded or associate one or more relevant advertising(s) of any formats including text, video, images(s), multimedia, audio, advertising(s) automatically and/or selecting manually (human mediated) and additional information and metadata.

Processing may then flow to block 812, where Active Resources & Actions Provider(s) can submitting or sending or synchronizing or updating said one or more Active Resources & Actions for said Active Note(s) to the Central Server. Active Resources & Actions Provider(s) can employ one or more communication and collaboration applications, services, devices, technologies and networks including online or mobile web site or portal, peer to peer application, smart client desktop or mobile application, mobile or smart devices, SMS, IM, email, chat, customize application, sensors, data transfer protocols, voice enabled or translating technologies, enterprise application, web services, APIs, scripting, programming languages for sending or submitting or updating said active note(s) related Active Resources & Actions to the central server or directly to the user or active note(s) provider(s).

Processing may then flow to block 813, where the central server receiving from each of at least a portion of the target responders or active resources & actions provider(s), a response or multidimensional active resources & actions and processing responses from responder devices, such as responder client devices 150-152 of FIG. 1. Process of block 813 corresponds to blocks 456 & 457 of FIG. 4, and illustrates at least some details that may be included in the actions of blocks 456 & 457, or in other parts of the process 400. Process of block 813 may employ at least a portion of the system illustrated in FIG. 1. It may employ any of the system variations as discussed herein, or it may be performed with other systems. In one embodiment, all, or at least a portion of the actions of process of block 813 may be performed by Response or Active Resources & Action(s) Processor component 354 of FIG. 3.

In one embodiment, the action of block 813 is performed by a multidimensional active resources & actions server or Connected Life Central Server or central server, such as server 110 & database 111 of FIG. 1. In one embodiment, the transmission of the response from the responder client device to the central server may include the use of an instant messaging mechanism. SMS and other messaging mechanisms or communication mechanisms may be used in the transmission or reception of the responses.

Receiving a response may include receiving information identifying the corresponding active note(s) that was previously sent to the responder. It may include retrieving information identifying the responder. As discussed above, it is envisioned that the invention may be practiced in an environment that include a large community of responder clients. It is further envisioned that the set of target responders, and the number of responses received, may number in the hundreds, thousands, hundreds of thousands, millions, or virtually any number.

A received response may include information in one or more of a variety of types or formats. A response may include a text response, a message, an image, a link, video, audio, photo, image, voice, sound, any types of files, databases, any types of formats, another type of data, application, service, or a combination thereof.

Processing may then flow to block 814, where the Central Server stores or updates and validates or processes and indexes said active note(s) and related Multidimensional Active Resources & Actions with ranks and metadata for routing to active note(s) provider(s) and make said resources searchable for other similar users or searchers. Central server can validates the said each resources including spam scanning, virus scanning, language interpretation, source scanning, optionally human mediated checking, spell checking, translation and formatting said resources including formatting as per preferences or destination one or more applications or services or devices or networks types for end user or active note(s) provider(s). Central server can also associate one or more relevant or contextual advertisements automatically and/or manually (human mediated) of any formats including text, video, images(s), multimedia, audio, advertising(s) integration or embedding with resources and additional information, metadata, system data with said active note(s) specific resources before sending to active note(s) provider(s) or user.

Processing may then flow to block 815, where the central server can routing or sending or updating the response or active resources & actions with advertisements to the user on client device & application.

Processing may then flow to block 816, where the Active Note(s) Provider(s) can receiving active note(s) related multidimensional active resources & actions, and perform any types of post operations like viewing, organizing, formatting, categorizing, sorting, comparing, printing, merging, selecting, using, following, executing and assign rank, associate metadata, give comments to selected or used or liked or executed one or more multidimensional active resources & actions.

Processing may then flow to block 817, where the Active Note(s) Provider(s) can submitting or sending or synchronizing or updating active note(s) and related Active Resources & Actions with assigned ranks and comments to the Central Server.

Processing may then flow to block 818, where the central server can receiving, updating, storing, formatting, categorizing, organizing, validating, indexing and processing said active note(s) and related multidimensional active resources & actions updates from the Active Note(s) Provider(s).

Processing may then flow to block 819, where the central server providing a search engine for searching all public & shared Active Note(s) related Active Resources & Actions to the users or all searchers and multidimensional active resources & actions providers based on one or more search criteria including keywords, taxonomies, categories, ontology, Boolean operators, selected sources for reusing, re-filtering and re-ranking said resources up to (N) numbers of depths & times.

Process 800 may then return to a calling program. In one embodiment, processing may continue at block 801, described in FIG. 8 or continue at block 416, described in FIG. 4.

It will be understood that each block of the flowchart illustrations of FIGS. 4, 8 and 9, and combinations of blocks in the flowchart illustrations can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustrations may also be performed concurrently with other blocks or combinations of blocks, or even in a different sequence than illustrated without departing from the scope or spirit of the invention.

Accordingly, blocks of the flowchart illustrations support combinations of means for performing the specified actions, combinations of steps for performing the specified actions and program instruction means for performing the specified actions. It will also be understood that each block of the flowchart illustrations, and combinations of blocks in the flowchart illustrations, can be implemented by special purpose hardware-based systems which perform the specified actions or steps, or combinations of special purpose hardware and computer instructions.

FIG. 9 is a logical flow diagram of step by step example generally showing one embodiment of a process 900 for receiving and processing active notes from a client device, such as mobile device 135 of FIG. 1. Process 900 corresponds to FIG. 4 and FIG. 8, and illustrates at least some details that may be included in the actions of FIG. 4 and FIG. 8, or in other parts of the process 400 and 800. Process 900 may employ at least a portion of the system illustrated in FIG. 1. It may employ any of the system variations as discussed herein, or it may be performed with other systems. In one embodiment, all, or at least a portion of the actions of process 800 may be performed by active note processor component 352 and Response or Active Resources & Action(s) Processor 354 of FIG. 3.

Process 900 begins, after a start block, at block 910, where active note(s) provider(s) can submit Active Note: e.g. “I am traveling in USA and now in New York City” with one or more metadata, taxonomies, categories, ontology and list of selected targeted responder to the central server. Central server route said active note(s) to 915 user selected targeted responder or multidimensional active resources & actions providers. Multidimensional active resources & actions providers receive said active note(s) of said active note(s) provider(s) from central server and determining and identifying one or more suggested concept(s) 920 based on user's current active note, profile(s), life stream, past active notes & resources and optionally verified or clarified with active note(s) provider(s) by communicating with said active note(s) provider(s). e.g. multidimensional or multi mode concept(s) for said active note(s) includes [1] New York City Travel Experience, [2] Shopping of new types of innovative gifts, [3] Book Tickets (Hotel, Flight, Cruise), [4] You like books, so you want to purchase books on technology and [5] You are with family and you are rich. So you like to purchase luxury items which not available in your country.

Then, said one or more providers can provides one or more multidimensional active resources & actions for all or each selected suggested concept(s) and sub-concept(s) to active note(s) provider(s) e.g. based on concept 925 [2] Shopping of new types of innovative gifts, provider provides related multidimensional active resources & actions including e.g. [2.1] You want to purchase gift items?; (Clarify) Yes, for my wife.; MDAR&A: List of hand bags & shopping addresses with features & Images (Links), [2.2] currently where are you?; (Clarify): I am at Times Square.; MDAR&A: Visit Macy store, you will get large range of cloths and based on concept 925 [4] You like books, so you want to purchase books on technology, provider provides related multidimensional active resources & actions including e.g. [4.1] Technology books exhibition at time Square; Directions: Link; Video Resources, and [4.2] New York Library List.

Then Active Note Provider(s) can selects, use, like, follow, execute and rank 940 one or more said multidimensional resources & actions related to said Active Note e.g. user select & use or implement concept 925 [2] Shopping of new types of innovative gifts, based multidimensional active resources & actions 931 [2.1] You want to purchase gift items?; (Clarify) Yes, for my wife.; MDAR&A: List of hand bags & shopping addresses with features & Images (Links) and concept 926 [4] You like books, so you want to purchase books on technology, based multidimensional active resources & actions 932 [4.1] Technology books exhibition at time Square; Directions: Link; Video Resources and provides comments and assign ranks to each selected or used or liked or implemented or executed said multidimensional active resources & actions e.g. 950 [2.1] Comments: I Purchased Kootol bag from New York City, I like much. This is the luxury diamond bag I m looking for. Thank You; My Ranks->7 out of 10; Associated Metadata: <List>, and [4.1] Comments: Oh my god, thousands of books is there. I purchased at least 10 books. I like presentation on kootol technology; My Ranks->8 out of 10; Associated Metadata: <List> and submit said resources with rank and comments to the 960 central server for making them searchable for 970 other users, multidimensional active resources & actions providers and searchers. e.g. 970 if searcher search “Travel to New York City” to the central server 460 then search results contains all ranked multidimensional active resources & actions related to said search query or keyword(s).

### Website Architecture

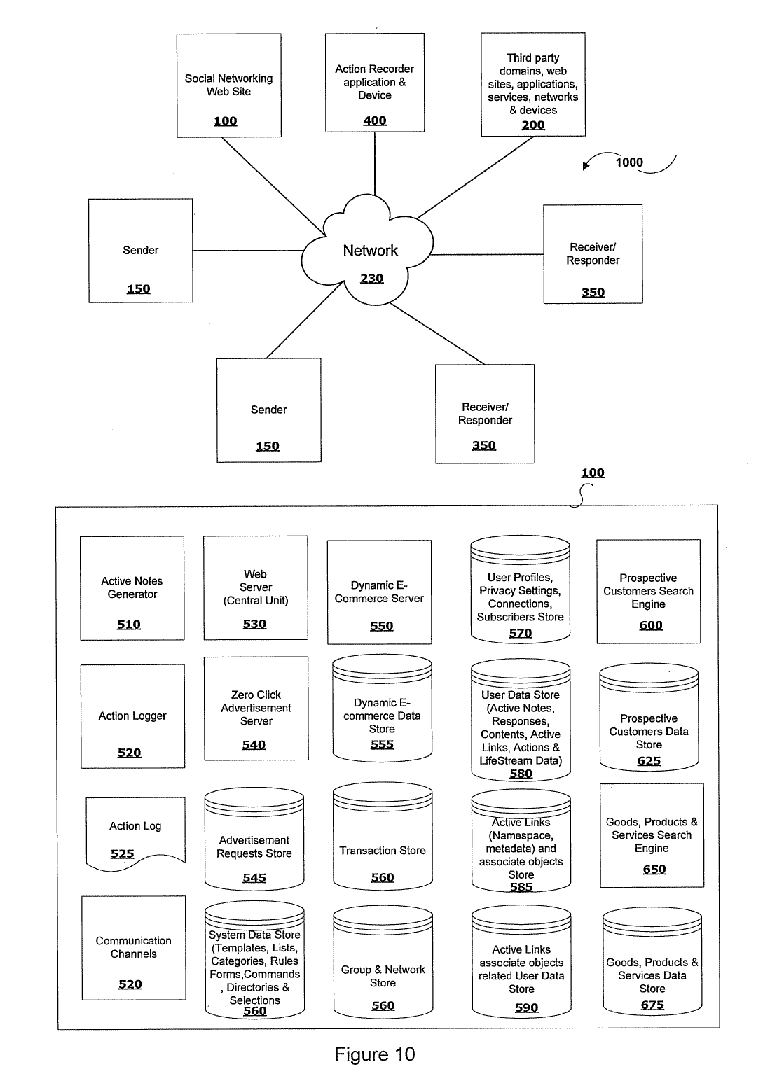

FIG. 10 is a high level block diagram illustrating a system environment suitable for operation of a social networking website 100. The system environment comprises one or more client devices 150 and 350, one or more third-party third party domains, web sites, applications, services, networks & devices 200, a social networking website 100, and a network 230. In alternative configurations, different and/or additional modules can be included in the system.

The client devices 150 and 350 comprise one or more computing devices that can receive member input and can transmit and receive data via the network 230. For example, the client devices 150 and 350 may be desktop computers, laptop computers, smart phones, personal digital assistants (PDAs), or any other device including computing functionality and data communication capabilities. The client devices 150 and 350 are configured to communicate via network 230, which may comprise any combination of local area and/or wide area networks, using both wired and wireless communication systems. As described above, the third party domains, web sites, applications, services, networks & devices 200 and the action recorder-150 are coupled to the network 230 for communicating messages to the social networking website 100 about the members' actions off the website 100.

The social networking website 100 provides customize, contextual, unified and integrated communication to users of network for that social networking website 100 registering each members and receives and stores each users profiles, privacy settings, preferences, connections with other users of network to user profile store 570, allow sender 150 to determine one or more target receivers 350 based on one or more connections, match making, selections, subscriptions stored at user profile & connection store 570, allow sender 150 to dynamically associate one or more identified active links with active note (message) or response of active note (message) based on active links owned, uploaded & registered, controlled by user or matched active links provided by other connected users, advertisers, responders, service providers and social networking website 100 stored at active links and associate accessible objects store 585, allow sender 150 to send or post said active note (message) or response of active note (message) with active link(s) to determined target receivers 350, wherein said active link(s) enables receivers 350 to sell, purchase, transact, communicate, collaborate, workflow, provide response, participate in same activities as sender and access the active link(s) for message specific purpose in an integrated, contextual and unified manner. The social networking website 100 receiving, storing and processing said active note (message) or response of active note (message) at the web server 530 and storing in user data store 580 and presenting said active note (message) or response of active note (message) to determined target receivers 350 as per preferences & privacy settings. The social networking website 100 allow user to take one or more actions on said active note, related response and associate active links and monitor, track, store, filter and records said one or more user actions in user data store 580.

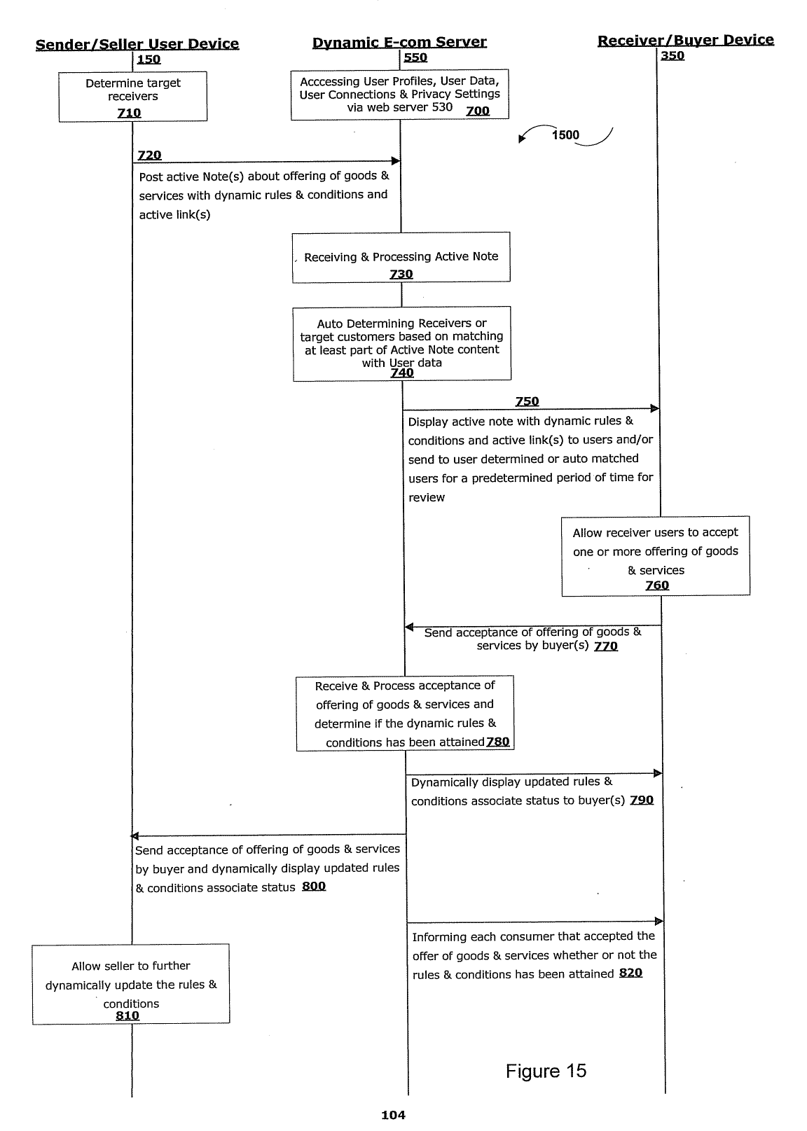

The social networking website 100 also provides dynamic e-commerce server 550 and related e-commerce data store 555 describes in detail in FIG. 15.

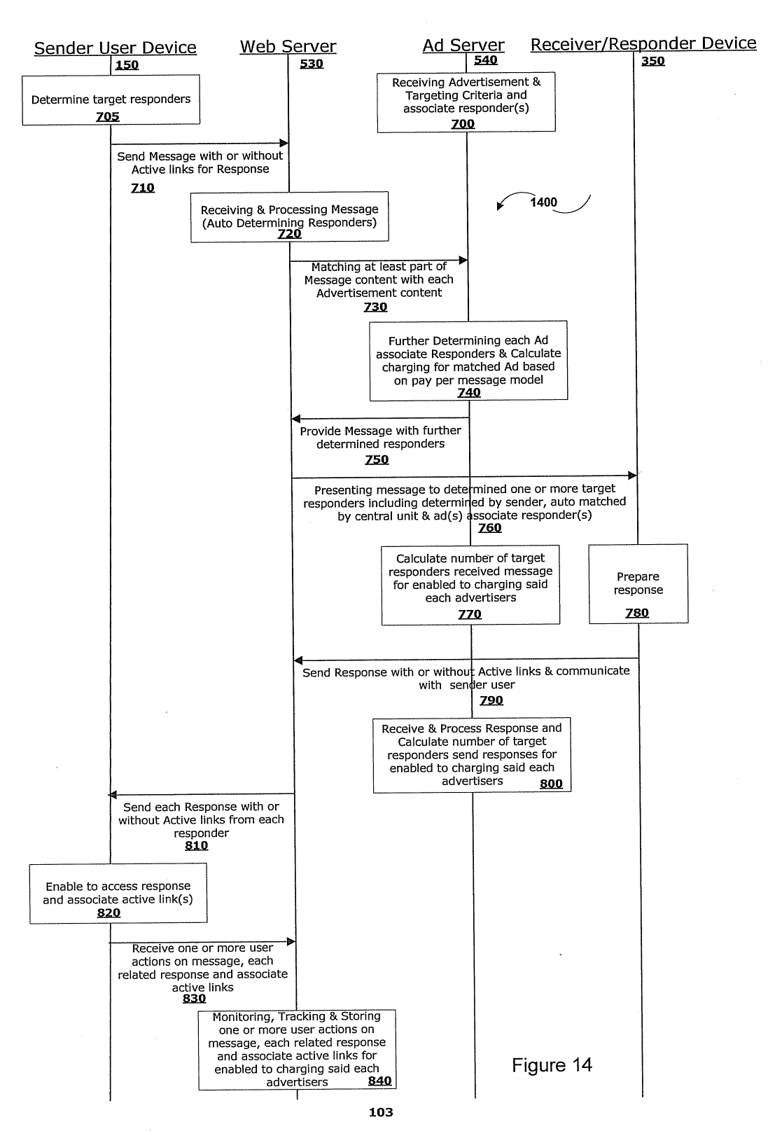

The social networking website 100 also provides zero click advertisement server 540 and advertisement request store 545 describes in detail in FIG. 14.

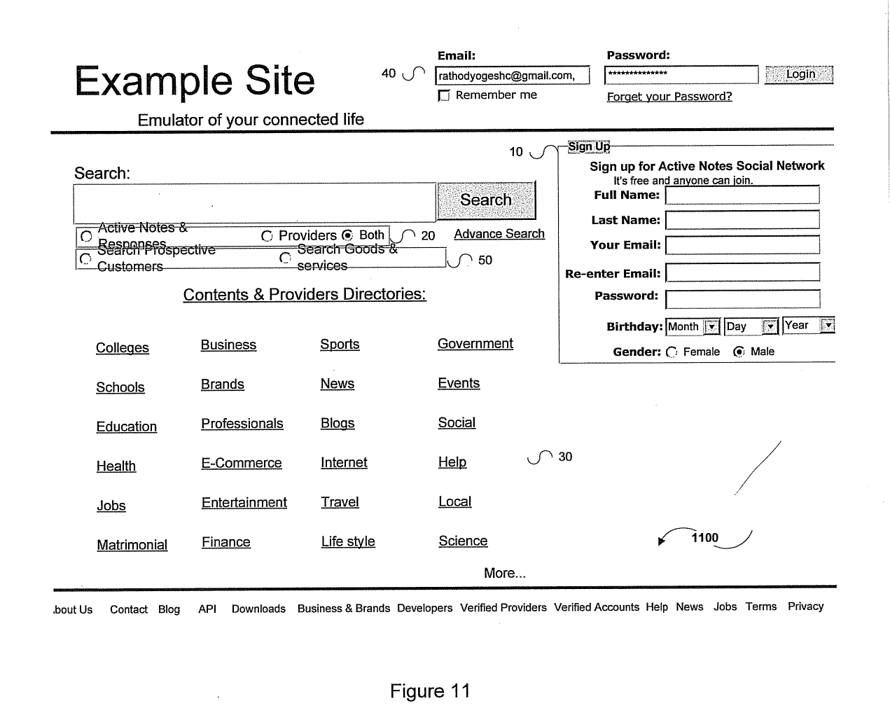

The social networking website 100 also provides Prospective Customers Search Engine 600 and Prospective Customers data store 625 describes in detail in FIG. 11—50.

The social networking website 100 also provides Goods, Products & Services Search Engine 650 and Goods, Products & Services Data Store 675 describes in detail in FIG. 11—50.

The social networking website 100 comprises a computing system that allows members to communicate or otherwise interact with each other and access content as described herein. The social networking website 100 stores member profiles that describe the members of a social network, including biographic, demographic, and other types of descriptive information, such as work experience, educational history, hobbies or preferences, location, and the like. The website 100 further stores data describing one or more relationships between different members. The relationship information may indicate members who have similar or common work experience, group memberships, hobbies, or educational history. Additionally, the social networking website 100 includes member-defined relationships between different members, allowing members to specify their relationships with other members. For example, these member defined relationships allows members to generate relationships with other members that parallel the members' real-life relationships, such as friends, co-workers, partners, and so forth. Members may select from predefined types of relationships, or define their own relationship types as needed.

FIG. 10—100 is an example block diagram of a social networking website 100. The social networking website 100 includes a web server 530, an action logger 520, an action log 520, an active notes generator 510, an ad server 540, a database of ad requests 545, en e-commerce server 550, e-commerce data store 550, a member profile including privacy settings, preferences & connections store 570, a group & network store 560, an event store, each active link related namespace, properties, metadata & associate objects store 585, each active link associate object or application related user data store 590, a transaction store 560, user data store including active notes, responses, contents, active links, actions & LifeStream data store 580 and system data store including templates, lists, categories, taxonomies, keywords, rules forms, commands, directories & various selections 560. In other embodiments, the social networking website 100 may include additional, fewer, or different modules for various applications.

The web server 530 links the social networking website 100 via the network 230 to one or more client devices 150 and 350, as well as to one or more third party websites 200. The web server 530 may include a mail server or other messaging functionality for receiving and routing messages between the social networking website 100 and the client devices 150 and 350 or third party websites 200. The messages can be instant messages, queued messages (e.g., email), text and SMS messages, or any other suitable messaging technique.

The action logger 520 is capable of receiving communications from the web server 530 about member actions on and/or off the social networking website 100. The received actions can occur within the social networking website 100 as well on other websites, via an application programming interface exposed by the social networking website 100. In one embodiment, the social networking website 100 maintains the action log as a database of entries. When an action is taken on and/or off the social networking website 100, an entry for that action is generated and stored by the action logger 520. Examples of user actions within the social networking website 100 include adding resources & notes to user's LifeStream including adding health report, results, bills, invoices, scanned documents and describe in detail in specification, posting active notes, receiving active note related responses, attaching active links, take one or more actions on each active note, related response and active links including purchase or sell products, book tickets, user likes one or more brands, joining a group, communication & sharing with other users. Examples of user actions outside of the social networking website 100 include purchasing or reviewing a product or service using an online marketplace hosted by a third-party website 140, auto recorded, auto detected, auto sensed, auto selected or extracted from user's life stream, auto extracted from video or audio or images, auto identified, auto determined, auto generated and auto posted one or more active notes (messages) from one or more applications, services, networks and devices based on monitoring, tracking and recording of user actions, events, current location, transactions & activities by action recorder applications & devices 400.

The action logger 520 includes data describing the member performing the action, the date & time the action occurred, an identifier for the member who performed the action, an identifier for the member to whom the action was directed, an identifier for the categories of action performed, an identifier for an object acted on by the action (e.g., an application), content associated with the action, identifying one or more objects associate with actions, dynamically identifying and associating one or more active links & applications or application features with action, who-what-where-when-how-where about the action occurred and/or other data describing the action. The action logger 520 can communicate with the all active links, objects, applications, services, groups, networks, data & content stores of network related to actions and/or user related to action. The action logger 525 can organize the stored action data according to an action identifier which uniquely identifies each stored action.

The active notes generator 510 generates communications for each member about information that may be relevant to the member. These communications may take the form of active notes, each active note is an information message comprising one or a few lines of information about an action in the action log that is relevant to the particular member. The active notes are presented to a member via one or more pages of the social networking website 100, for example in each member's home page or active notes page. An active note is a message that summarizes, condenses, or abstracts one or more member actions from the action log 525. The generated active notes can then be transmitted to one or more related members e.g., the member's connected users, friends, subscribers, and auto matched responders allowing the member's actions to be shared with related members. More about user action describe in U.S. patent application Ser. No. 11/995,343, titled: “A method and system for communication, publishing, grouping, advertising, searching, sharing and dynamically providing a Journal Feed” and divisional U.S. patent application Ser. No. 12/973,370, titled: “A System and method for publishing, communication and real time searching”

FIG. 11 illustrates an exemplary GUI 1100 for home of example site where guest or unregistered users & registered users without log-in can search public contents 20 or browse directories 30 of ranked public contents including active notes, related responses, associate active links and user actions. User can register by sign-up 10 with the system by entering basic user details including name, user name or email, password, birth date and gender for quick registration. After basic registration user can sign-in 40 with the system by entering username or email and password. Registered users can search 20 & browse directories 30 and subscribe providers or responders. User can register as a general or anonymous user or verified user. User can also create multiple users accounts or linked accounts. User can act as an active note(s) sender user and/or responder user. Responder user can create one or more service profiles for providing service based responses or user can update basic responded details for providing responses to other users.

FIG. 11—50 illustrates an exemplary prospective customers search engine GUI. Web server 530 of the social networking web site 100 receives, stores 580, indexes, orders, ranks and processes active notes and associate data including metadata, attachments, privacy settings, list of responders, responses, communications, active links and user actions from plurality of users for making them searchable for other users. Web server 530 identifies prospective customers' related active notes from said plurality of active notes based on said active notes and associate data and stores and process said identified prospective customers' related active notes with metadata at Prospective Customers Data Store 625. In one embodiment, searching user enter search query to GUI FIG. 11—50 or search engine 600 for searching prospective customers related active notes and associate data & active links for identifying prospective customers. Prospective Customers Search Engine 600 of web server 530 presents ranked & chronological search results to searching user based on matching search query with said identified prospective customers data for said search query comprising one or more identified active notes & associate data including active links related to one or more prospective customers, wherein said each active link(s) associate with active note enable searching user to provide response, communicate, collaborate, participate, make offer, provide deal, sale product or ecommerce, workflow, make transaction with buyer, negotiate, provide discount, share and provide media data & information to related prospective customer or sender of active note and notify each author or sender of each active note of search results about searching user searches, selects and received said search results related active notes and allow each author or sender of active note to communicate, collaborate, participate, accept offer, receive deal, buy product or ecommerce, make transaction with seller, negotiate with seller, ask or receive discount, share and receive media data & information with selective one or more active note receiver or seller with receivers based on said active note associate active link(s).

FIG. 11—50 illustrates an exemplary prospective goods, products & services engine GUI. Web server 530 of the social networking web site 100 receives, stores 580, indexes, orders, ranks and processes active notes and associate data including metadata, attachments, privacy settings, list of responders, responses, communications, active links and user actions from plurality of users for making them searchable for other users. Web server 530 identifies offering of goods and services related active notes from said plurality of active notes based on said active notes and associate data and stores and process said identified offering of goods and services related active notes with metadata at Goods, Products & Services Data Store 625. In one embodiment, searching user enter search query to GUI FIG. 11—50 or Goods, Products & Services Search Engine 650 for searching offering of goods and services related active notes and associate data & active links for identifying goods and services. Search engine 600 of web server 530 presents ranked & chronological search results to searching user based on matching search query with said identified offering of goods and services data for said search query comprising one or more identified active notes & associate data including active links related to one or more offering of goods and services, wherein said each active link(s) associate with active note enable searching user to communicate, collaborate, participate, accept offer, receive deal, buy product or ecommerce, make transaction with seller, negotiate with seller, ask or receive discount, share and receive media data & information from publisher of active note or seller of goods & services and notify each author or sender of each active note of search results about searching user searches, selects and received said search results related active notes and allow each author or sender of active note to provide response, communicate, collaborate, participate, make offer, provide deal, sale product or ecommerce, workflow, make transaction with buyer, negotiate, provide discount, share and provide media data & information to selected one or more active note receiver or buyer of goods & services based on said active note associate active link(s).

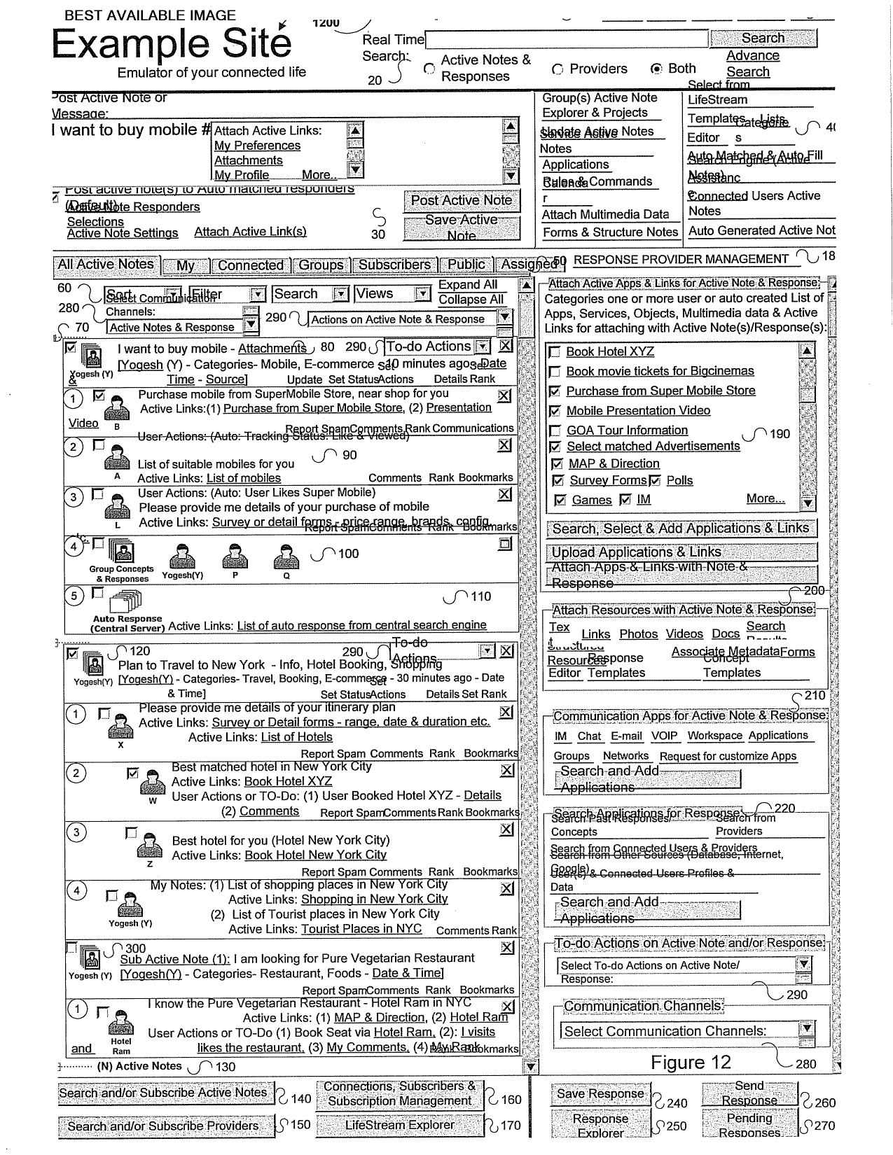

FIG. 12 illustrates an exemplary GUI 1200 for User home & profile where system provides User Settings 10 for editing and updating user Account(s), update or edit user profile(s) including user details and responders details, one or more service profile(s), privacy settings & preferences, 3^{rd} parties applications & services related privacy settings, change password, notification setting including notify user when some events triggers, mobile settings for enabling system over mobile & other smart device, language selection, provide or update payment information, preferences for auto match making and dynamically creating group(s), update user connections or contacts via suggested users list, fording people from present network or other sources, searching & matching and/or subscribing users or responders, invite other users or accept invitation from other users, browse directories for searching categories users or responders, subscribe one or more users or responders or service providers, join one or more networks & groups. User can create & update one or more categories lists and groups and attach or detach one or more connections to each list or group. User can also manage categories list of Subscribers & Subscriptions for sending active notes & messages and providing responses. User can search, add or install, delete one or more applications, services and communication channels with profile or user home.

Central unit FIG. 10—530 maintaining for each of plurality of users of network(s), a user account(s) including verified account and anonymous or general account, one or more public, private & shared user profile(s) for active note providers and/or responders, service profiles of service provider responders, preferences & privacy settings for connected users, communication channels, applications, contents, profiles, activities and actions and maintaining set of user connections with other users of the network(s) and allowing users or active note(s) provider(s) and responders to creating and updating connections list(s) based on contacts, invitations, finding people from internal or external networks, searching & matching, subscribing, bookmarking and match making based on privacy settings & preferences.

Central unit FIG. 10—530 also maintaining applications, services, communication channels, list of applications, services, communication channels of 3^{rd} parties and associate system & user data, list of categories networks & groups and associate users, users connections & users data and maintaining active links, applications or application features links, shared workspace links for attaching with active note by active note sender or with response by responder, contents including any types of multimedia data, transactions, messages, updated user status actions and events.

FIG. 12 illustrates an exemplary GUI 1200 for User home & profile where user can mange active notes and related all response & communications 30 & 50 as well as manage providing responses and related all communications 180. Active Notes Management including Active Note Posting Management 30 where user can draft & manually post or auto post or conditional post Active Note(s) related to Active Notes & Responses Communication Channel or post messages related to one or more other communication channels.

User can draft active note(s) or select one or more other options 40 for sending Active Note(s) including managing and posting plurality of categories group(s) of Active Note(s) by multiple users via project or explorer management, update posted Active Note(s), Search & select from past Active Note(s), Services related ready Active Note(s) or templates, Active Note(s) related applications like travel, finance, marketing, e-commerce, health, Select one or more Active Note(s) integrated & interpreted rules, conditions, commands and part of Active Note(s), use calendar for selecting & updating drafted Active Note(s), select one or more multimedia data as Active Note(s) including video, image, file, docs, link or URL and text, draft or select Active Note(s) from subject specific categories forms or structured Active Note(s) for surveying user including user can select one or more products or brands from list to sell or purchase or refer or publish, select one or more Active Note(s) from one or more categories updated lists including list of brands used by user, list of brands like by user and other updated lists, select Active Note(s) from user's Life stream describe in detail in FIGS. 5 & 6, select Active Note(s) from categories templates, use full features editor for drafting Active Note(s), search & select Active Note(s) based on one or more search criteria, auto match Active Note(s) based on one or more keywords, categories, selections, profile, past active notes, responses, life stream data, user behavior, relevancy & preferences, use expert assistance from user connected users and subject or domain specific responders for drafting and preparing Active Note(s), search & match user connected users Active Note(s). System can also auto generate one or more Active Note(s) based on monitoring, storing or recording user's filtered or selected activities, actions, events and transactions and dynamically attaching one or more active links & apps and posting said auto generated Active Note(s) to user connected users or subscribers or matched users, wherein active links & apps enabling receiving users or responders to participate, communicate, collaborate, sell or ecommerce with Active Note(s) provider users.

User can apply or set various settings with all (default settings) or to each posted Active Note(s) including associate one or more categories, keywords, metadata, attachments of multimedia data including links, images, video, files, apply security & privacy settings including public, private & shared and selections of Active Note(s) receivers or responders, select type or categories of Active Note(s) including share, communication, e-commerce, search, task and communication channel type or name, Set conditions, rules, schedule Active Note(s) posting or Auto Post of Active Note(s) settings based on calendar, events, date & time range, make Active Note(s) as Group Notes based on invitation, provide details, categories survey forms based details, set auto generated notes related settings, other settings related to show active note related response to other providers for better & relevant contextual response, select communication channels or apps for posting active note or messages, select preferred communication channels or apps or device for receiving response(s).

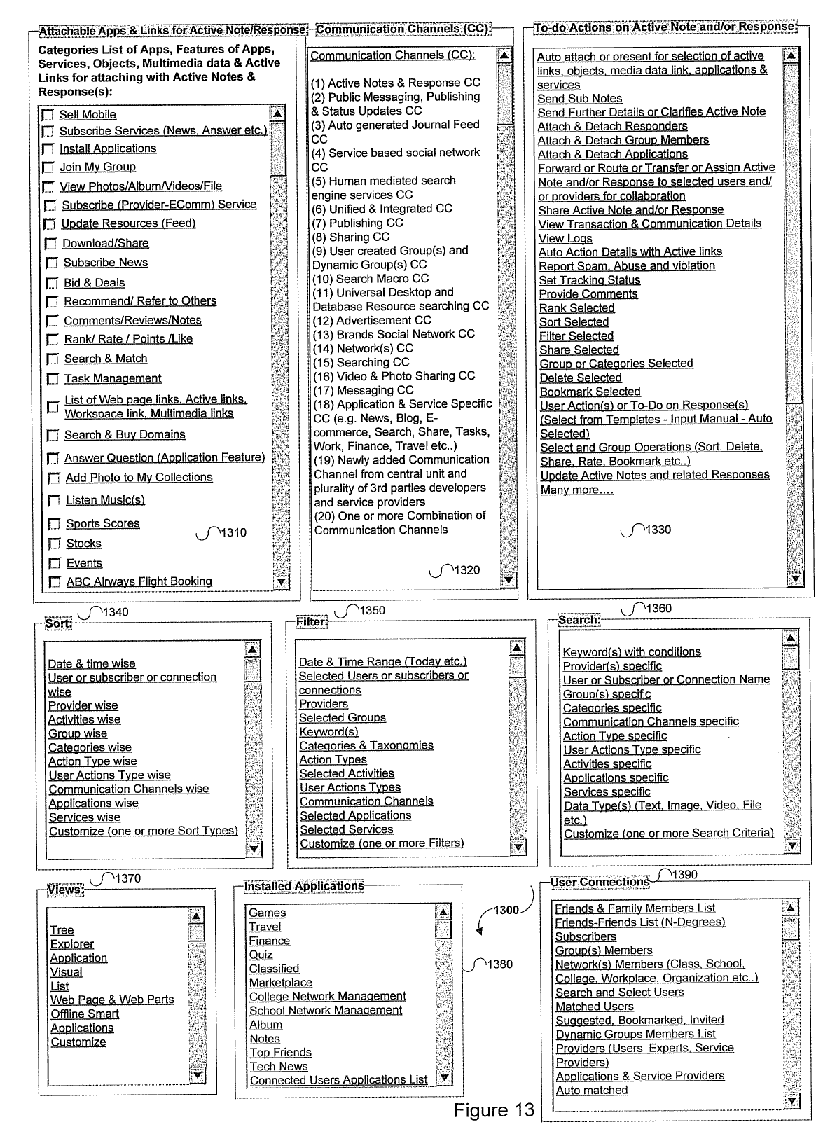

User can attach one or more active links, objects, applications, services & application features with Active Note(s) from FIG. 12 (190) & FIG. 13 (1310) for participating, communicating, collaborating, transacting with responders based on user selection or selection from system provided matched list of active links and active applications or services or application features or auto attaching one or more active links and/or active applications or services or application features based on Active Note(s) text analysis, past Active Notes, user profile & user data. A “trigger,” such as a special character or symbol, may be used while inputting text to indicate that the user desires to identify active links. Selectable active links are then provided to the user responsive to the trigger. These selectable links may also be called candidate active links because they comprise the active links which the user may wish to reference. In one embodiment, the provided active links are narrowed responsive to additional input from the user. Thus, a user may quickly and easily reference one or more active links while posting an active note to the social network. Selectable links enable the user to mention one or more active links in the social network when posting an active note as describe in US patent application No., titled: “A System and Method for generating and updating information of connections between and among nodes of social network”. List FIG. 12 (190) & FIG. 13 (1310) comprises plurality of attachable and accessible objects of network that host and link by central unit FIG. 10—530 or from external network & domain, developer of application, develop by user, service providers including one or more profiles of user and connected users, identity of user and resources, contents, publications, media data & items including image, photo, video, audio, message, communications, lists, attachments, applications, services, groups, networks, links or URLs, AI Agents, pages, search results, brands name or objects name, advertisements, logs, search macros, auto generated messages, relationships, one or more or list of user connections objects, subscribers, privacy settings, structured data like list of brands, domain specific categories survey forms for getting more details in structured way and any other objects.

For example FIG. 13 (1310) user can select & attach “Sell Mobile” active links & apps from list of active links & apps with message “I want to Sell Mobile” and send to matched or connected or subscriber or responder users of network, wherein said links enable said users to buy mobile by clicking and using said active links or applications and system tracks the user action on said Active Note(s) and related response.

Another example is that user send message “I want to buy mobile—Attachments” and send to matched or connected or subscriber or responder users of network and related one or more responders can attach one or more active links and apps with said response like responder send response “Purchase mobile from SuperMobile Store, near shop for you” and attach active links or applications or application features or services like Links: (1) Purchase from SuperMobile Store, (2) Mobile Presentation Video and send said response to said Active Note(s) provider, wherein said links enable said users to buy mobile by clicking and using said active links or applications and system automatically tracks user's actions on said response like “User Actions: (Auto: Tracking Status: Like & Viewed)” and related active links or apps or stores user defined action and comments like “Purchase from SuperMobile Store at Mulund”. Central unit FIG. 10—530 receives, stores, indexes and process said Active note(s), related responses & active links & applications and associate system generated or user defined one or more user actions on said Active note(s), related responses & active links & applications and making them searchable for other users based on ranking and one or more search criteria.

User can determine and select one or more responders based on auto match making, search, match, filter & select from categories list(s) of user connections including friends, friends of friends, family, co-workers, classmates, Search, invite & select users from central search engine and other sources or external domains, select from one or more categories list of subscribers, search, subscribe & select one or more verified providers or responders from categories lists, online available matched public providers, select based on one & two way match making preferences, select from bookmarks of responders or users, select from suggested responders or users or service providers, select responders based on dynamically created Group based on online available matched users, similar activities, location, applications, interest, categories, select service based responders based on service profile, select one or more user networks, groups, customize selection of responders including selection conditions, rules, search specific name, connections, networks, groups, interest, activities, location. User can select or update responders for all Active Note(s) (default) or for each Active Note(s). User can save or post one or more Active Note(s).

User can manage all Active Note(s), related Response(s) and communications from all responders, sources & communication channels (All Active Notes Tab) 50 including user's own all Active Note(s), related Response(s) & communication (My Active Notes Tab) where user can receive responses from and communicate with plurality of related responders and communication channels.

User can select or switch one or more or combination of communication channels 280 (more detail in FIG. 13—1320) and set default communication channel e.g. 280 shows default “Active Notes & Response” communication channel.

User can 60 select various types of Sort (more detail in FIG. 13—1340), Filter (more detail in FIG. 13—1350) & Search (more detail in FIG. 13—1360) options for Active Note(s), related Response(s) & communication data and select view type (more detail in FIG. 13—1370) for presenting and managing Active Note(s), related Response(s) & communication.

FIG. 13 illustrates an exemplary GUI 1340 for presenting to user various Sort 60 options or selections for sorting of Active Note(s), related Response(s) & communication data and source of responses including User or subscriber or connection wise, Date & time wise, Provider wise, Activities wise, Group wise, Categories wise, Action Type wise, User Actions Type wise, Communication Channels wise, Applications wise, Services wise, Customize Sorting and any combination thereof.

FIG. 13 illustrates an exemplary GUI 1350 for presenting to user various Filter 60 options or selections for filtering Active Note(s), related Response(s) & communication data including Date & Time Range, Selected one or more Users, subscribers, connections, Providers, Groups, Networks, Keyword(s), Categories & Taxonomies, Ranking & Rating, Active links & apps types, Activities, User Actions Types, Communication Channels, Applications, Services, Resource or media data types including image, video, audio, text, docs, file, status types and any combination thereof.

FIG. 13 illustrates an exemplary GUI 1360 for presenting to user various Search 60 options or selections for searching Active Note(s), related Response(s) & communication data including searching based on One or more Keyword(s) with conditions, Provider(s), Users, Subscribers, Connections Name, Group(s) specific, Categories specific, Communication Channels specific, Action Type specific User Actions Type specific, Activities specific, Applications specific, Services specific, Media Data Type(s) including Text, Image, Video, File and any combination thereof or customize one or more search criteria.

FIG. 13 illustrates an exemplary GUI 1370 for presenting to user various Views 60 options or selections for selecting presentation and management type for managing Active Note(s), related Response(s) & communication data including Tree-Branch style 70, Explorer style, Application style, Visual style, List style, Web Page & Web Parts, Offline Smart Applications and Customize.

FIG. 13 illustrates an exemplary GUI 1320 for User to select one or more communication channels 280 for presenting and managing all messages or communication data related to said selected one or more communication channels including:
(1) Active Notes & Response Communication Channel (280) as describe in this invention.
   Examples:
      (1) Example 1—Step 1: Active Note sends by sender User [Y]=“I want to buy mobile” FIGS. 12-80 with Attached Active Link(s): (1) Specification Attachments and associate metadata including source, categories, keywords, data & time. User interface presenting to user each Active Note send by user. For example Tree style user interface 70 presents each active note 80, 120, 300 & 130, accessible metadata and responses for each active note to user. User interface also provides various operations on selective Active Note(s) & Response(s) 290 Actions & To-Do, Tracking & Logging User Actions, updating user interface based on receiving, sending, updating, user actions, transactions, events, user activities, auto actions, actions by other users.
         Step 2: Matched target Receivers or Responder Users [A, B, C, D, L, P, Q and Central Server] receives said Active Note via central unit FIG. 10—530, in which User [Y] receives said Active Note 80 related responses from FIG. 12—80 (Responses—1 to 5) Users [B, A, L], Group Response from Users [User's Own Response, P, Q] and Auto Response from [Central Server]. For example FIG. 12—80 (Responses—2) User [B] provides response “Purchase mobile from Super Mobile Store, near shop for you” and attaching Active Application & Service Link(s): (1) Purchase from Super Mobile Store application & service and Active Media Content (2) Mobile Presentation Video with said response for said Active Note received from User[Y].
         Step 3: Active Note provider [Y] receives said all responses with attached one or more active links and applications from said responders for said Active Note 80. For example User [Y] can ask further details or clarify the offer or communicate with responder user [B] by using one or more unified communication applications. User [Y] clicks on Purchase from Super Mobile Store application & service link and system opens Purchase from Super Mobile Store application in an integrated environment or on web page, so user can easily view information, enter buying details, make payment and purchase said mobile. Active Note Receiver or Responder User [B] give rating to said Active Note & Active Note provider based on frequent purchaser, fast purchasing of product and other criteria and User [Y] can also provides rating and comments on Responder User [B] and on said transaction or response based on reasonable price, good communication & service, fast product delivery, relationships, frequent purchase and other criteria.
         Step 4: Central unit FIG. 10—530 or system (FIG. 1—110) monitors, records or logs or tracks, stores, indexes, filters & process user's said one or more actions, activities, To-Do, events, transactions, rating, comments & communications including who, what, where, when, how about action on said active Note and identify related objects links like User [B], ABC, User [Y], Purchase from Super Mobile Store indicating source(s) of action, Active Note source, Responder or Action doer, source of Action on Active links & application and auto generates and present said one or more user actions on each response of each Active Note. For example: system presents tracking status to receiver of active Note User [B]—Tracking Status: User [B] sell mobile ABC to User [Y] by using Purchase from Super Mobile Store and receives payment of Rs. 5500 (Date & Time) and system presents tracking status to provider of active Note User [Y]-Tracking Status: User [Y] buys mobile ABC from User 1131 by using Purchase from Super Mobile Store and make payment of Rs. 5500 (Date & Time)
         Step 5: Sender of Active Note [Y] as well as Responder User [B] can manually provides User Actions on each response of each Active Note. For example User [B] provides User Action manually or selecting from ready templates: “I buy mobile ABC” and User [Y] gives User Action: “I sell 20^{th} mobile ABC at the rate of Rs. 5500 within 1 hour”
         Step 6: Central unit FIG. 10—530 or system (FIG. 1—110) receives, stores, indexes and processes each Active Note & attached active links & applications, each Active Note related each response & attached active links & applications, each Active Note and/or Response related system and user defined Actions, Rating or Ranking and comments and making all said resources searchable for other users based on one or more search criteria.
         So purpose specific Active Note and associate active links & applications for clarifying, solving said Active Note related purpose i.e. [I want to Buy Mobile] created by Active Note Provider or sender of message, Matched target revivers or responders receives said Active Note, one or more revivers or responders among said target revivers or responders can provide response with attaching matched active links & application for solving said Active Note related purpose i.e. [I want to Buy Mobile]. Active Note Provider receives said response and said integrated active links or applications enables Active Note Provider to [Purchase Mobile] and transaction or purpose of Active Note is completed and solved.
         All steps are not compulsory and fewer steps can take place, concurrent one or more steps in any order can take place and any sequence and combinations are possible.
      (2) Example 2—Step 1: Active Note sends by sender User [Y]=“Plan to Travel to New York—Info, Hotel Booking, Shopping” FIG. 12—120 and associate accessible metadata including user profile, source (web site or mobile or external domain), categories & keywords (Travel, Booking, E-commerce), data & time.
         Step 2: Matched target Receivers or Responder Users [X, W, Z, P, Q] receives said Active Note via central unit FIG. 10—530, in which User [Y] receives said Active Note 120 related responses from FIG. 12—120 (Responses—1 to 4) Users [(1) X, (2) W, (3) Z] and User's Own Response (4). For example (1) User [X] response is “Please provide me details of your itinerary plan” and attaches Active Links: (1) Survey or Detail Forms (for price range, date & duration, likes) and (2) Active Links: List of Hotels for getting further details, communication, choice and clarifying various related things. User [Y] provide details in said survey forms and select some possible hotels from list and send said survey form(s) with selection to responder User [X]. Responder User [X] further transfer and assign said user active note with details to other matched responder users [W] and [Z] for receiving response for User [Y]. (2) Responder User [W] provides response “Best matched hotel in New York City” and attach Active Links Book Hotel XYZ and (3) Responder User [Z] provides response “Best hotel for you (Hotel New York City)” and attach Active Links: Book Hotel New York City. User [Y] gets said response from User [W] and User [Z] directly or via User [X] after verification, editing & updating said responses by User [X]. User can also provide own response with own said active note. User [Y] provides response “My Notes: “(1) List of shopping places in New York City” and Active Links: Shopping in New York City and “(2) List of Tourist places in New York City” and attach Active Links: Tourist Places in NYC.
         Step 3: User [Y] likes response of responder User [W] and clicks on Book Hotel XYZ application & service link and system opens Book Hotel XYZ application in an integrated environment or on web page, so user [Y] can easily view information, enter booking details, make payment and book hotel XYZ. Active Note Receiver or Responder User [W] give rating to said Active Note & Active Note provider [Y] based on frequent booking customer, speed booking and other criteria and User [Y] can also provides rating and comments on Responder User [W] and on said transaction or response based on reasonable room rates, good communication & service, fast booking, relationships, frequent bookings and other criteria.
         Step 4: Central unit FIG. 10—530 or system (FIG. 1—110) monitors, records or logs or tracks, stores, indexes, filters & process user's said one or more actions, activities, To-Do, events, transactions, rating, comments & communications including who, what, where, when, how about action on said active Note and identify related objects links like User [w], Book Hotel XYZ, User [Y], Hotel XYZ indicating source(s) of action, Active Note source, Responder or Action doer, source of Action on Active links & application and auto generates and present said one or more user actions on each response of each Active Note. For example: system presents tracking status to receiver of active Note User [W]—Tracking Status: User [W] booked hotel room for User [Y] by using Book Hotel XYZ and receives payment of Rs. 15000 (Date & Time) and system presents tracking status to provider of active Note User [Y]—Tracking Status: User [Y] book hotel room ABC from User [B] by using Book Hotel XYZ and make payment of Rs. 15000 (Date & Time)
         Step 5: Sender of Active Note [Y] as well as Responder User [W] can manually provides User Actions on each response of each Active Note. For example User [W] provides User Action manually or selecting from ready templates: “I book hotel for Use [Y] and give discount 5%” and User [Y] gives User Action: “I book hotel XYZ room”
         Step 6: Central unit FIG. 10—530 or system (FIG. 1—110) receives, stores, indexes and processes each Active Note & attached active links & applications, each Active Note related each response & attached active links & applications, each Active Note and/or Response related system and user defined Actions, Rating or Ranking and comments and making all said resources searchable for other users based on one or more search criteria.
         So purpose specific Active Note and associate active links & applications for clarifying, solving said Active Note related one or more purposes i.e. [Hotel Booking] created by Active Note Provider or sender of message, Matched target revivers or responders receives said Active Note, one or more revivers or responders among said target revivers or responders can provide response with attaching matched active links & application for solving said Active Note related purpose i.e. [I want to Buy Mobile]. Active Note Provider receives said response and said integrated active links or applications enables Active Note Provider to [Purchase Mobile] and transaction or purpose of Active Note is completed and solved.
         Step 7: User can also send one or more Sub-Active Notes related to parent active note. For example User sends 300 Sub Active Note (1): “I am looking for Pure Vegetarian Restaurant” for parent Active Note 120 and associate metadata including source, categories, keywords, data & time. User [Y] sends Sub-Active Note 300 to connected Responder Users [Hotel Ram and Q], in which User [Hotel Ram] send response “I know the Pure Vegetarian Restaurant in New York City” and attach Active Links: MAP & Direction and User [Y] likes and select said response and visit said restaurant and provide various user actions including manual User Actions or TO-Do (1): I visits and likes the restaurant (2): My Comments (3) My Rank. Further steps 4 to 6 take place for said Active Note and related Response & Response Provider.
         All steps are not compulsory and fewer steps can take place, concurrent one or more steps in any order can take place and any sequence and combinations are possible.
      (3) Example 3—Step 1: Active Note sends by sender User [A]=“I want to sell my mobile” with Attached Active Link(s): (1) Specification & Photo Attachments, (2) Sell Mobile and associate metadata including source, categories, keywords, data & time
         Step 2: Matched target Receiver or Responder User [B] receives said Active Note via central unit FIG. 10—530 and can buy mobile by clicking on Active Link Sell Mobile application & service. System opens Sell Mobile application in an integrated environment or on web page, so user can easily view information, enter buying details, make payment and purchase mobile.
         Step 3: Receiver or Responder User [B] can ask further details or clarify the offer or communicate with sender user [A] and make payment and buys the mobile by using Sell Mobile active link or application & service. Receiver or Responder User [B] give rating to said Active Note & Active Note provider and User [A] provides rating and comments on Receiver or Responder User [B] and said transaction or response.
         Step 4: Central unit FIG. 10—530 or system monitors, records or logs or tracks, stores, indexes, filters & process user's said one or more actions, activities, To-Do, events, transactions, rating, comments & communications including who, what, where, when, how about action on said active Note and identify related objects links like User [B], ABC, User [A], Sell Mobile indicating source(s) of action, Active Note source, Responder or Action doer, source of Action on Active links & application and auto generates and present said one or more user actions on each response of each Active Note. For example system presents tracking status to receiver of active Note User [B]—Tracking Status: User [B] buys mobile ABC from User [A] by using Sell Mobile and make payment of Rs. 5500 (Date & Time) and system presents tracking status to sender of Active Note User [A]—Tracking status: User [A] sells mobile ABC to User [B] by using Sell Mobile and receives payment of Rs. 5500 (Date & Time)
         Step 5: Sender as well as Receiver User can manually provides User Actions on each response of each Active Note. For example User [B] provides User Action manually or selecting from ready templates: “I buy mobile ABC” and User [A] gives User Action: “I sell 20^{th} mobile ABC at the rate of Rs. 5500 within 1 hour”
         Step 6: Central unit FIG. 10—530 or system receives, stores, indexes and processes each Active Note & attached active links & applications, each Active Note related each response & attached active links & applications, each Active Note and/or Response related system and user defined Actions, Rating or Ranking and comments and making all said resources searchable for other users based on one or more search criteria.
         So purpose specific Active Note and associate active links & applications for clarifying, solving said Active Note related purpose i.e. [Sell Mobile] created by Active Note Provider or sender of message, Matched target revivers or responders receives said Active Note, one or more revivers or responders among said target revivers or responders can [Buy Mobile] by using attached one or more active links and integrated applications i.e. [Sell Mobile] and transaction completed.
         All steps are not compulsory and fewer steps can take place, concurrent one or more steps in any order can take place and any sequence and combinations are possible.
      (4) Example 4—Active Note=“My plan is to get admission for ICWA” and auto matched Active Note Responder can provide response with attached Active Link Admission Forms
      (5) Example 5—Active Note=“Where to purchase cycle?” and selected Active Note Responders can provide response with attached Active Links: MAP & Directions, Purchase Cycle, Presentation & Information Resources
      (6) Example 6—Active Note=“Book tickets of movie “ABC” at Mulund” and auto matched Active Note Responder can provide response with attached Active Link: Book Tickets and links enable the Active Note Provider to book movie tickets
      (7) Example 7—Active Note=“I want to rent my house” & attach Active communication application: Instant Messaging (IM) and central server auto matches the customers, wherein link enables interested customers to communicate with said Active Note Provider for further details and clarification. Active Note Provider can refer or forward the said Active Note(s) to other matched or connected users.
      (8) Example 8—Active Note=“Provide me patent related news sources & subscriptions or updates or search results” and attach attachments: List of Keywords and auto matched Patent News related Active Note Responder can provide response with attached list of news subscription sources and Active Note Provider can subscribe said one or more sources and receive updated news from subscribed news sources.
      (9) Example 9—Active Note=“Currently I m in New York City” and plurality of matched responders provides multidimensional concepts and/or responses including shopping, e-commerce, map & direction of shops, exhibition, tourist places, bookings, cabs, tour guides, restaurants, events, discounts and Active Note Provider can select interested response and further communicate with related responders.
      (10) Example 10—Active Note=“My current school project require resources and images related to all tourist places of India” and plurality of matched responders provides multidimensional concepts and/or responses including collections of images and related resources.
      (11) Example 11—Active Note=“I want to discuss on today's cricket match” and attach Active link or application: Discussion Group and connected or matched users can discuss by using said active link or application Discussion Group on said topic i.e. “today's cricket match particular event”
      (12) Example 12—Active Note=“Can you participate with my this game” and attach game application: Game WWW and connected or matched like minded user can participate and play with said game by clicking on game application: Game WWW
      (13) Example 13—Active Note=“Join our School “XYZ” Network and Connected users or student of said school network can join the said network by clicking said active link.
      (14) Example 14—Active Note=“Today I m free pls give some work related to Wikipedia project” and matched responder provides Active links for utilizing said user and knowledge & resources of said user for creating Wikipedia topic specific details or wild pages.
      (15) Example 15—Active Note=“I like fashion shows” and matched fashion related service providers can receives the said Active Note and provides fashion related paid, free & sponsored services including Videos, experts, marketing of products, consulting, education & training and like.
      (16) Example 16—Active Note=“<List of Brands> provided by Active Note Provider [A]. For example user inputs or selects used and like brands: Brands [A], [B], [C], [D] and [E] and each time when user updates said brand lists, central unit FIG. 10—530 FIG. 10—530 send said list of brands and brand related data to matched customers, brand users, brand owner or sellers, connected users and like for providing resources or responses and/or concepts related to said brands to Active Note Provider [A].
      (17) Example 17—Active Note=“I m currently in Los Angeles” and user can creates group or system dynamically creates group based on location, event, activities, interest, date & time and one or more users can join the group and invite other connected or matched users to join the group with permission. Group members or group users can submit one or more active notes and/or provide responses and communicate, collaborate, and share with each other by using one or more applications, services, networks and devices.
      (18) Example 18—Active Note=“I m looking for any job in NYC” Active Links: (1) Model Profile, Commands: (1) Publish in Public, (2) Advertise Me and Conditions: (1) Instruction: Provide Multidimensional Concepts (2) Response Condition=“Please provide only NYC related jobs information” (Purpose is to collect all available Job in NYC for other job seekers) and all matched responders and users can receive said Active Notes and provide one or more concepts including types of job and sender of Active Note can select one or more interested types of job and receive responses including available job in said selected categories or type in NYC.
      (19) Example 19—User [A] initiate new communication related to “Give Donation to Wikipedia” and Attach Active Link: Donate, application enable other users to give donation and attach one or more connected users or invite other users and other users can accept invitation and join the communication. Other users can also send request to join the said communication and user can accept the request and allow other user to join the said communication. System presents said communication to each member of said communication and enables members of said communication to post one or more active notes and/or provide responses to said one or more active notes.
      (20) Example 20—User [Y] of register with current social network web site [Kootol.com] and other external [Kootol2.Com] integrating services of [Kootol.com] with them by using API, button, plug-ins of [Kootol.com], which enables users to send and receive Active Notes and/or responses from external domains, applications, devices, services, networks and web sites e.g. [Kootol2.Com].
      (21) Example 21—System monitors one or more user's activities & actions and stores user's activities in database e.g. “purchase particular brand(s)”, “refer particular brand(s) to other connected users”. System auto generates one or more active notes each time when user purchase one or more brands or activities occurs and user or system can attach one or more active links with said active notes, wherein said active links enables receiver of said active notes to purchase said brands & communicate with user and send said auto generated and user updated one or more active notes to determined one or more targeted or connected or matched users.
      (22) Example 22—Enterprise user [YYY] can creates one or more projects in multi users & members environment including creates one or more categories or taxonomy classifications in said project and assign rights to one or more users for managing each categories, wherein said assigned users of said each categories can send and receive one or more active notes and/or responses and search, select, register and upload active links related applications, objects, links, pages, services, media contents, take one or more actions on said one or more active notes and/or responses, manage all transactions and communications and like.
      (23) Example 23 (Prospective Customer Search Engine)—Step 1: E.g. Users [A], [B], [C] and [D] post active note regarding “book hotel in NYC” with Active Links: (1) E-commerce App, (2) IM, (3) Map & Directions, (4) Share with Me and associate active note related details & metadata. Central unit FIG. 10—530 receives, stores, indexes and processes said active notes and associate data including metadata, active links and list of target responders or receivers from plurality of users.
         Step-2: Central unit FIG. 10—530 identifies matched prospective customers and related active notes based on said active notes and associate data including categories, keywords, location, metadata, user profile, user data, type of active note like purchase, buy, booking, transact and human mediated identifying prospective customers based on said active notes and associate data.
         Step-3: E.g. Registered User [Hotel Ram] want to search in real time prospective customers related to them. User can submit search query to search prospective customers and each prospective customer associate active note or set one or more search queries and preferences to receive automatically prospective customers and each prospective customer associate active note in real time. E.g. User [Hotel Ram] submit search query “Hotel booking and NYC or New York City”
         Step-4: Central unit FIG. 10—530 search & match search results for said search query and present search results or list of one or more prospective customers and associate active notes, each said active note identify prospective customer associate with one or more active links, wherein said active link(s) enable searching user e.g. User [Hotel Ram] to provide response, communicate, collaborate, participate, make offer, provide deal, sale product or ecommerce, workflow, make transaction with buyer, negotiate, provide discount, share and provide media data & information with selective one or more prospective customers. E.g. Central unit FIG. 10—530 list active notes posted by Users [A], [B], [C] and [D] with associate active links, attached data & metadata based on “book hotel in NYC” keyword(s) in active notes posted by said users and order the list based on date & time and rank, wherein said each active note associate one or more active links enable the User [Hotel Ram] to provide response, communicate, collaborate, participate, make offer, provide deal, sale product or ecommerce, workflow, make transaction with buyer, negotiate, provide discount, share and provide media data & information to related prospective customer or sender of active note.
         Step-5: Central unit FIG. 10—530 notifies each sender of active note e.g. Users [A], [B], [C] and [D] about receiving of said active note by receivers or search & selected by searching user e.g. User [Hotel Ram] and allow sender of active note e.g. Users [A], [B], [C] and [D] to communicate, collaborate, participate, accept offer, receive deal, buy product or ecommerce, make transaction with seller, negotiate with seller, ask or receive discount, share and receive media data & information with selective one or more active note receiver or seller with receivers based on said active note associate active link(s). E.g. User [A] communicates with User [Hotel Ram] and book the hotel by using said active link associate applications & services.
      (24) Example 24 (Zero click Advertisement)—Step 1: Central unit FIG. 10—530 receives and stores one or more advertisement contents from advertisers. E.g. registered user and advertiser “Hotel Ram” post advertisement contents:
         Advertisement Details=Best Pure Vegetarian Restaurant in NYC
         Keyword(s)=“Pure Vegetarian Restaurant”
         Location(s)=NYC, New York City
         Categories=Restaurant, Foods
         Accessible Active Link(s)=MAP & Direction
         Accessible Responder List with registered & verified Active Link(s)=Hotel Ram (said link enable user to contact Hotel Ram for getting information, booking seat and communication with staff)
         Brand or Identity Name and/or accessible Page or URL=Hotel Ram
         Daily budget=$500 (Daily advertisement amount not exceed to said budget)
         Bid amount for Pay-Per-Keyword occurs in message, associate response(s) & communication for priorities of informing prospective customers=$1.0 per message of per user
         Pay-Per Click based on number of responders receives message, number of responders provide responses, user clicks on active link, advertisement, and take user actions)=$0.1 per click of per user
         Pay Per Transaction (when actual sales or transaction take place)=20% per successful transaction
      Step 2: E.g. User [Y] post active note or message=“I am looking for Pure Vegetarian Restaurant” and associate Categories=Restaurant, Foods and send to responders based on option auto matched responders by central unit FIG. 10—530;
      Step 3: Central unit FIG. 10—530 receives, stores & process said active note or message, wherein processing comprising comparing part of message or each keyword of message and message associate metadata, sender user data & profile, other responses data with each advertisement related keyword(s), targeting criteria and contents and charge advertiser if match making take place. E.g. User [Y] mentioned in said active note or message “Pure Vegetarian Restaurant” keyword with associate Categories=Restaurant, Foods and user current location or system knows from user data that user is now in New York City and system matches said active note content and user data with each advertisement content including said matched advertisement content of “Hotel Ram” which includes matched Keywords)=“Pure Vegetarian Restaurant”, Location(s)=NYC, New York City and Categories=Restaurant, Foods and based on said matching of keywords with advertisement content, system charging the advertiser for said advertisement as per pay per keyword(s) occurs in message advertising model;
      Step 4: Central unit FIG. 10—530 send and present said active note or message to matched responders based on various criteria as describe in specification e.g. Central unit FIG. 10—530 sends said active note or message to connected users of User[Y], matched users that visits or know about such type of restaurants and matched said advertisements related or associate responders or verified service providers for providing response e.g. matched said advertisement related responder User [Hotel Ram] receives said active note or message from prospective customer User [Y];
      Step 5: Central unit FIG. 10—530 calculates the number of target receivers and/or responders that received said message for charging said each advertisers based on matching at least part of message including keywords, metadata & attachments with each advertisement keyword(s), targeting criteria and contents;
      Step 6: Central unit FIG. 10—530 allowing each receiver to access message associate active link(s) or allowing each responder to send one or more response with or without active link(s) to sender or communicate with sender of message. E.g. said responder User [Hotel Ram] send response to target customer User [Y]=“I know the Pure Vegetarian Restaurant—Hotel Ram in NYC” and provide or attach with response one or more active links, e.g. Active Links: (1) MAP & Direction, (2) Hotel Ram;
      Step 7: Central unit FIG. 10—530 calculates the number of responses and communication of all responders of said message for enabling charging said each advertisers based on matching at least part of message including keywords, metadata & attachments and responses of message with each advertisement keyword(s), targeting criteria and contents;
      Step 8: Central unit FIG. 10—530 enables the sender of message to access said response and associate active link(s) e.g. User [Y] view the active links MAP & Direction for finding restaurant and access the active link Hotel Ram for advance book the seat in restaurant “Hotel Ram”; and
      Step 9: Central unit FIG. 10—530 tracks one or more actions by sender of message, receiver(s) or responder(s) of message and central unit on said message, related response(s) and active link(s) and based on that calculating number of actions, number of hits or clicks, amount of transactions, type of actions, interactions & transactions for charging said each advertisers based on matching at least part of message including keywords, metadata & attachments and responses of message with each advertisement keyword(s), targeting criteria and contents. E.g. e.g. User [Y] manually describes user actions i.e. (2): I visits and likes the restaurant, and provide comment (3) My Comments, and provide rank (4) My Rank and system also auto monitor, tracks, generates and records User Actions e.g. (1) User [Y] Book Seat via Hotel Ram based on user access of active link Hotel Ram and transaction for booking.
      All steps are not compulsory and fewer steps can take place, concurrent one or more steps in any order can take place and any sequence and combinations are possible.
(2) Public Messaging, Publishing & Status Updates Communication Channel, where user can subscriber & subscription of public message publication of any other users of network and search sources from public message content as describe in U.S. patent application Ser. No. 11/995,343, titled: “A method and system for communication, publishing, grouping, advertising, searching, sharing and dynamically providing a Journal Feed” and divisional U.S. patent application Ser. No. 12/973,370, titled: “A System and method for publishing, communication and real time searching”.
   Examples:
      (1) Publisher User [A] publishes message: “I like Movie “ABC”, my movie details, story and rating . . . ” and have 3 subscribers Users [X], [Y] & [Z] and all subscriber users receives all updated messages from said publisher user [A]
      (2) Publisher User [A] publishes message: This is my tour photos—Download Link(s): Collections of Photos and have 3 subscribers Users [P], [Q] & [R] and all subscriber users receives all updated messages including said from said publisher user [A] and download and view said photos by clicking on said attached link.
      (3) Status updated by User [A]: “Currently I am in New York city mall” and all subscribed user receives each updated status from said user.
(3) Auto generated Journal Feed Communication Channel in which system monitors, records, stores & filters user activities or actions and auto generates journal items or messages based on said activities and attaching one or more active links & apps and send to connected users of user, where active links or apps enables a user to participate in the same activity as another user as describe in U.S. patent application Ser. No. 11/995,343, titled: “Method and system for communication, publishing, grouping, advertising, searching, sharing and dynamically providing a Journal Feed” and divisional U.S. patent application Ser. No. 12/973,370, titled: “A System and method for publishing, communication and real time searching”.
   Examples:
      (1) Auto generated action messages of User Y: (1) “User Y install application WWW” where User Y is source of message or action doer, install application is type of user action or activity and WWW is an application that user install. Central unit monitors user's “install application activity or action” and each time generate message with said who-what-where-when-how of action and identified integrated objects or application links and present to connected or selected or matched users, wherein said links enables viewing user to participate same activity as of another user or source or subject user.
      (2) User Y join group ABC, wherein links enables viewing user to join said group.
   Central unit receives and stores each user of network, user profile(s), User selected and installed applications, communication channels & subscribed services for facilitating user's various activities and user connections including friends and friends of friends.
   Central unit or system monitors, records or logs or tracks, stores, ranks, indexes, filters & process user's filtered or selected or matched one or more actions, activities, To-Do, events, transactions including who, what, where, when, how, with whom about action and identify related and interacted one or more objects, profile(s), interactions, users, links, pages, media contents & data, applications, networks, groups, services identity in a network or from external domains like User [B], Brand ABC, User [A], Application—Game with accessible link indicating interaction source(s) or source(s) of action, message source (from), matched or selected or connected destination or viewing users, Action doer and auto generates and present said one or more generated messages to matched or selected or connected destination or viewing users.
(4) Service based social network Communication Channel where user provides one or more services to other users of social network including task, work, searching, sharing, marketing, advertising, communication services and user can subscribe one or more services of other users as describe in U.S. patent application Ser. No. 12/847,875, titled: “A System and method of Service Based Social Network and expert human mediated search engine”.
(5) Human mediated search engine services Communication Channel in which user send search query or question to one or more expert human agents based on auto matchmaking or user selection or determination and one or more expert human agents provided search result(s) or answer(s) to related searcher or asker. Central unit stores, indexes and process said search query and related responses and provides search engine to other users for searching contents as describe in U.S. patent application Ser. No. 12/847,875, titled: “A System and method of Service Based Social Network and expert human mediated search engine”, U.S. patent application Ser. No. 12/974,998, titled: “Div-12: A method and system for managing resources for providers” and U.S. patent application Ser. No. 12/975,016, titled: “Div-13: A method and system for requesting social services from group of users”.
(6) Unified & Integrated Communication Channel where user can create or initiate plurality of communications and attach & detach connected & selected users and communication applications including email, chat, IM and user can send request for joining one or more communications or invite other users for joining communication as describe in U.S. patent application Ser. No. 12/975,036, titled: “A method and system for integrated online communication and collaboration”.
(7) Publishing Communication Channel wherein user or system can dynamically publish and present user content and data as per subscriber users selection and preferences as describe in U.S. patent application Ser. No. 12/973,387, titled: “A method & system for publishing and subscribing in social network”.
(8) Sharing Communication Channel where user can share content from external domain to any communication channel and connected users of existing domain as describe in U.S. patent application Ser. No. 12/948,483, titled: “A method and system of sharing in a plurality of networks”.
(9) User created Group(s) and Dynamic Group(s) Communication Channel wherein user can create one or more public, private and shared groups for communication, collaboration, workflow, participating, searching & sharing and system dynamically creates one or more groups based on user activities, online availability, location, date & time and combination thereof for communication, collaboration, workflow, participating, searching & sharing as describe in U.S. patent application Ser. No. 11/995,343, titled: “Method and system for communication, publishing, grouping, advertising, searching, sharing and dynamically providing a Journal Feed” and divisional U.S. patent application Ser. No. 12/973,370, titled: “A System and method for publishing, communication and real time searching”.
(10) Search Macro Communication Channel in which system monitors, records, stores, indexes and process user's one or more keywords specific search process related sequences of actions & events and allow user to edit search process related one or more actions, events and providing said search macros to other users, connected users and subscribers as describe in U.S. patent application Ser. No. 12/847,853, titled: “A System and method for Creating, Searching and Using a Search Macro”
(11) Universal Desktop and Database Resource searching Communication Channel in which system send search query to matched user's desktop based on index data and users desktops act as distributed search server and matched or selected search results send to related searching user(s). Central unit also stores, indexes ranked and selected said searched contents and making them available to other users of network as describe in U.S. patent application Ser. No. 12/847,879, titled: “A System and Method for Universal Desktop & Database Resources Searching, Subscribing and Sharing” and U.S. patent application Ser. No. 12/853,108, title: “A system and method of peer to peer network”
(12) Advertisement Communication Channel in which advertisers and relevant and matched users of network can interact, communicate, transact with each other as describe in U.S. patent application Ser. No. 12/973,351, titled: “A method & system for Intelligent Targeting of Advertisements” and U.S. patent application Ser. No. 12/847,840, titled: “A system and method of targeting advertisements and providing advertisements management”
(13) Brands Social Network Communication Channel in which user selects or inputs brands and identification data based on relevant templates and system creates public, private and shared networks based on said brands and identification data for e-commerce, review, communication, collaboration, workflow, participation, searching & sharing as describe in U.S. patent application Ser. No. 12/954,564, titled: “A METHODS AND SYSTEMS FOR BRANDS SOCIAL NETWORKS (BSN) PLATFORM”.
   Other Communication Channels:
(14) Network(s) Communication Channel where users can join or create one or more networks for communication, collaboration, workflow, participation with other users' activities, searching & sharing within network(s).
(15) Searching Communication Channel in which user can initiate search process and system auto matching online related users including connected users for searching & sharing search result collaboratively,
(16) Video & Photo Sharing Communication Channel wherein user can share refers, view, upload one or more videos and provide ranking or rating and comments. System also monitories, records, filters and stores user's video related activities and actions including viewing particular video, uploading video, commenting, and rating a video and auto generating messages and attaching links of video and source user with said video related user's activities and sharing with other connected or filtered users of user, so other user can view said video or read comments & rating on video.
(17) Messaging Communication Channel in which user can post one or more messages including any media data like text, video, link or URL, video, photo to selected and connected users of network.
(18) Application & Service Specific Communication Channels including News, Blog, E-commerce, Search, Share, Tasks, Work, Finance, Travel and like.
(19) New and existing known & available Communication Channel from central unit and 3^{rd} parties' developers, service providers and users.
(20) One or more Combination of Communication Channels

User can select or switch and use one or more or combination of Communication Channels for providing responses to related Active note(s) provider(s).

System can also provides application framework to user, so user can search, share and install one or more applications from central unit FIG. 10—530 & one or more developers and service providers and share application data with one or more connected users based on privacy settings as describe in U.S. patent application Ser. No. 12/847,861, titled: “A System and Method for accessing applications for social networking and communication in plurality of networks”

System can dynamically and selectively apply privacy setting for one or more user profiles, user data or content, communication channels, applications and services as describe in U.S. patent application Ser. No. 12/948/495, titled: “A systems and methods for dynamically generating a survey result(s)”, U.S. patent application Ser. No. 12/975,046, titled: “A method and system for sharing user and connected users” data with external domains, applications & services and users' and “A System and Method for publishing, sharing and accessing selective contents in a Social Network”

System maintains in a database a plurality of nodes of a social graph, plurality of connections in the social graph, where each connection represents a connection between two or more nodes in the social graph and maintaining in database information about one or more of the nodes and connections. Each node of social graph is identified by unique namespace. System dynamically updates connection information between nodes based on user's activities, actions, interactions, events and transactions with other nodes including connected and matched users, objects, applications, services, media data & contents, identities, pages, links and other objects from network. User can search, select, access and share one or more links of nodes with other nodes on network, wherein link or namespace enables other users to access and invoke link associate one or more resources, applications, services, media data, objects, profile, page, communication channels and like as describe in US patent application No., titled: “A System and Method for generating and updating information of connections between and among nodes of social network”

FIG. 12 illustrates an exemplary user selected 60 tree style user interface or view i.e. GUI 70 for presenting all Active Note(s), related Response(s) and communications data related to user selected Active Notes communication channel 280 in tree-branch format 70. Active Notes are represented in a tree-branch configuration such that new responses added to each Active Note(s) are associated directly to the existing Active Note(s) to which they respond. Branches can be opened or collapsed automatically or at the users' option, allowing the user focus his attention on selected Active Note(s) & related Responses and communication. The user can close any branch of the conversation by clicking an icon with a ‘minus sign’, which collapses that comment and any detail that falls below it. After the user clicked the minus sign, the minus sign icon it changed to ‘plus sign’ and a line appeared, indicating a collapsed comment or branch in the conversation. Clicking that plus sign icon expands the conversation view back to the state shown in FIG. 12 (70). Expanding and collapsing branches of the conversation tree can be done in an automated fashion as well. User can expand all and collapse all branches of tree.

User can also act as responder and provide response for Active Note(s). User receives all Active Note(s) from connected users under (Active Notes from Connected Users Tab), from one or more categories lists or groups of users under (Active Notes from Lists of Groups of Users Tab), from subscribers under (Active Notes from Subscribers Tab), from Public based on one or two way matchmaking user preferences under (Active Notes from Public Tab), user receives Active Note(s) transfer or assigned from other users or responders or service providers for providing one or more responses to related Active Notes Providers by using Response Provider Management 180.

User can select one or more Active Note(s) and related one or more Responses or Messages and apply or do one or more actions 290 (more detail in FIG. 13—1330), allow sender and receiver of active note (message) to take one or more actions on each active note (message), related responses and active links wherein said actions comprising attach or detach receivers or responders, active links, group members and forward, transfer, assign, search, match, share, filter, sort, order, group, categories, bookmark, add, update, delete one or more active notes, related each responses and active links, view logs, actions, transactions, events, activities & communications details, report spam, abuse & violation, set tracking status, provide comments & ranks, communicate with sender or receiver of messages, accessing of active links related each action details and provide user defined or auto recorded action details.

FIG. 121 illustrates an exemplary tree style GUI 70 for presenting to user Active Notes & Responses communication channel related Active Note(s) 80 & 120 or messages & communication data with metadata, categories, attached active links, applications, application features, services, multimedia data, date & time of sending Active Note(s), list of one or more responders & associate metadata, source of Active Note(s) or messages or communication including sending from mobile, sending from external domain, web site, application, services, network, device, sending from particular communication channel(s) like Active Note(s) communication channel, journal feed communication channel. User can take actions or To-Do 290 on each selected Active Note(s) or messages or communication. Each parent Node displays an Active Note(s) 80 & 120 or message or communication and related each child or branch node displays response(s) (70-1 to 5). Each Sub-branch node displays each response related further communication by using various applications and communication channels including text, instant messaging, chat, email, new types of communication channels and like. FIG. 12 (70-1 to 5) shows various responses from plurality of sources or responders related to Active Note(s) or messages & communication 80. Each response may comprise response from one or more responder(s) including auto responses 110 from central unit FIG. 10—530 and group responses 100 from group of categories users in text, video, image or any types of media data and attached with metadata, categories, concept name or type, keywords, date & time of responding, further communication related details & logs, source(s) of response(s) including mobile, from external domain, web site, application, service & network, attached one or more active link(s) or apps or services by responder(s) for participating, communication, collaborating, transacting and other user actions or operations with one or more responders, service providers, groups, networks applications and users, displaying the list of one or more user provided or auto generated actions on each response including tracking status like pending, read and user ratings, user comments, purchase brand by user that suggested by responder, viewed or read or played media data by user that send by responder(s), booked ticket or hotel room by user with the help of attached active link(s) or active application(s) that provided or facilitated by responder or service provider, installed application by user based on received auto generated message from connected users related to one or more activities, join particular group by user and manual user actions provided by user including shopping by me, not like particular brand, attend exhibition, viewed movie, eat food at restaurant provided by responder, visits museum, purchase book from particular events provided by particular connected user and like and any other user provided or auto logged or recorded user actions based on Active Note(s) or message or communication related response and response attached one or more active link(s) or apps or services.

FIG. 12 illustrates an exemplary GUI 180 for Response Provider Management where user or responder or service provider can prepare, manage and send one or more responses to one or more related Active Note(s) providers. Responder user or service provider can search & select already exist active links, applications, services and/or upload one or more domain or field or subject or professional or expertise specific applications or services for providing domain or field or professional specific Active Note(s) related response to Active Note(s) provider. Responder user or service provider can attach one or more active links or apps or apps features or services with response for said received one or more messages, wherein said attached active links or applications or services enabled response receiver or Active Note(s) provider(s) to communicate, collaborate, share, search, workflow, take one or more actions, transact and participating activities of responder(s).

Active note(s) Provider & Responder can attach one or more active applications & links with Active Note(s) & Response(s) FIG. 12—190 & FIG. 13—1310. Active note(s) Provider & Responder can search select and add to list one or more related active applications & links from central master list and upload one or more active applications & links. Active note(s) Provider & Responder can create one or more categories list. For example Active note(s) Provider & Responder can create separate list for Active note(s) and providing response. List auto generated or user created may based on Active note(s) Provider & Responder's expertise fields, education & qualification, profession, service, interest, activities, connection, preferences, age, gender, income range, location, language, purpose, requirement, group(s), network(s) including school, collage, work & like, random selection, Active Note(s) content or text, type(s), categories, metadata, Active Note(s) Provider profile & data, past responses & experience.

Active note(s) Provider attach one or more active applications & links with Active Note(s) from list FIG. 12—190 & FIG. 13—1310, wherein said one or more active applications & links enables response providers to provide response, participating same activities as of Active Note(s) provider, communication, collaboration, group discussion, e-commerce, transactions, provide support services, answering, marketing, advertising, referring, selling, sharing, publishing any Active note(s) purpose specific or related one or more active applications & links. For example Active Note(s) Provider attach “Sell Mobile” link which enables receiver user to buy mobile, attach Install Application(s) link which enables receiver user to select & install applications that installed by or suggested by sender, attaching Join My Group link which enables receiver user to join same group as of sender user, attaching Answer My Question link which enables receiver user to answer the question of sender. Thus ready to use one or more active applications & links enables responder to provide any types of response or participate or take actions on one or more active applications & links related to Active Note.

Likewise responder or receiver of Active note(s) Provider can attach one or more active applications & links with Active Note(s) from list FIG. 12—190 & FIG. 13—1310, wherein said one or more active applications & links enables Active note(s) Provider to buy something, transact, ecommerce, participate same activities as of responder or receiver of Active note(s) Provider, communicate, collaborate, discuss, consume services, view answer, advertising 7 attachments, share and any Active note(s) purpose specific or related one or more active applications & links. For example responder or receiver of Active note(s) Provider can attach “Book Hotel XYZ” link which enables Active note(s) Provider to book hotel, attach Listen & Download Music(s) link which enables Active note(s) Provider to listen or download preferred music based on Active note(s) Provider's Active note(s), requirement, purpose, solution, activities, actions, events, interest, workflow, task, entertainment, health issue, complaints, how-what-where-when-which related things, search, news, blogs, publication, answer for question, discussion on particular topics, direction & map, purchase & transaction requirement, information, application, service, user actions on response, user attached active links & apps, auto & manual or human mediated analyzing & interpreting Active Note(s) text data and metadata.

Active note(s) Provider & Responder can draft and/or attach one or more resources 200 with Active Note(s) or message or communication and Responses including Text, Links, Photos, Videos, Docs, Search Results, Structured Resources, Form(s) based resources, Draft resources by using full features Editor, Response Templates & Concept Templates and associate one or more metadata.

Active Note(s) Provider(s) & Responder(s) can use one or more communication applications 210 for providing one or more responses and communication with message(s) sender(s) or Active Note(s) provider(s) and other Responders, wherein communication applications comprising Instant Messaging (IM), Chat, E-mail, VOIP, shared Workspace, Applications, Groups, Networks and other customize Applications & services. User can also search and add or install one or more communication applications.

Responder can use one or more communication channels 280 for providing one or more responses to message(s) sender(s) or Active Note(s) provider(s).

Active Note Provider User can take one or more actions or To-Do 290 on one or more selected Active Note(s) and/or Responses including Attach one or more active applications & links from list of active applications & links based on user selection or auto selection, Send one or more Sub Notes, Send Further Details or Clarifies Active Note(s), further communication with responder(s), Attach & Detach Responders, Attach & Detach Group Members, Attach & Detach Applications, Forward or Route Active Note and/or Response to selected users and/or providers for collaborative responses, Share Active Note and/or Response, View Transaction Details or Logs or communication details on Active Note(s), related responses and active links & applications, view Auto Action Details monitored, record, store, filter & logged automatically by central unit FIG. 10—530 based on user actions on Active Note(s), related responses & active applications & links, Report Spam, Abuse and violation to central unit FIG. 10—530 for blocking & removing responders, Set Tracking Status or View auto Tracking Status by user, Provide one or more Comments on response(s), Provide Rank or Ratings to response(s) and Sort, Filters, Group, Categories, Delete and Bookmark one or more selected Active Note(s) and/or responses & communications, User Action(s) or To-Do on Response(s) can selected from Templates, Input by user manually and auto generated or selected or inputted by system or central unit FIG. 10—530, select Active Note(s) and/or responses and take one or more group actions or operations on them including sort, delete, share, rate, bookmark and Update & edit Active Notes and/or Responses.

Likewise responder user(s) can take one or more actions or To-Do 290 on one or more selected Active Note(s) and/or Responses including Attach one or more active applications & links from list of active applications & links based on user selection or auto selection, Send one or more responses, Send request for further details or clarification of Active Note(s), further communication with Active Note(s) Provider(s), Attach & Detach Group Members for providing response(s), Attach & Detach Applications, Forward or Route or assign or transfer Active Note(s) and/or Response(s) to selected or connected users and/or service providers and/or responders for providing collaborative responses, Share Active Note(s) and/or Response(s) with other connected, subscribed, responder users, View Transaction Details or Logs or communication details on Active Note(s), related responses and active links & applications, view Auto Action Details monitored, record, store, filter & logged automatically by central unit FIG. 10—530 based on responder actions on Active Note(s), related responses & active applications & links, Report Spam, Abuse and violation to central unit FIG. 10—530 for blocking & removing Active Note(s) Provider(s), Set Tracking Status or View auto Tracking Status by responder user, Provide one or more comments on Active Note(s), Provide Rank or Ratings to Active Note(s) and Sort, Filters, Group, Categories, Delete and Bookmark one or more selected Active Note(s) and/or responses & communications, Responder Action(s) or To-Do on Active Note(s) & Response(s) can selected from Templates, Input by user manually and auto generated or selected or inputted by system or central unit FIG. 10—530, select Active Note(s) and/or responses and take one or more group actions or operations on them including sort, delete, block, unsubscribe, share, rate, bookmark and Update & edit one or more responses.

Response Provider Management also provides various integrated search options 220 to responders for providing one or more responses to Active Note(s) provider(s) message(s) sender(s) including Search Past Responses/Concepts, Search and Subscribe keyword(s), categories specific resources including matched Active Note(s) & related responses from central unit FIG. 10—530, Search from one or more Providers, Search from Connected Users, Search from Other Sources including deep databases, internet, service providers and search engines like Google, Search User(s) & Connected Users Profiles & user Data including selective Life stream resources and search and add various customized search applications for preparing and providing response(s).

User can save each response 240 and/or send 260 each response to related one or more Active note Provider users. Responder or Active Note receiver user can manage all saved or pending to send and already send responses related to plurality of active notes by using Response Explorer 250. Response Explorer categories each Active Note Provider specific Active Notes and related response(s), so responder can search, sort, view, share, transfer, send, filter, bookmark, order, schedule for sending to active Note Provider(s), edit or update, delete one or more Active Note related responses, attach one or more active links & apps (FIG. 11—190 & FIG. 12—1210) and take one or more actions (FIG. 11—290 & FIG. 12—1230) on response(s) and set rank or rating, provide comments on Active Note(s) & Active Note Provider(s).

User can manage connections, subscribers and subscriptions (FIG. 12—160 & FIG. 13—1390) via searching known connection from network, importing contacts from external sources and search connected users from network, selecting or adding connections from suggested users, searching like minded or matched users from central search engine including search and/or subscribe responders 140 and active note providers 150. User connections comprising (FIG. 13—1390) one or more or categories list of Friends & Family Members, Friends of Friends (N-Degrees of separation), Subscribers, Group(s) Members, Network(s) Members including connections from Class, School, Collage, Workplace, Organization, Club networks, added connections by searching and selecting users from central search engine, Matched Users based on one or two way match making preferences, selected users from Suggested list of users, Dynamically created Groups Members, Responders or Providers including Users, domain or subject or brand specific Experts & Service Providers and Applications & Service Providers, Bookmarked users, list of Invited users and Auto matched users based on user preferences, user profile & data, location, interest, transaction, rank.

User can search, select, install one or more applications and subscribe services from central unit FIG. 10—530 and 3^{rd} parties' application developer and service providers via central unit FIG. 10—530 comprising collaborative games, travel, finance, Question & Answer, Quiz, Classified, Marketplace, College Network Management, School Network Management, Album, Notes, Top Friends, Tech News and user can also publish or share list of applications to connected users for sharing, communication, collaboration, participation, searching, supporting, providing response to other users and social network related applications. Connected users of each user can see user installed said one or more applications and install or participate with one or more applications of one or more connected users. User can selectively share profile(s), user data and application(s) data with other users based on one or more privacy settings. User can also invite other users for participate with user's activities via one or more applications. For example a user install game related application and invites other connected or matched users for playing game, installs collaborative search application and invite other connected or matched users for searching search query collaboratively from one or more sources, install one or more communication channels and allow other user's to subscribe or allow connected user's to participate with said one or more communication channels for communication, collaboration, searching, participating, sharing and providing user services and user generated contents.

FIG. 14 illustrates a process for zero click advertisement in accordance with one embodiment of the invention. In this embodiment, the process for zero click advertisement is used for a social networking website 100. In a first step, receiving plurality of advertisement requests 700 at Ad server 540 coupled to the web server 530 of the social networking web site 100, each advertisement request comprising an advertisement, advertisement content, targeting criteria and one or more responders on behalf of advertisers and storing said advertisement request data at advertisement requests data store 545 to receive one or more active notes (messages) from target customers of the network based on matching at least part of each active note (message) posted by each user including keywords, metadata & attachments with each advertisement keyword(s), advertisement, targeting criteria and contents. Sender 150 can send or post 710 an active note (message) with or without active link(s) or auto send by central unit (web server 530) to one or more determined 705 target receivers and/or responders 350 by sender 150 and/or to auto determined by central unit (web server 530). Web server 530 receives said active note (message) and process 720 said active note (message), wherein said process of active note (message) comprising matching 730 at least part of active note (message) including keywords, metadata & attachments with each advertisement keyword(s), targeting criteria and contents at Ad server 540 for enabled to further determine responders 740 including send or present active note (message) to each matched advertisement associate responder(s) and charging 740 each matched advertisement or advertiser based on pay per advertisement related keyword(s) matched in each active note (message) of each sender user and receive said matched & relevant active note (message) from target customers. Process 740 of Ad server 540 provides active note (message) with further determined responders 750 to web server 530. Web server 530 send or present 760 said active note (message) to determined one or more target receivers and/or responders 350 including one or more responders associate with said matched advertisement content, determined by user and auto matched by central unit and web server 530 calculates the number of target receivers and/or responders that received said active note (message) for enabled to charging said each matched advertisements. Web server 530 allows each receiver 350 to access said active note (message) associate active link(s) or allow to each responder 350 to prepare 780 and send 790 one or more response with or without active link(s) to sender user device 150. Web server 530 calculates the number of responses and communication of all responders of said message for enabled to charging said each matched advertisements and send 810 response with or without active links from each responders to sender user device 150 and enable sender 150 of active note (message) to access 820 response and associate active link(s) and receiving 830, monitoring, tracking & storing each actions 840 taken by sender 150 of active note (message), receiver(s) or responder(s) 350 of active note (message) and central unit (web server 530) on said active note (message), related response(s) and active link(s) and based on that calculating 840 number of actions, number of hits or clicks, amount of transactions, type of actions, interactions & transactions for enabled to charging said each matched advertisements.

Advertiser can post advertisements with advertisement contents which are stores at Advertisement request data store 545 comprising one or more target criteria, keywords, brand name(s), identities, product and service name, location, language, details, description text, media data including URL or links, video, image, documents, associate registered active links, list of responders, daily budget of advertisement, bid amount for particular keyword(s).

Advertisement associate one or more active links enables user(s) to buy & sell products, make payment or transaction, communicate, collaborate, view presentation or media data, search, share, participate, workflow, refer to other users, e-commerce, make order, book tickets, view said advertisement, make deal, bidding for products and services, join group, install application, receives discount vouchers, fill survey forms, subscribe newsletters, bookmark product(s) or service(s), negotiate with advertiser, managing buying and selling process or activities.

In one embodiment, enable to charging to advertisement of advertiser further based on list of responders mentioned in advertisement content receives number of messages, wherein message or part of message matched with said advertisement content.

In an embodiment, allow responder to present one or more active links mentioned in said advertisement based on matching part of message or keywords and metadata & attachments of message with each advertisement keyword(s), targeting criteria and contents and allow to attach said one or more active links with response for said message.

In an embodiment, wherein enable to charging to advertisement of advertiser further based on active links mentioned in advertisement content clicked by responder or response receiver.

In an another embodiment, wherein enable to charging to advertisement of advertiser further based on number of times message, related response(s), associate active links share and forward to other users of network by sender(s) and/or responder(s) including connected & matched users, subscribers, other responders.

FIG. 15 illustrates a process for dynamic e-commerce in which an offer does not become valid until associate dynamic rules & conditions attained in accordance with one embodiment of the invention. In this embodiment, the process for dynamic e-commerce is used for a social networking website 100. In a first step, web server 530 enables dynamic e-commerce server 550 of the social networking website 100 to access 700 user profiles, user data, user connections with other users and privacy settings that store in user profile store 570 and user data store 580. Dynamic e-commerce server 550 allow seller or sender of active note(s) 150 to post active note(s) 720 about offering of goods & services with one or more dynamic rules & conditions and active links. Dynamic e-commerce server 550 receives & store said posted active notes in dynamic e-commerce data store and process said active note. Web server 530 coupled with dynamic e-commerce server 550 display 750 said active note(s) with one or more dynamic rules & conditions and active links over a network and send 750 said active notes to user determined 710 or auto matched users 740 of network for a predetermined period of time for potential buyers 350 to review. Dynamic e-commerce server 550 allow said target receivers or potential buyers 350 to receive said active note and/or allow users 350 to search, browses, select, bookmark, forward said active note(s) about offering of goods & services and allow users 350 to accept one or more offering of goods & services 760. Some users 350 accept 760 the offering of goods & services by said active note(s) and send acceptance of offering of goods & services 770 to Dynamic e-commerce server 550. Dynamic e-commerce server 550 receives said acceptance 750 of offering of goods & services by buyer users over the network for the predetermined period of time and determines if the dynamic rules & conditions has been attained 780. Dynamic e-commerce server 550 dynamically display updated rules & conditions associate status to buyer users 350 and send 800 acceptance of offering of goods & services by buyer 350 to seller 150 and dynamically display updated rules & conditions associate status and allow seller 150 to further dynamically update the rules & conditions 810 and informing each buyer or consumer that accepted the offer of goods & services whether or not the rules & conditions has been attained 820.

Dynamic rules & conditions based on determined number of purchase or determined amount of purchase or determined duration within which purchase made or determined number of times purchases by buyer or group of buyers, total sale in particular duration, date & time range, location, income range, education & qualification, age range, gender, number of buying requests, number of points earned by user or group of users, one or more customize & user defined preferences, rules and conditions and any combination thereof at which time the discount offer price becomes valid.

Dynamic rules & conditions comprising user's actions & activities, transactions, current location, and events at which time the discount offer price becomes valid. User's action & activities comprising participating with brand social network by user, win sports & contests, play game and achieve scores by user, pass in exam & get particular percentage of marks or scores, join group by user, install application, subscribe service, fill survey form(s), provide rank & comments, refer, sell, resell, communicate, forward active note(s) to one or more connected users by user. User's transactions comprising number of transactions, amount of transactions in particular duration, transaction by referred, connected users and any combination thereof. User's events comprising user's birthday, anniversary, festival, holiday, seasons, any event days, trigger of any events defined by buyer and seller, trigger of events by system including current like minded or matched online users or prospective customers.

In an embodiment, Determining a geographic location of the identified devices; and applying rules & conditions based on current location of one or more or group of users including private or public events like concert, tradeshows, business meetings, sporting event, weddings, rallies, tourist place, work place & class room and number of users at particular location, where the geographic location is provided by an access device or based on the location of an access device.

In an embodiment, sending, receiving & processing active note (message) and associate response of active note (message) in a network comprising steps of:
determine one or more target receivers and/or responders by sender and/or auto determined by central unit;
sending active note (message) with or without dynamically attaching one or more identified active links by sender and/or auto attaching by central unit to one or more determined target receivers and/or responders, wherein said active links enables receiver and/or responder to communicate & collaborate with sender, provide response(s) & service(s) to sender, enabling workflow, e-commerce transaction, participate with sender's one or more activities and access active links;
receiving and processing said active note (message) at the central unit;
presenting said active note (message) to one or more target receivers and/or responders based on one or more preferences;
allow each said responders to send one or more responses for said active note (message) to sender of active note (message) with or without attaching one or more active links and/or auto attaching active links by central unit, wherein said active links enables receiver of response(s) to communicate & collaborate with responder, send active note (message), receive services, enabling workflow, participate with responder(s), make purchase transaction, e-commerce, view, share & search multimedia data & contents, solve any active note (message) specific solution and access active links;
allow user to take one or more actions on said active note (message) and/or related responses and/or associate active links;
identifying, monitoring, storing, recording, logging said one or more user actions based on one or more filters & privacy settings with action date & time, action categories, user provided or auto recorded action related details, action related data, responses & communications, one or more action source(s) including people, applications, services, shared workspace, media data or contents, objects, groups, networks, pages, items, links and any action related identified objects from network and/or external domains, attachments, lists, tracking status, further communication details, ratings or ranks, comments and user provided and/or dynamically associated one more active links, services, objects, media data, shared workspaces and applications; and
receiving, storing, indexing, ranking, processing said message, message related responses and actions & action associate logged data for making them searchable for other users and/or send to subscribers or connected users of user based on sender & receiver user's privacy settings & preferences, wherein action associate said active links enable said one or more receiver users to participate with sender user.

In an embodiment, processing an active note(s) and associate concept(s) comprising steps of:
receiving and processing the active note (message) from the active note provider(s) or sender;
determining one or more target responders or receivers;
presenting or sending a representation of the active note (message) to one or more target responder(s) or receiver(s);
receiving and processing one or more multidimensional concept(s) and/or response(s) from one or more target responders or receivers; and
presenting or sending the multidimensional concept(s) and/or response(s) to the active note provider(s) or sender as per preferences.
selecting one or more concept(s);
send one or more concept with active note to related responder(s) and
receiving one or more response(s) from one or more responder(s) based on selected each concept(s) and related active note(s).

In an embodiment, managing active links comprising steps of:
registering each user and storing each user's profile, connections and privacy settings;
registering and storing one or more active links and profile & metadata of active links by user, application & service providers and central unit;
maintaining in a database a plurality of said active links;
maintaining in a database each user related active links;
allow user to associate or attach one or more active links with message from said active links;
send message to determined one or more targeted receivers;
allow targeted receivers to access said active links or provide response and attaching one or more active link(s) with said response based on at least part of message;
allow user to take one or more actions on said message associate one or more active links and track one or more user actions on said message associate one or more active links; and
storing each message associate one or more active links with said tracked user actions on said message associate one or more active links.

In an embodiment, managing nodes and connections among nodes in a network comprising steps of:
maintaining in a database a plurality of nodes of a social graph;
maintaining in a database a plurality of connections in the social graph, where each connection represents a connection between two or more nodes in the social graph;
maintaining in a database information about one or more of the nodes and connections;
providing an interface for users of the social network to send content items in one or more communication channels of the social network to determined one or more target receivers and/or responders;
receiving via the interface a said content item from a user of the social network, the said content item including a link referencing a node of the social graph; and
sending or presenting said content items in one or more communication channels of the social network to determined one or more target receivers and/or responders;
allow receivers and/or responders to send content items to sender of content items in response to received said content items including a link referencing a node of the social graph, wherein said referred links based on at least part of received content items;
tracking user actions on said link referencing a node of the social graph; and
receiving, storing, indexing, ranking, mapping, processing said content items, associate one or more links referencing a node(s) of the social graph and related one or more tracked user actions.

In an embodiment, generating an active note, the method comprising steps of:
allow user to filter pre-defined & pre-categories activities, actions, events, and transactions types;
monitoring a plurality of activities, actions, events, transactions of each user, said each user configurable to act as sender user and a receiver or responder user;
storing a plurality of said activities, actions, events, transactions in a data repository unit;
determine one or more target receivers and/or responders by user and/or auto determined by central unit;
generating a plurality of active notes or messages regarding one or more of the activities, actions, events, transactions of each user with or without associating one or more active links with said active note(s) or message(s), wherein said active links enable receiver or responder users to communicate & collaborate with sender, access active links, provide response(s) & service(s) to sender, enabling workflow, e-commerce transaction and participate in at least one of the activities as performed by the sender;
filtering plurality of active notes for one or more determined receiver or responder users; and
presenting one or more active notes or messages to said determined target receivers or responders.

In an embodiment, communication in a network(s) environment comprising steps of:
allowing each user to subscribe to each other user for receiving each active note (message) of sender or publisher;
receiving and storing one or more user profiles, preferences, active note (message) subscribers, active note (message) subscriptions, dynamic relationships & connections, selections and privacy settings for sending and receiving active notes (messages) and communication at a central unit;
determining one or more target subscribers by a sender;
allowing the sender to send each active note (message) to the one or more target subscribers via a central unit;
receiving each active note (message) with or without associated with one or more active links from the sender or publisher at the central unit, wherein said active links enables subscribers to access active links, communicate, provide response(s) & service(s), workflow, e-commerce transaction, participate with sender's one or more activities;
storing, indexing and processing said each active note (message) with or without auto attaching one or more active links at the central unit wherein said active links enables subscribers to communicate, provide response(s) & service(s), workflow, e-commerce transaction, participate with sender's one or more activities;
determining one or more target subscribers by the central unit based on one or more preferences and subscriptions;
sending a representation of the each active note (message) to the one or more target subscribers by the central unit;
presenting each active note (message) in chronological order based on the preferences and privacy settings, subscriptions of target subscriber by the central unit; and
receiving, storing, indexing, ranking and processing said each public active note (message), related responses, active links & user actions for making the searchable for users and allow to search & subscribe source of active note (message) publication based on at least part of message content and one or more predetermined criteria.

In an embodiment, communicating in a social network about active notes and/or activities or actions from an external domain comprising steps of:
maintaining a profile for a plurality of users of the social network, each profile comprising profile data, privacy settings and connections to each of a plurality of other users of the social network;
determine one or more target receivers and/or responders by user and/or auto determined by central unit;
receiving a plurality of user posted active notes with or without attaching one or more active links by user and/or auto attaching by central unit from the external domain, each active notes representing user posted active note or an action taken by a user of the social network in the external domain, wherein said active links enables receiver and/or responder to access active links, communicate, provide response(s) & service(s), workflow, e-commerce transaction, participate with sender's one or more activities;
& processing said active notes and/or logging or recording the actions at the social network, each logged action including information about the action; and
generating one or more messages wherein each of said messages represents one or more of said recorded actions; and
presenting said active note(s) and/or generated messages to each determined target receivers and/or responders.

In an embodiment, dynamically creating groups for active note(s), related responses, communication in a network environment, the method comprising steps of:
receiving and storing users profiles, real time location information of users, preferences, connections, selections, privacy settings at the central unit;
determining one or more users for dynamically created or user created & updated one or more groups based on active note(s), related responses, active links & user actions and associate categories, keywords & metadata, match making of users preferences, real time location information based on wireless devices and wired devices, date & time, online availability of users, bookmarked active note providers or responders, one or more accepted invitations, permissions for joining the group, conditions, searching & matching, selected connections, subscriptions & selections of users, privacy settings, user profiles & data, interest & activity types, filters and any combinations thereof and/or based on one or more users auto match by the central unit;
allowing members of said one or more groups to post active notes, provide & receive responses, attach and access active links, establish communication, create social network(s), provide service(s), collaborate, bookmark, rank, search and share multimedia contents.

In one embodiment, present invention provides a system and method of processing an active note(s) from an active note provider(s) and related response from responder(s) comprising steps of:
receiving and processing the active note(s) from the active note provider(s);
determining one or more target responders;
presenting or sending a representation of the active note(s) to one or more target responder(s);
receiving and processing a response from one or more target responders; and
presenting or sending the response to the active note provider(s) as per preferences.

In one embodiment, displaying active notes, related responses, active links and user actions in a social network, the method comprising steps of:
receiving by a social network a plurality of active notes, related responses, active links and user actions from users of the social network;
providing a user interface to a user of the social network;
displaying in the user interface some of the active notes, related responses, active links and user actions received from users in the social network;
providing to the user one or more selectable filters, each filter specifying a criteria to be applied to the active notes, related responses, active links and user actions;
receiving a selection of a filter from the user; and
updating or presenting said active notes, related responses, active links and user actions based on the said received selected filter and presenting said one or more updated active notes, related responses, active links and user actions.

In one embodiment, managing unified communications and collaboration for one or more active notes, the method comprising steps of:
receiving from one or more users of a social network a request to initiate a new communication for one or more active notes;
initiating a plurality of new communications responsive to the requests,
for each of a plurality of the communications, receiving requests from one or more users of the social network to join the communications;
attaching users to the communications responsive to the requests to join;
receiving active notes, related responses, active links, user actions & communication data from a plurality of the users in connection with one or more of the active notes related communications,
for each communication, presenting to each member of said communication the plurality of active notes, related responses, active links, user actions & communication data received for the communication in a tree style or format based on one or more preferences and privacy settings.

Present invention can solve users all requirements in one source in an integrated, collaborative and unified ways by using plurality of responders, active links, applications, services, objects, advertisements and media data or contents.

In one embodiment, central unit maintains for each of plurality of users of network(s), a user account(s) including verified and/or anonymous or general, one or more public, private & shared profile(s) including one or more active note providers and responders' profiles & service profiles, preferences & privacy settings and set of connections with other users of the network(s), wherein allowing users or active note(s) provider(s) and responders to creating and updating connections list(s) based on contacts, invitations, finding people from internal or external networks, searching & matching, subscribers, book marks and match making preferences.

In one embodiment, Life stream Management facilitates active note provider and life stream administrator to manage and update life stream timeline related note(s) & related resources with metadata including multimedia contents, text, messages, emails, communications, web links, videos, images, photos, albums, graphics, audio, voice, files, scanned documents, databases and related applications & services, connections, updated resources from connected users or internal or external sources & services, user's or connected users' generated contents like publications, blogs, news, events, updates, notes, experiences, reviews, discussion, likes & dislikes, activities, solutions, sharing, purchases, brands use and want to use, history and everything related to user's and connected users' activities or life, wherein said metadata comprising date & time, one or more taxonomies, ontology, categories, semantic syntax, keyword(s), comments, source, author.

In one embodiment, User can associate one or more taxonomies to said life stream for organizing life stream comprising allowing user or active note(s) provider(s) to download or synchronize or update one or more default top level or parent system taxonomies from the central unit and allow user to append or update one or more user created taxonomies of one or more levels to said default top levels or main system taxonomies.

In one embodiment, allowing user to share or publish or subscribe or synchronize one or more selected and updated life stream or selected one or more active note(s) and related multidimensional active resources & actions of life stream to or with one or more selected or connected or matched users or subscribers based on one or more conditions, privacy settings and preferences.

Active note can comprising one or more statement(s) or sentence(s), templates, selected or edited concepts, note taking methods including tree structure, charting, outlining, mapping, mind maps, timelines, unstructured notes, structured notes with customize fields or tags, details, visual notes, flow charts, cluster notes, reports, summary, story, blog, descriptions, database, message(s), paper form, multimedia content types including text, image(s), photos, symbols, diagram, presentation, video(s), extracts or part of video &, voice, map, scanned documents, calendar, script, query, keyword(s) in one or more languages, phrase(s), Boolean operators, rules, condition(s), semantic syntax, ontology with associated one or more accessible metadata or fields.

In one embodiment, active note provider can identify or select or extract one or more active note(s) from existing note(s) of life stream and/or based on received one or more concepts or searching or subscribing & selecting of active note(s) from active note(s) of other users or drafting or preparing new active note(s) or sub active note(s) with one or more accessible metadata or fields.

Central unit can auto generating, storing or recording one or more note(s) or active note(s) attached with one or more accessible metadata or fields based on monitoring, tracking, sensing, auto detecting, auto identifying, storing and managing of one or more related or filtered activities, actions, events and transactions of active note provider(s) or related & connected users as per preferences and privacy settings.

one or more said accessible metadata or fields associate with active note(s) comprising one or more determined responders & preferences, date & time, title, priority types including high, normal, low, expiration date & time, keywords, categories, types, taxonomies, ontologies, source & categories of activities, actions, events, transaction, source of note, location(s), language type, size, source id, source profile(s), privacy settings & preferences, dynamically attached one or more active links, informational links, attachments, multimedia contents, applications and service including communication utilities and shared workspace for providing response or multidimensional active resources & actions, collaboration, participation, tracking, answering, communication, workflow, services & task fulfillment, searching, sharing, social networking, purchasing, transactions, information.

System can auto update said auto generate note(s) to the user's life stream timeline or auto synchronizing and presenting identified active note(s) to related or connected or matched or subscribed responders as per preferences and privacy settings.

Active note(s) provider or responder(s) comprises of one or more digital automated sources including mobile, computer, video camera(s), scanner, digital pen & pad, RFID, touch screen, speech & text recognition system, communication systems, note taking software, imports from other systems, applications, services, devices and networks, multimedia content sources including image, video, file, extracts from video or voice, editor, wizard, search engine, survey, historical data, logs, sensor systems, multi Artificial Intelligence Agent(s), languages & translation system, speech or voice source(s) & paper forms, users of social network(s), human mind, experts, user's related groups, connections, subscribers, 3^{rd} parties and like minded users and one or more individuals, groups, collaboration of one or more pre-identified individuals comprising company, organization, professional and social bodies, web site, governmental bodies and enterprises, service providers, data and application providers and 3^{rd} parties providers on behalf of animals, birds, non living things including tree, products, road, building, location, tourist place.

Active note(s) may related to any types of activities, concepts, purpose, updated status, thought, motive, logic, act, idea, what user currently doing or want to do or already did something, aim, goal, desire, want, wish, requirement, request, query, help, object, matter, plan, target, task, issue, subject, topic, project, case, event, problem, attempt, try, what next possibly user can do, what happen next, likes & dislikes, hobby, selection or choice, around anything related to user's or entity's environment like brands & services using, brands & services want to use, before spent money, experiences, reviews, interest, relation, connected people, all types of works, activities, actions, jobs, procedures, to do, about user, user's life, health, education, travel, entertainment, life style, finance, job, business, career, learning, training, food, habit, hobby, location and like.

In one embodiment, central unit can dynamically creates one or more groups of active note(s) providers and/or responders for collaboration and communication based on one or more active notes and/or concepts and/or responses and related metadata, keywords, categories, location, availability, date & time, language, invitation, relations or connections, subscriptions, searching & matching, preferences and profile data of active note(s) providers and responders.

Central unit can receives and processes said one or more active note(s) and/or selected concepts from one or more active note(s) providers, wherein said processing comprising storing, updating, indexing, validating & formatting including editing, clarifying, update details, fonts settings, spell checking, language & spam detecting, translating, transcribing, converting to other formats like voice, text, associating priority types including high, normal, low, expiration, date & time, categories, keywords, locations, advertisements, payment information, profile data, URL, dynamically attaching one or more system data, active links, informational links, attachments, multimedia contents, applications and service including communication utilities and shared workspace for providing response or multidimensional active resources & actions, collaboration, participation, tracking, answering, communication, workflow, services & task fulfillment, searching, sharing, social networking, purchasing, transactions, information and determining one or more responders for sending or routing or publishing said active note(s) to one or more determined responders.

Central unit can comprising server or processor or device linked to internet, intranet, peer to peer network including super nodes or hubs, LAN, WAN, mobile service provider(s), cluster of centralized or distributed servers, database(s) and one or more types of networks.

In one embodiment, determining of one or more target responders by central unit and/or active note provider(s) based on one or more preferences, privacy settings, active note related dynamic selections, auto match option, selected concepts, connections, subscriptions, filters, rules or conditions, profiles, ranks, points, historical data, behavior, interests of active note provider, availability, ranks, preferences & privacy settings, service(s) profile(s) or personal profile(s) data, provided concepts and determined active note(s) providers of responders, active note(s) associated one or more categories, keywords, location & metadata and auto matching or searching by central unit based on one or more predetermined preferences or criteria of active note providers(s) and/or responder(s), determined relevancy criteria and number of determined responders.

In one embodiment, central unit can registering one or more responders for providing one or more concepts and/or response(s) or multidimensional active resources & actions services to one or more active note providers for one or more types of active note(s) with service profile, wherein said service profile comprising service details, categories, keywords, location, language, expertise, subject or domains, availability or date & timings, payment information, conditions or rules, privacy settings, preferences, one or more associated connections and subscription lists.

In one embodiment, determining receiving one or more related active note(s) from one or more active note(s) provider(s) by responder(s) based on one or more subscriptions, services, connections, selections, preferences, privacy settings, profile(s) data, relations, collaboration with other responders or service providers, assignments by other connected users or service providers, filters, rules or conditions, locations, languages, timings or availability, payment information, ranks, points, historical data, behavior, interests, searching and/or subscribing active note(s) provider(s) based on one or more search criteria, relevancy and auto matching criteria.

One or more target responders receiving and processing said one or more active note(s) and/or selected concepts from one or more active note(s) providers from one or more networks, wherein said processing comprising storing, indexing, formatting including editing & updating, clarifying, assign ranks, comments, status & tracking status, identifying & searching resources utilized for providing response(s) or multidimensional active resources & actions, determining, sending & clarifying one or more concepts, preparing one or more concepts specific one or more responses or multidimensional active resources & actions and associate one or more accessible metadata or fields with active note(s).

In one embodiment, identifying & searching resources utilized for producing or providing response from local, central unit, service providers and connected users based on keyword(s) contained in the active note(s) and related metadata, active note provider data including profile, historical data, life stream data; and presenting, sharing, synchronizing, updating and displaying the said identified resource to said responder(s) for preparing or providing response(s).

In one embodiment, determining, sending & clarifying one or more concepts based on an analysis of the active note(s) by responder(s) comprising determining the one or more concept(s) based on analysis of the active note(s), life stream environment analysis and clarifying active note(s) with active note(s) provider(s) based on one or more communication, active note(s) provider's one or more categories or part(s) of life stream, past active note(s) & related ranked used multidimensional active resources & actions, active note provider's one or more profile(s), preferences, rank, points & levels, purchase transactions & e-commerce history, current location, connected users information and sending or clarifying one or more determined concepts or multidimensional views to related active note(s) provider(s) for providing one or more response(s).

The system & method can allow active note(s) provider(s) or responders to search one or more active note(s) and/or concept specific one or more active resources & actions based on one or more concepts, search criteria, keyword(s), categories, taxonomies, ontology, semantic syntax, conditions, rules from local and/or online central server and/or external sources & services integrated by API and/or connected social or personal networks or from any selected connections.

Responder(s) can preparing or drafting response(s) or multidimensional active resources & actions based on one or more concepts, experience, analysis, one or more sources including search local & central database, online search engines & resources, social networks, 3rd parties databases, books, resources from connected users, collaboration of responders and service providers, by using one or more applications, services & devices from one or more networks.

Response(s) or multidimensional active resources & actions comprises any types of resources and one or more multimedia contents including text, messages, emails, communications, web links, connections, videos, images, photos, albums, graphics, audio, voice, files, scanned documents, databases, applications, services, updated resources from internal or external sources, user generated contents or services from connected or subscribed or matched users including search results, articles, publications, blogs, news, events, experiences, reviews, discussion, actions, sharing, suggested brands, providing one or more concept(s) specific suggested resources & action(s) including one or more actions, what to do, better way to do, more ways, questions & related answers, answers, suggestions, solutions, guidance, helps, finance, supplies, information, knowledge, tips & tricks, training, learning, match making, ideas, what, where, when, why and how like information, one or more actions, suggestions, solution, direction, guidance, execution plan, step by step procedures, to do, tips & tricks, more particularly, but not exclusively to using a community to provides personalized or customized multi model or multidimensional active resources & actions for active note(s), result-oriented actions, positive steps, active resources designed to actively promote and advance the user's status, any measures taken to rectify conditions, acts or deeds used to remedy a situation, solution for removing an error, or adjust a condition, how to carry out a task, how to execute the things, planned series of actions, tasks or steps designed to achieve an objective or goal, guide the implementation or improvements of any types of process including task assignments, milestones, timelines, resource allocations, data collection methodology, and evaluation, step or series of steps to be taken, detailed description of the steps used to implement a strategic plan, a plan to determine what information is missing or pending, where and when to collect this information, and who will need the information and anything related to active note(s) which are useful to active note(s) provider(s) and associate one or more accessible metadata or fields.

Associated or attached accessible metadata or fields comprising one or more applications, services, shared workspace(s), active links or URL for communication, collaboration, answering participation, tracking, workflow, associate date & time, matched advertisements, invitation request, resource types, resource structured tag types, location, language, resource sources, categories, taxonomies, controlled vocabulary, keyword(s), ontology, ranks, status.

Sending and response(s) session between or among active note(s) provider(s) and responder(s) comprises one or more determining of responders, drafting or auto generating or identifying, sending and processing active note(s) or sub active note(s), identifying, sending, receiving, selecting, editing or modifying, processing & clarifying concepts, preparing, processing & sending response(s), communications, collaboration, clarification, answers, routing, assigning, workflow, calls, emails, messages, videos, online meetings, searching & matching, sharing, e-commerce, aggregating, tracking, follow-up, actions, events, transactions, activities, participation, attaching active links & resources including applications, services, multimedia contents or resources links with response, applying privacy settings and preferences, selecting, filtering, subscribing, mapping, downloading, accessing, invoking, programming, book marking, attaching, detaching, assigning, federating, integrating, distributing, ranking, commenting, composing, comparing, co-coordinating, orchestrating, choreographing, organizing, recording, configuring or customizing, classifying & grouping, connecting, disconnecting, editing, updating, synchronizing, transacting, binding with 3rd party applications, networks, services & devices via web services & API, forwarding, transferring, merging, joining, listing, linking, arranging, scheduling, automating, sequencing and ordering, sending, receiving, managing, monitoring, registering, accounting & metering, reporting, logging and executing between or among one or more or group or combinations or series or sequences of active note(s) and/or active note(s) provider(s) and/or response(s) and/or responder(s).

The central unit can receiving and processing said one or more concepts and/or response(s) from each of at least a portion of the target responders, wherein said processing comprising receiving, storing, updating, indexing, validating & formatting including editing, clarifying, update details, fonts settings, spell checking, language & spam detecting, translating, transcribing, converting to other formats like voice, text, associating priority types including high, normal, low, expiration, date & time, categories, keywords, locations, advertisements, payment information, profile data, URL, dynamically attaching one or more system data, suggested response(s), active links, informational links, attachments, multimedia contents, applications and service including communication utilities and shared workspace for providing response or multidimensional active resources & actions, collaboration, participation, tracking, answering, communication, workflow, services & task fulfillment, searching, sharing, social networking, purchasing, transactions, information and determining one or more responders for sending or routing or publishing said active note(s) to one or more determined responders and determining one or more receivers or active note(s) provider(s) for sending or routing or publishing or presenting said concepts and/or resource(s) to one or more determined receivers or active note(s) provider(s) based on one or more preferences and privacy settings or searchers based on one or more search criteria.

The system & method can allow active note providers to assign rank, sort, organize, categories, bookmark, filter, select, save, share, edit or update, store, use, process one or more received concepts and/or responses, set active note session status and tracking status including active, pending, completed, executed or used or like, concepts or response received, set active note as public or private or shared types, associate metadata including keywords, categories, provide comments on one or more selected or executed or liked or used responses and submit said one or more selected active note(s) and/or related one or more concepts and/or responses to central unit for storing, editing or updating, indexing, validating, formatting, associating data, processing for making them searchable to other users based on one or more search criteria.

The system & method can allow responders to assign rank, sort & order, organize, categories, bookmark, filter, select, save, share, edit or update, store, process one or more received active note(s), set response session status and tracking status including active, pending, completed, assigned or forwarded, concepts or response sent, set concepts or response as public or private or shared types, associate metadata including keywords, categories, provide comments on one or more selected active note(s) and submit said one or more selected active note(s) and/or related one or more concepts and/or responses to central unit for storing, editing or updating, indexing, validating, formatting, associating data, processing for making them searchable to other users based on one or more search criteria.

Presenting or attaching an advertisement to a user or active note(s) provider(s) with or within active note(s) and/or related concepts and/or response during the sending, receiving, selecting and presenting.

Allowing a responder or an active resources & actions provider(s) to accept an active note(s) to designates the advertisement.

Advertisers may bid for position and placement and timing of ads associated with keywords on the responder's or active resources & actions provider's GUI and the responder(s) active resources & actions provider(s) can optionally pick which advertisement is presented.

The object of invention is to allow sender User to dynamically associate one or more identified active links which are controlled by user and exist in social network with message and sent to determined target users, wherein said active link(s) with message enables receiving user to sell, purchase, transact, participate with same activities as sender user, communicate, collaborate, workflow with sender user, provide response in an integrated, dynamic and unified manner. Central unit stores each active links associate user actions and data for enabling users to share said data with other apps, services and users.

Conventionally, a user can search, register web sites, subscribe services, install applications, share contents, and make payments by using plurality of sources for wide different varieties of user's requirements. Typically these sources are disparate and disorganized. In other words, the user must spend time researching, searching, registering, accessing, and identifying different sources that are not present in consolidated, coherent, unified and integrated manner. Often many of the sources are not relevant to user. What is needed is unified and integrated wide variety of communication system by providing and accessing message associate active links for solving user's on demand wide varieties of requirements.

In one embodiment, a user interface that enables users to post content items in one or more communication channels of the social network also includes an interface that allows the posting user to identify one or more nodes or active links within the posted content item. For example, a trigger received in the interface may indicate that a user wishes to reference a node in the posted content item from list. Selectable links may be provided to enable the user to author a content item comprising a link to another node or active link in the social network. After sharing the content item comprising the link to another node in the social network, another user can access node or active link.

In one embodiment, a social network enables a user to identify, reference, or otherwise mention another node while posting a content item to the social network. “Nodes” on a social graph in a social network may represent objects on the social network, such as actual users and other entities within the social network that have profile information. These types of entities may post content to communication channels within the social network. For example, a user and the user's friends in the social network are included in this category of nodes. These nodes have “identities” because they represent actual users and entities with profile information. Entities such as products or brands, celebrities, and teams, may also have identities because an actual entity is identified and claimed in the social network. Other types of nodes, such as applications, services, actions, transactions, digital content, events, groups, network and objects, may also have “identities” because those nodes may be controlled by a specific user or entity. In one embodiment, present invention provides managed, organized, secure, interactive, real time, trusted, unified and controlled new next generation super internet network, contextual search engine, multi communication channels, dynamic e-commerce, zero click unobtrusive advertisement and human or social operating system which monitors, tracks, records each activities, actions, transactions, events of each participating users and facilitates each related activities, actions, transactions, events of each user by providing on demand, customize, contextual, dynamic & unified communication. Present invention can also able to predict future based on each entity related each recorded, updated and stored activity, actions, transactions, events and related ranked responses, active links and actions. User can search ranked actions, active links and response for active note(s) from past active note(s), related response, active links & actions.

Tools are needed for creating unified and integrated environment in an abbreviated and user-friendly manner. A user may wish to reference other people, objects, and/or entities that exist on the social network and external of the social network when posting content. Conventional social network lack a content upload and delivery mechanism that enables users to easily refer to active links or objects and other users when posting content for the other users, where active link enables other user to access, view, transact, participate, communicate, collaborate.

E.g. User post question “<Question>” and attach Answer My Question application or active link with question and receiving user does not have to search, install application and register with service for providing answer. Receiving User can access question associate integrated application or active link for providing answer.

E.g. user post “I want to buy mobile” and plurality of responders provide response message with active links and user communicate with plurality of said responders and select one best that user like and make purchase transaction with selected responder. So user does not have to search plurality of mobile seller, register with different sites for communicate with different sellers and maintain profiles. So present system facilitates users to communicate, transact, workflow, access information & applications from plurality of sources in unified & integrated manner.

E.g. User post message with photo and attach active links (application features) view my photo, share my photo, which enables receiving user(s) to view photo, share photo with other connected users, wherein photo active link indicates user related accessible objects based on namespace and view my photo, share my photo active links indicates application features or components or objects that user can associate with message and enable receiving user to view & share photos. User doesn't have to install whole application, only part of features which sender user allow receiver user to access active links and associate operations on active link(s) of message.

Another object of invention is to monitor, track, store, index & rank each user actions on said each message associate each active link and making them searchable for other users which enable users to get relevant results.

E.g. Many users action is [Users] buys from merchant [ABC] for mobile [XYZ] indicates more relevant for search query “mobile” and rank prior to other search results.

Another object of invention is to provide zero click advertisement based on posted messages.

Another object of invention is to provide prospective customers search engine based on posted messages.

### Another Object of Invention is to Provide Dynamic E-Commerce Platform

No prior art provides on demand, customize, contextual, dynamic, unified and integrated environment for communication, collaboration, transaction, participation, sharing, providing response based on user defined message and associate active links indicating user's need, requirement, transaction, activities, workflow, task and like. User does not have to install plurality of applications, subscribe services, register with different applications, web sites and services, and maintain different profiles for different web sites & apps, searching content and media data from plurality of different sources. By using present invention user can access plurality of applications, services, objects from network base on message associate active links without departing from present network and user can share user data, application data, and profile with plurality of apps, services and users based on privacy settings.

Also no prior art provide zero click advertisement method wherein each user's each message content matched with each advertisement content including keywords and ad targeting criteria and send message to advertiser or responder, wherein said message identifies target customers and charging advertiser based on receiving said message from identified target customers.

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Furthermore, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. Additionally, although the foregoing embodiments have been described in the context of a social network website, it will apparent to one of ordinary skill in the art that the invention may be used with any social network service, even if it is not provided through a website. Any system that provides social networking functionality can be used in accordance with the present invention even if it relies, for example, on e-mail, instant messaging or any other form of peer-to-peer communications, or any other technique for communicating between users. Systems used to provide social networking functionality include a distributed computing system, client-side code modules or plug-ins, client-server architecture, a peer-to peer communication system or other systems. The invention is thus not limited to any particular type of communication system, network, protocol, format or application.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

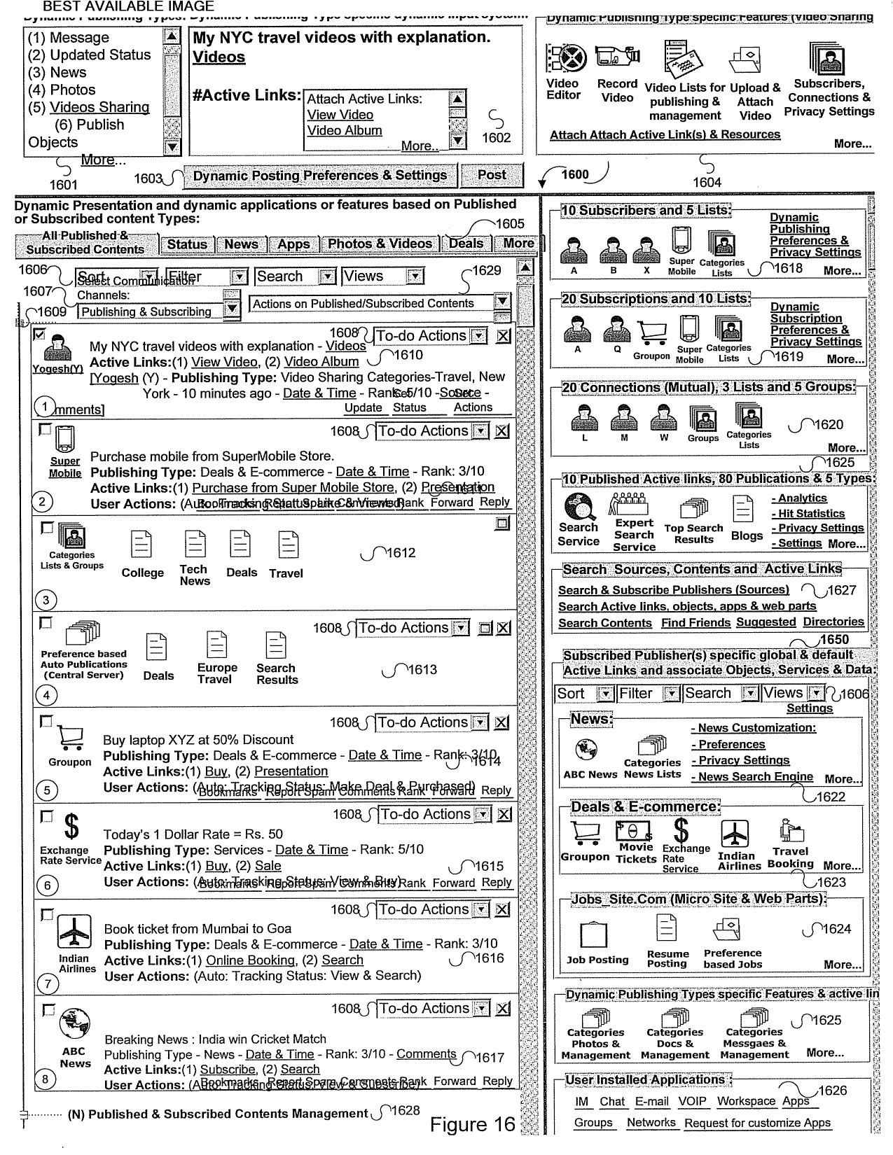

FIG. 16 illustrates an exemplary GUI 1600 for dynamically managing all types of dynamic publications, sharing, one or more subscribers of one or more publications, subscriptions of publications of publishers from connected, likeminded and matched sources, categories lists & groups of subscribers, subscriptions & connections, search and dynamically attached active links and associate objects with user profile from plurality of subscribed publishers for providing enhanced functionality including applications, services, web features, widgets, objects, multimedia data, web parts, portlets, micro sites, plug-n-play, groups, networks and like. User can act as Publisher(s) and/or Subscriber(s). Publisher User can publish plurality types of publications & contents by selecting dynamic publishing types 1601. Based on said dynamic publishing type 1601 selection, system dynamically presents dynamic publishing type specific applications, services, publication type specific features, objects, multimedia data, associate connections, subscribers, subscriptions, groups, networks, lists, privacy settings, preferences, customization settings, hit statistics & analytics, metadata management including categories, keywords, author, date & time, descriptions, payment information, help, source and like and other management functionalities 1604 for facilitating Publisher User to manage, edit, draft, attach active links (1310) with publication or posting publication specific contents. Based on said dynamic publishing type 1601 selection, system dynamically presents dynamic input system 1602 for drafting, preparing, editing, updating, testing, reviewing one or more types of publications including text, video, images, photos, documents, files, objects, applications, URLs, Web pages and any types of multimedia data. After drafting one or more publications, Publishing User can dynamically post, publish, advertise, send, update, synchronize and present said one or more publications to one or more users including connected users, subscribers, one or two way match making preferences based target users, all users of network (public), selected users, rules and conditions based target users with associated one or more privacy settings and metadata 1603.

User can manage subscribers, categories list of subscribers and each or all subscribers or publications & contents specific dynamic publishing preferences & privacy settings 1618. In one embodiment any user of network can subscribe to any other user of network for receiving any types of one or more public publications. 1618 displays all subscribers of publishing user with statistics including number of subscribers, lists, number of message send to each subscriber, number of views and like. User can click on each subscriber icon for accessing selected subscriber's profile(s), public user data, public publications, public subscribers & subscriptions, view profile, communicate & share, make transactions with permission and like. User including publishing user and subscribing user includes any entities including person, organization, company, college, experts, automated digital sources, web site, applications, services, networks, device, groups, sensors, database and like. User can manage one or more subscriptions of one or more publishers and each publishers and associate publications specific preferences and privacy settings 1619. User can search and subscribe plurality of publishers or sources of publications or contents by plurality of ways based on selections, send request or invite others for creating connections, user connections & contacts, searching people from network, find friends from contacts, search sources from message(s) associate source(s), search subscribers & subscriptions of each public user, one or two way match making preferences, rules & conditions, categories, taxonomy wise directories & lists, auto match making of publishers based on preferences, profile & user data and based on user activities, actions, events & transactions 1621. User can also search & subscribe 1621 published public active links associate objects from plurality of publishers or sources based on one or more criteria and install one or more said active links associate applications, services, objects, multimedia data, web parts, and widgets from plurality of publishers or sources. User can subscribe to any other users and other user can subscribe to user in one way or two ways (mutual). User can manage connections including friends, family, know people or entities, co-workers, classmates and like 1620 for publishing and subscribing each other.

Central unit receives and process including indexing, associating metadata, active links, advertisements and routing or sending or presenting said each posted publications of each user to each publication specific target users in network(s). Central unit dynamically presents 1609 each publications or shared contents of each publication types (categories publication type's specific tabs—1605) to receiving users. Each publication type specific publication contents present in different or customize ways and organize in different tabs or single tab and dynamically provide applications, services, objects, application features associate with each publication type in unified, integrated manner for facilitating user to manage, view, edit, process, re-share or forward, reply, organize, sort, filter, search, match, provide ranks & comments and take one or more actions.

User can 1606 sort (1340), filter (1350), search & match (1360) and take one or more actions 1629 (1330) on all or selected one or more publications including messages, contents, active links, publishers or sources, active links, objects, applications, services, multimedia data, groups and like.

Publisher can publish each publication or message with one or more related active links and Publisher can also publish or upgrade default of global publisher or publication type or publication specific one or more objects, applications, services, widgets, multimedia data, web parts, portlets and micro sites 1625 which are searchable to other users and/or auto installed to receiving or subscribing user's profile page 1650. So subscribing user not only subscribe publisher user's publication including messages, updated status, news, photos, video but also subscribe publishing user's default & global active links associate objects, web parts, services, applications, widgets, multimedia data, social networks, groups which enables receiving or subscribing user to communicate, collaborate, provide response(s), provide service(s) including news, blogs, workflow, social networking, groups, e-commerce transaction, search, share, job & resume, posting and participate with publishing user's activities.

Publishing user can manage all publishing types' specific publications and publisher specific default & global active links and associate objects & data 1625. Publisher can view hit statistics & analytics including number of subscriber installed said active links and associate objects & data, number of subscriber views publications, number of published active links and associate objects & data, number of published publications and like. Publisher can apply privacy settings and other customization settings with one or more active links and associate objects & data and publications.

Various examples of various embodiments 1622, 1623, 1624 shows user's subscribed each publisher specific global & default one or more active links and associate objects and data. Example 1622 shows “News” category specific various applications, services & widgets, multimedia data, web parts, social networks, groups and associate data, privacy settings, customization settings, preferences and news search engine from news publishing type publishers which are subscribed by user or subscriber. Example 1623 shows “Deals & E-commerce” category specific various applications, services & widgets, multimedia data, web parts, social networks, groups and associate data, privacy settings, customization settings, preferences and products & services search engine from e-commerce publishing type publishers which are subscribed by user or subscriber. Example 1624 shows “Job_Site.Com” category specific various applications, services & widgets including job posting, resume posting & preference based jobs, multimedia data, web parts, social networks, groups and associate data, privacy settings, customization settings, preferences and jobs search engine from job or recruitment publishing type publishers which are subscribed by user or subscriber.

User can subscribe plurality publishing types of publishers and receives each subscribed types of publishing related publications and contents which are dynamically present to user as per publishing types 1605 and each publishing type associate default active links and associate objects & data 1625 are present to user, which provides all general features specific to said publishing type and facilitate user to manage, access, use, view, categories, organize, sort, filter, search, order, rank, bookmark, share, forward, reply, print, purchase, subscribe, remove, edit, provide comments & details, associate keywords, privacy settings & metadata, take one or more actions on said publishing type specific publication contents and like.

User can invoke active link associate objects & data by clicking on one or more active links, each active link associate one or more objects are invoked and presented in unified, integrated, customized, personalized manner. System can monitor, records, stores & log each user's each actions, activities, events, transactions associate with said active links and associate objects & data and present said log with analytics & hit statistics to user as well as publisher(s) of said active link(s) based on privacy settings and preferences.

User can 1606 categories, sort, share, bookmarks, drag-n-drop, search, filter, remove one or more said active links and associate objects and data. System can also organize and rank & order said categories active links based on number of times use, rank by user, mark as important, connections, transactions, and actions.

User can share selected user data and user profile with publishers, connected & selected users, 3^{rd} parties developers based on privacy settings & preferences.

User can install 1626 applications, active links, objects, multimedia contents and like with user profile from central unit, 3^{rd} parties developers, uploaded by user, shared by connected and like minded users and search, select and install from search engine & categories directories based on one or more criteria and preferences.

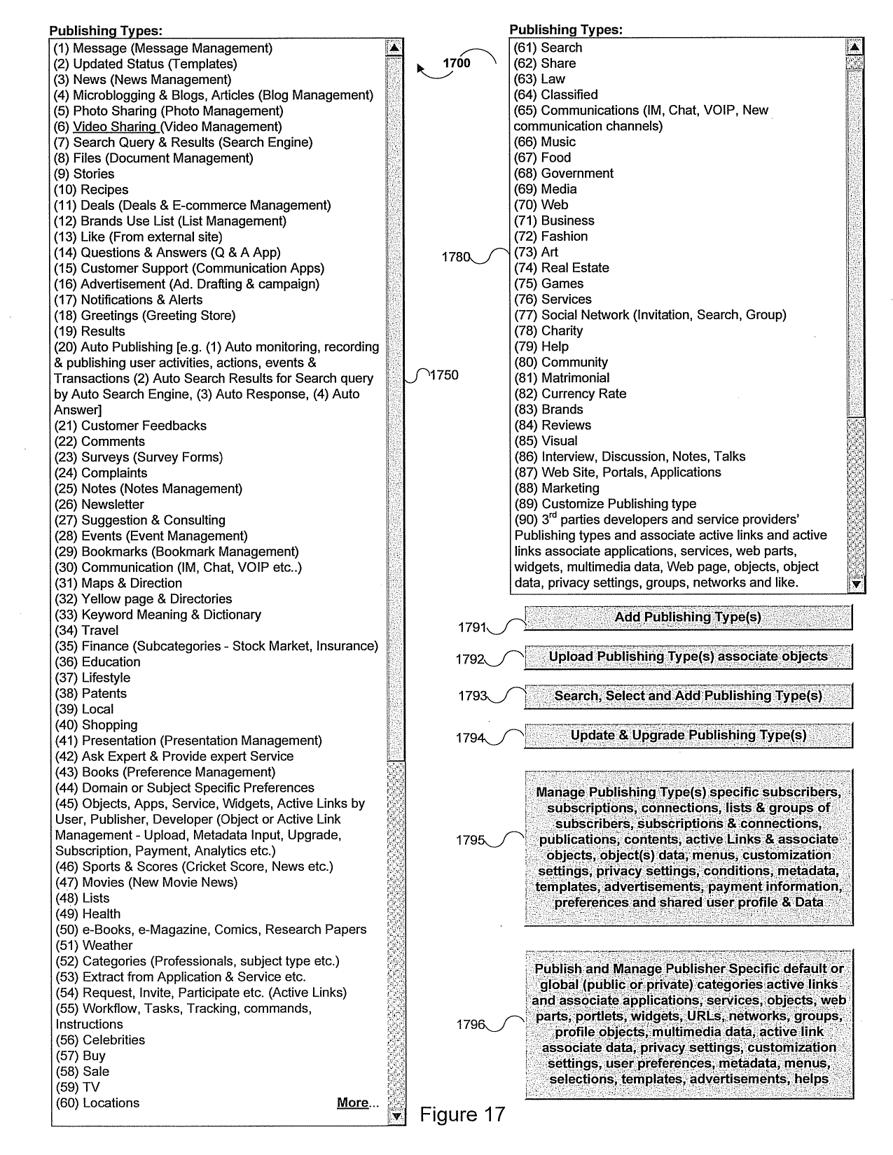

FIG. 17 illustrates an exemplary GUI 1700, which enables publishing user to select one or more Publishing types 1750 & 1780 and provides management for managing each Publishing types including publishing user can adds 1791 one or more publishing type(s) which are displayed in dynamic publishing type list 1601 or 1750 & 1780. User can upload 1792 publishing type(s) specific input system and associate list of active links, which are displayed to publisher user's dynamic input system area & active link attachment 1602 and upload or create & update one or more list of subscribers, subscriptions, connections, lists & groups, publications, contents, active links & associate objects, associate applications, services, application features, multimedia data, web page, widgets, web parts, portlets, plug-n-play, menus, shared user profile & data, customization settings, privacy settings, conditions, metadata, templates, advertisements, payment information and preferences which are displayed to publisher user's dynamic publishing type specific features area 1604.

Publisher user can manage 1796 and publish publisher, publication & publication type specific default or global (public or private) categories active links and associate applications, services, objects, web parts, portlets, widgets, URLs, networks, groups, profile objects, multimedia data, active link associate data, privacy settings, customization settings, user preferences, metadata, menus, selections, templates, advertisements, helps which are searchable and auto or manually installed or upgraded to subscriber user's profile page and displayed said active links and associate objects to subscribing or receiving user's profile area including default or global dynamic active links & associate objects from publishers area 1650. User can search, select and install or subscribe said one or more publisher, publication & publication type specific default or global (public or private) categories active links, associate objects & data or in one embodiment when user subscribe one or more publisher, said active links automatically or manually install or attached with subscriber user's profile page based on user privacy settings and preferences.

Publishing user can search, select and add one or more public publishing types 1793 and install all associate data, objects and settings based on one or more search criteria from search engine which are provided by other publishers, central unit and 3^{rd} parties' developers and service providers.

After installing public publishing types associate data, objects and settings, user can auto or manually upgrade and update said associate data, objects and settings 1794.

User can manage each Publishing Type(s) specific 1795 List of Subscribers, Subscriptions, Connections, Lists & Groups, Publications, Contents, Active Links & associate objects, menus, Shared user Profile & Data, customization settings, Privacy Settings, conditions, metadata, templates, advertisements, payment information and Preferences 1795, wherein management includes adding, updating, upgrading, ordering, sorting, categorizing, ranking, selecting, removing, publishing, attaching with publication, publication drafting and like.

In one embodiment, a method for communication in a network(s) environment comprising:
allowing each user to subscribe to each other user for receiving each publication of sender or publisher;
receiving and storing one or more user profiles, preferences, publication subscribers, publication subscriptions, dynamic relationships & connections, selections and privacy settings for sending and receiving publication and communication at a central unit;
determining one or more target subscribers by a sender;
allowing the sender to send each publication to the one or more target subscribers via a central unit;
receiving each publication with or without associated with one or more active links from the sender or publisher at the central unit, wherein said active links enables subscribers to access active links, communicate, provide response(s) & service(s), workflow, e-commerce transaction, participate with sender's one or more activities;
storing, indexing and processing said each publication with or without auto attaching one or more active links at the central unit wherein said active links enables subscribers to communicate, provide response(s) & service(s), workflow, e-commerce transaction, participate with sender's one or more activities;
determining one or more target subscribers by the central unit based on one or more preferences and subscriptions;
sending a representation of the each publication to the one or more target subscribers by the central unit;
presenting each publication in chronological order based on the preferences and privacy settings, subscriptions of target subscriber by the central unit; and
receiving, storing, indexing, ranking and processing said each public publication, related responses, active links & user actions for making the searchable for users and allow to search & subscribe source of publication based on at least part of message content and one or more predetermined criteria.

In one embodiment, publisher or sender or source can publish publication including messages, multimedia data, contents, active links and active link associate one or more objects, object associate data, privacy settings & metadata, wherein said active links enables subscribers and publishers to e-commerce, deals, transactions, marketing, advertisement, communication, collaboration, search, share, take one or more actions, games, provide & consume services including entertainment, travel, finance, sports, education, news, blog, maps, social networks, groups and other online services in a unified and integrated manner.

In one embodiment, auto installing and auto subscribing one or more active links of one or more publishers or sources to profile of subscriber or user's publisher page, wherein said one or more attached active links enables user to communicate, collaborate, answer, share, search, workflow, take one or more actions, transact, e-commerce, create social networks and participate with publisher or source. Auto installing and auto subscribing one or more active links of one or more publishers or sources based on user subscriptions with publisher(s), user and connected users' profile(s), data, message(s) & message(s) associate active links and installed applications & active links, user connections, user actions, activities, interest, behavior, transactions, events, preferences, privacy settings and auto match making.

In an another embodiment, user can install, attach & subscribe one or more active links of one or more publishers or sources with user profile or user's publisher page based on search, match, selection, bookmarks, suggestions, connections, preferences, privacy settings, message(s) & message(s) associate one or more active links, user profile & user data, user activities, actions, events & transactions, wherein said one or more attached active links enables user to communicate, collaborate, answer, share, search, workflow, take one or more actions, transact, e-commerce, create social networks and participate with publisher or source.

User can sort, filter, categories, groups, order, provide rank & comments, take one or more actions, apply privacy settings & customization settings to one or more active links, share profile, user data with active link associate objects and share active link associate object(s) data with publisher of active link(s).

In an embodiment, Active link comprising one or more applications, services, objects, shared objects, web parts, widgets, micro web sites, multi AI agents, multimedia data & contents, people, networks, groups, links or URLs, ID, User Profiles, profile objects, pages, attachments, informational links including advertisements, deals, lists, messages, web URL, multimedia data and shared workspaces for collaboration from networks and/or from external domains, applications, networks, services and devices with one or more associate metadata including name & ID, categories, keywords, date & time, description, help, properties, source, size, namespace & URL, payment information, privacy settings, customization information.

In one embodiment, each user can subscribe to any preferred users and send or share each message or publishing resources to each subscribers and/or publish in public, wherein message or publishing resource subscription based on selections, send request or invite others, connections, contacts, search people, find friends from contacts, search sources from message(s) associate source(s), search subscribers & subscriptions of each public user, one or two way match making preferences, rules, conditions, categories, taxonomy wise directories, lists, auto match based on preferences, profile, user data and user activities, actions, events & transactions.

In one embodiment, a method for dynamic publishing and subscribing in a network(s) environment comprising:
registering user with profile and enabled user to act as publisher and/or subscriber;
storing each registered user's subscribers, subscriptions, connections, privacy settings & preferences, subscribed and published one or more publications, contents, active links and associate objects & data;
allowing user to subscribe one or more publishers and/or one or more publication types of one or more publishers of network;
allowing publisher to dynamically publishing publications based on publishing type selections 1603 and publisher specific global & default active links and associate objects & data 1796;
dynamically presenting publishing type specific publishing input system, active links 1602 and application features for drafting & managing publications 1604;
allowing publisher to dynamically publishing each publication with or without active links to subscribers and connected users 1603; and
dynamically presenting said published publication 1605 with publishing type specific application features 1625 to target subscribers 1618 and connected users 1620 or auto installs or attach one or more publisher specific global & default active links and associate objects & data with subscriber's profile page 1650.

In one embodiment, subscriber of publisher can dynamically access publishing type specific publications based on dynamic publishing type specific presentation and application features and enables subscribers to dynamically access publisher specific global & default active links and associate objects & data.

In one embodiment, publisher can dynamically manage, add, edit, remove, upload, upgrade, search, select one or more publishing types, publishing type associate dynamic input system, active links and associate objects, applications, services, widgets, multimedia data, Web pages, profile objects, networks, groups and like, publishing type specific dynamic application features, publishing type specific subscribers, subscriptions, connections, privacy settings, customization settings, preferences, prospective publication contents & templates, metadata, shared profile & publisher data, rules & conditions, advertisement.

In one embodiment, publisher can dynamically manage, add, edit, remove, upload, upgrade, search, select publisher specific one or more global & default active links and associate objects & data including one or more applications, services, widgets, multimedia data, Web pages, profile objects, networks, groups, preferences, privacy settings, metadata, templates, conditions & rules, customization settings.

In one embodiment, subscriber of publisher can access each publication, take one or more actions on publications, view metadata, provide comments and rank, search, sort, categories, filter one or more publications and access publication associate active links, wherein said active links enables user to communicate, collaborate, search, share, give & receive response, create groups, social network, buy and sell, make payment & transactions, participate with publisher(s), 3^{rd} parties service providers and other users of network.

### VARIOUS EXAMPLES FOR VARIOUS EMBODIMENTS OF INVENTIONS

1. Publisher User Example: User [Y] registers with network [WW] with profile(s) for publishing publications and contents to any subscribed users and/or subscribing one or more types of publications from one or more publishers. Users of network [WW] are enabled to search and/or subscribe plurality of publishers including Publisher [Y] based on profile, publications, publication types & categories, active links and associate objects & data. Publisher User [Y] creates 20 connections 1620 based on invitations, find friends from network and has 10 subscribers 1618 from network. Publisher User [Y] can use default publications types 1601, 1750 & 1780, upload & add one or more new publication types & associate objects 1791 & 1792 and search, select and add one or more publication types from central search engine 1793. Publisher User [Y] can manage each publishing type specific each publishing 1795 and manage & publish publisher specific global, public or private & default active links and associate objects & data which are install, display or subscribed 1650 by each subscriber of publisher automatically with or without privacy settings & permission and/or manually based on subscription, searching, matching, preferences, privacy settings, interest, behavior, connections, selections, invitations, suggestion, user's activities, actions, events & transactions. Each said published global, public or private & default active links and associate objects & data are display to publisher's profile or publisher's page 1625 with hit statistics, analytics, where Publisher User [Y] can apply privacy settings, customization settings, view analytics & hit statistics, view logs of user activities, actions, events & transactions, communicate with subscribers, remove, edit, upload, update & upgrade one or more active links and associate objects & data.
   For example Publisher User [Y] selects dynamic publishing type 1601 (5) “Video Sharing” and system dynamically presents dynamic publishing type specific input system and associate active links 1602 for drafting, previewing publication & attaching message associate active links and system also dynamically presents dynamic publishing type specific application features & services 1604 for managing, processing publication contents, applying publishing privacy settings & preferences, associating metadata including categories, details, payment information, keywords, help and like, managing & creating publishing type specific subscribers, connections. For example when Publisher User [Y] selects dynamic publishing type 1601 (5) “Video Sharing” system displays video related application features and functionalities including video editor for editing video, record video for capturing video, video lists for selecting video for publication(s), video management, upload video and attaching one or more videos with publication or message. Publisher User [Y] draft message 1602 “My NYC travel videos with explanation” with attachments Videos select from Video list application feature 1604 and attach active links (1) View Video and (2) Video Album, selected from Active Links combo box 1602. Publisher User [Y] apply privacy settings, preferences and other settings with said message or video sharing type publication or sharing contents and post or send said message and associate data to subscribed users.
   Central unit receives, stores, indexes, process all publication contents of all publishers including Publisher User [Y] for making them searchable for other users and dynamically present 1605 said publication to all subscribers of publications and/or connected users. Receiving and viewing or subscribed User can access one or more said received publications, associate active links and utilize publication type specific features 1625 for managing publications. User can provide comments, ranks, action details on said one or more publications from one or more subscribed publishers. System monitors, records, logs, stores one or more user actions, events, transactions on said publications and send or present to related publisher(s) based on permission and privacy settings. Concurrently user can also use and access publisher specific one or more global & default active links and associate objects & data 1650 for subscribing, receiving one or more other services of publisher including use applications, play games, subscribe news service, view information, browse data, search, share, communicate, collaborate, participate with publisher and other users, make payment and purchase products & services. So users not only receive publications from subscribed publishers but also access, subscribe, and use other services of publishers.
2. Subscriber User Example:
   Central Unit registers the User [Y] with profile and enabled User [Y] to act as publisher and/or subscriber and stores each registered user's including User [Y]'s subscribers 1618, subscriptions 1619, connections 1620, privacy settings & preferences, subscribed and published one or more publications, contents, active links and associate objects & data and allow users including User [Y] to subscribe subscriptions of one or more publishers and/or one or more publication types of one or more publishers 1619 of network. Subscribing User [Y] receives each publications and/or publication type specific publications from one or more subscribed publishers 1605. System dynamically presents said each publication in tabular format which enables Subscribing User [Y] to dynamically access & manages each publishing type specific publication contents with associate application features 1625. User can sort, filter, search and select views for one or more publications and one or more publication types specific one or more publications 1606. User can take one or more actions on published and/or subscribed one or more publication contents 1629. User can expand and collapse tree and add, detach & remove one or more publications 1609. User can view user's own publications 1609 (1) or 1610 with subscribed publishers publications 1609 (1) to (8). User can select one or more publications and take one or more group actions on said selected one or more publications 1609 (1) to (8).
   Subscriber User [Y] publish publication 1609 (1) to subscribers 1618 and connected users 1620 which also present to User [Y] 1609 (1). Subscriber User [Y] can receives and views 1609 (2) to (8) all publications from all publishers 1625. For example Subscriber User [Y] subscribe to publisher “Super Mobile” and receives each publications from publisher “Super Mobile” including publishing type “Deals & E-commerce” related message 1609 (2) or 1611 with date & time, publishing type, ranks & hit statistics, categories, metadata, source, associate one or more accessible active links. User can access said active links for purchase mobile from super store and/or view presentation. User can take one or more actions on said message or publications and system monitors, records, stores, logs said one or more user's actions and present to user. User can use publishing type specific general application features 1625 and User can use, access and manage publisher specific global & default one or more active links and associate objects & data 1650, which enables user to access other services of publisher “Super Mobile” including view information, presentation, communicate with experts, subscriber newsletter and other publications & services and like. Another example 1609 (3) or 1612 where user receives various types of publications from categories publishers, Example 1609 (4) or 1613 shows user can receives one or more preferences based auto publications from central unit. Example 1609 (5) or 1614 show user can receives deals related messages from publisher “GroupOn™” with metadata and accessible active links which enables user to make offer and buy from publisher in unified, integrated manner. User receives publication contents from plurality of other publishers including publisher “Exchange Rate Service” 1609 (6) or 1615 for receiving daily dollar rate in rupees and attach active links enables user to buy and sell currencies, receiving message from publisher “Indian Air Lines” 1609 (7) or 1616 and news publisher “ABC News” 1609 (8) or 1617. User can access each said publisher's default & global active links and associate objects & data 1650 for receiving, subscribing, accessing more services of said each publishers including access full features e-commerce & deals applications, news services, list of news, book tickets, posting job or resume and receiving preference based jobs from publisher.

The above specification, examples, and data provide a complete description of the manufacture and use of the composition of the invention. Since many embodiments of the invention can be made without departing from the spirit and scope of the invention, the invention resides in the claims hereinafter appended

I claim:

1. The method of customize, contextual, dynamic, unified and integrated communication comprising:
allow sender to determine target receivers;
allow sender to dynamically associate one or more identified active links with active note (message) or with response of active note (message), wherein response based on at least part of active note (message);
allow sender to send or post said active note (message) or response of active note (message) with active link(s) to determined target receivers, wherein said active link(s) enables receivers to sell, purchase, transact, communicate, collaborate, search, share, workflow, provide response, participate in same activities as sender and access the active link(s) for message specific purpose in an integrated, contextual, customize and unified manner;
receiving and processing said active note (message) or response of active note (message) at the central unit; and
presenting said active note (message) or response of active note (message) to determined target receivers as per preferences & privacy settings.

2. The method according to claim 1, wherein said active note (message) sender and receiver/responder comprising digital sources including mobile, computer, video camera(s), RFID, touch screen, speech & text recognition system and automated sources, communication systems, imports from other systems, applications, services, devices and networks, multimedia content sources including image, video, file, extracts from video or voice, editor, wizard, search engine, survey, historical data, logs, sensor systems, multi Artificial Intelligence Agent(s), languages & translation system, speech or voice source(s) & paper forms, users of social network(s), human mind, experts, user's related groups, connected users, subscribers, 3rd parties and like minded users and one or more individuals, groups, collaboration of one or more pre-identified individuals comprising company, organization, professional and social bodies, web site, governmental bodies and enterprises, service providers, data and application providers and 3rd parties providers on behalf of animals, birds, non living things including tree, products, road, building, location, tourist place.

3. The method according to claim 1, wherein determine one or more target receivers and/or responders by sender based on selecting one or more connected users, connected users of connected users, subscribers, verified & expert service providers, all users (public) of network and determine by other users including user selected, connected, matched users.

4. The method according to claim 1, wherein auto determine one or more target receivers by the central unit by auto match making of receivers/responders based on active note (message) & associate metadata, sender and/or receiver's matchmaking preferences including filters, conditions, ranks, categories, keywords, sender profiles, sender privacy settings, user data, interest, behavior, available responders, responder profiles, responses of responders.

5. The method according to claim 1, wherein said active note (message) comprising multimedia content types including text, video, audio, image, file, application, service, URL or links, conditions, rules, structured list, wherein user and connected users on behalf of user can create, update and identify active note (message) and select from past active notes (messages).

6. The method according to claim 1, wherein said active note (message) comprising auto generating and auto posting active note (message) based on monitoring, tracking and recording of user actions, events, current location, transactions & activities, auto selection or extraction from user's life stream, auto extraction from video, auto identification, auto determination, auto detection and auto sense one or more active notes (messages) from one or more sources.

7. The method according to claim 6, wherein lifestream comprising user related chronological stream of categories digital resources provided & generated by user, connected users and auto generated, auto identified, auto detected, auto sensed user related resources based on user's activities, actions, events, current locations, transactions, extracted from recorded video, sensed by sensors.

8. The method according to claim 1, wherein said active note (message) associate accessible metadata and applied settings comprising one or more determined responders or receivers, preferences, date & time, title, priority types including high, normal, low, expiration date & time, keywords, categories, types, taxonomies, ontologies, source of active note, sender user profile, location(s), language(s), size, source id, source profile(s), privacy settings & preferences, dynamically attached one or more active links and auto generated active note further comprising motioning, recording, storing user's each activities, actions, events, transactions and identifying associate one or more accessible objects and sources from network.

9. The method according to claim 1, wherein user can create and update one or more categories lists of identified active links which are controlled by user and exist in social network based on user selection, uploaded by user, search & match, suggested & provided by connected & matched users, suggested list or auto generated by central unit based on user profiles, user data, user activities, recorded user's actions, past responses, interest, list of active links, list of active links of connected users, installed applications and provided by 3^{rd} parties developers, service providers and advertisers based on users privacy settings and preferences.

10. The method according to claim 1, wherein sender can search, select, identify and manually attach or auto attach one or more active links with said active note (message) or response of active note (message), wherein said one or more attached active links enables receivers and/or responders to provide one or more responses & actions, communicate, collaborate, answer, share, search, workflow, take one or more actions, transact, e-commerce, social networking and participating activities of sender of message.

11. The method according to claim 1, wherein said active link comprising one or more applications, services, objects, multi AI agents, multimedia data & contents, people, networks, groups, links or URLs, ID, User Profiles, profile objects, pages, attachments, informational links, shared workspaces for collaboration from networks and/or from external domains, applications, networks, services and devices with one or more associate data.

12. The method according to claim 11, wherein said associate data of active link comprising URL or namespace of each active link for identifying and allowing to access active link associate objects, applications, services, media data, people, entities, identities, profile, group, network, page & other objects of network, active link related one or more metadata, categories, keywords, sources, providers, details, descriptions, properties, links, attachments, features, upload, created & use date & time, help, identifier & profile(s) of sender & receiver of active link, active link associate tracking status & status, active link associate object related user data and preferences, security policies, authentication information and privacy settings of accessing & sharing active link and active link associate object(s) related user data.

13. The method according to claim 12, wherein said associate tracking status & status of active link and user of active link comprising pending, online, offline, transacting, transaction complete, using, downloading, viewed, install and other active link associate tracking status & status.

14. The method according to claim 12, wherein one or more senders and receivers of active link can share active link & active link associate objects and said object related at least part of user data with one or more users based on privacy settings for communication, grouping, workflow and collaboration.

15. The method according to claim 10, wherein said auto attaching & identifying one or more active links with active note (message) or response of active note (message) based on active note(s) and associate metadata, user profile, user data.

16. The method according to claim 10, wherein responder of active note (message) can attach one or more active links based on sender user's message, sender user's profile, sender user's data, sender user's connections, responder user's analysis, suggestion from other connected users of responders, auto match making and suggested by sender of message.

17. The method according to claim 1, wherein user can register and verify one or more active links including objects, profiles, accounts, identities, applications, services, multimedia media contents, networks, groups, connections, pages and other objects with central unit.

18. The method according to claim 1, wherein said active links & objects provided and host by the central unit and/or users and/or 3^{rd} parties developers, service providers and advertisers.

19. The method according to claim 1, wherein user can share selective user profiles and user data with application and services of network, 3^{rd} parties' application and services, connected & matched users based on privacy settings and user preferences.

20. The method according to claim 1, wherein said active links & objects manage and invoked in an integrated environment.

21. The method according to claim 1, wherein one or more active links are attached to active note (message) about sender user's posting of a question, and the said one or more active links enable the responder user to answer the question.

22. The method according to claim 1, wherein one or more active links are attached to active note (message) about sender user's sell of one or more brands, and the said one or more active links enable the responder user to buy said one or more brands.

23. The method according to claim 1, wherein one or more active links are attached to active note (message) about sender user's activities, and the said one or more active links enable the responder user to participate with sender user's activities.

24. The method according to claim 1, wherein the active note (message) comprises a story about user's and connected users' activities, where the activities are that the user installed particular application, join a group, add a photo, subscribe a service, post a message or blog, update status and automatically logged activities from existing or external networks(s).

25. The method according to claim 1, wherein the active note (message) comprises user's task, where the task is that the user want to purchase brand(s) or book movie tickets.

26. The method according to claim 1, wherein the active note (message) comprises user's e-commerce where the e-commerce is that the user wants to sell one or more branded products and services.

27. The method according to claim 1, wherein users of network can send, receive, share, search, bookmark, attach, access one or more active notes (messages), related responses, associate active links and user actions from 3^{rd} party web sites, applications, services, networks and devices.

28. The method according to claim 1, wherein the message comprises user's requirements where the requirements are that the user want collections of images regarding particular subject, search results for particular keywords(s), articles & blogs of particular categories, list & details of top mobiles.

29. The method according to claim 1, wherein the active note (message) comprises user's workflow where the workflow is that the user wants to collect money from customers.

30. The method according to claim 1, wherein responder of active note (message) can attach or associate one or more active links with response, wherein said one or more attached active links enables sender of active note (message) to communicate, collaborate, share, search, workflow, take one or more actions, transact and participating activities of responder.

31. The method according to claim 30, wherein one or more active links are attached to response of active note (message) about booking of tickets as per active note (message) or requirements of sender of active note (message), and the said one or more active links enable the sender of active note (message) or receiver of response to book the tickets.

32. The method according to claim 30, wherein one or more active links are attached to response about downloading collections of photos as per active note (message) or requirements of sender of active note (message) that the user want collections of photos regarding particular subject, and the said one or more active links enable the sender of active note (message) or receiver of response to download and view the collections of photos attachments in an integrated environment.

33. The method according to claim 30, wherein one or more active links are attached to response about book domain name as per active note (message) or requirements of sender of active note (message), and the said one or more active links enable the sender of active note (message) or receiver of response to search, book domain name(s).

34. The method according to claim 30, wherein one or more active links are attached to response about marketing report as per active note (message) or marketing task assignment of sender of active note (message), and the said one or more active links enable the sender of active note (message) or receiver of response to view the marketing reports and assignment.

35. The method according to claim 1, wherein receiving and processing said active note (message) or response of active note (message) at the central unit comprising storing, updating, indexing, validating & formatting including editing, clarifying, update details, spell checking, language & spam detecting, translating, transcribing, converting to other formats like voice, text, associating priority types including high, normal, low, expiration, date & time, categories, keywords, locations, advertisements, payment information, profile data, URL, dynamically attaching one or more active links & system data and determining one or more receivers of active note (message) or response of active note (message).

36. The method according to claim 1, wherein said privacy settings and preferences of sender and receiver comprising receive message only from one or more selected & connected users, receive message as per set date, time and duration range, receive message related to one or more categories, keywords, location, language, age range, education & qualification, income range.

37. The method according to claim 1, wherein enabling receiver of active note (massage) to access said active note (message) associate one or more active links.

38. The method according to claim 1, wherein enabling receiver of active note (massage) to provide response(s) for said received active note (massage), where response comprising media data and dynamically attach one or more identified active links.

39. The method according to claim 1, wherein receiving and processing said each response(s) from each responders of said active note (message) and presenting to the sender of said active note (message) as per privacy settings and preferences comprising receive response only from one or more selected & connected responders and experts, receive response date, time and duration range, receive response related to one or more categories, keywords, location, language, education & qualification.

40. The method according to claim 1, wherein enabling sender of active note (message) or receiver of response of active note (massage) to access said response associate one or more active links.

41. The method according to claim 1, wherein registering one or more responders with one or more service profiles for providing one or more response(s) and attaching active links with response(s) for one or more categories & types of active note(s), wherein said service profile comprising service details, categories, keywords, location, language, expertise, subject or domains, availability or date & timings, payment information, conditions or rules, privacy settings, preferences, one or more associated connections and subscription lists.

42. The method according to claim 1, wherein allow sender and receiver of active note (message) to take one or more actions on each active note (message), related responses and/or active links wherein said actions comprising attach or detach receivers or responders, active links, group members and forward, transfer, assign, search, match, share, filter, sort, order, group, categories, bookmark, add, update, delete one or more active notes, related each responses and active links, view logs, actions, transactions, events, activities & communications details, report spam, abuse & violation, set tracking status, provide comments & ranks, communicate with sender or receiver of messages, accessing of active links related each action details and provide user defined or auto recorded action details.

43. The method according to claim 42, wherein identifying, storing, ranking, processing & presenting said one or more user defined and system generated actions on said each active note (message), related responses and active links based on monitoring, recording, logging user actions & activities and one or more filters & privacy settings with action date & time, action categories, user provided or auto recorded action related details, action related response & message, one or more action source(s) including people, applications, services, shared workspace, media data or contents, objects, groups, networks, pages, items, links and any action related identified objects from network and/or external domains, attachments, lists, tracking status, further communication details, ratings or ranks, comments and user provided and/or dynamically associated one more active links, services, objects, media data, shared workspaces and applications.

44. The method according to claim 1, wherein receiving, storing, indexing, processing active notes (messages), related responses, active links and user actions & action associate logged data for making them searchable for other users based on one or more search criteria and/or send to subscribers or connected users of user based on sender & receiver user's privacy settings & preferences, wherein action associate said active links enable said one or more receiver users to access said active links and participate with sender user.

45. The method of customize, contextual, dynamic, unified and integrated communication comprising:
determine one or more target receivers and/or responders by sender and/or auto determined by central unit;
sending active note (message) with or without dynamically attaching one or more identified active links by sender and/or auto identifying, sending & attaching by central unit to one or more determined target receivers and/or responders, wherein said active links enables receiver and/or responder to communicate & collaborate with sender, provide response(s) & service(s) to sender, enabling workflow, e-commerce transaction, participate with sender's one or more activities and access active links;
receiving and processing said active note (message) at the central unit;
presenting said active note (message) to one or more target receivers and/or responders based on one or more preferences;
allow each said responders to send one or more responses for said active note (message) to sender of active note (message) with or without attaching one or more active links and/or auto attaching active links by central unit, wherein said active links enables receiver of response(s) to communicate & collaborate with responder, send active note (message), receive services, enabling workflow, participate with responder(s), make purchase transaction, e-commerce, view, share & search multimedia data & contents, solve any active note (message) specific solution and access active links;
allow user to take one or more actions on said active note (message) and/or related responses and/or associate active links;
identifying, monitoring, storing, recording, logging said one or more user actions based on one or more filters & privacy settings with action date & time, action categories, user provided or auto recorded action related details, action related data, responses & communications, one or more action source(s) including people, applications, services, shared workspace, media data or contents, objects, groups, networks, pages, items, links and any action related identified objects from network and/or external domains, attachments, lists, tracking status, further communication details, ratings or ranks, comments and user provided and/or dynamically associated one more active links, services, objects, media data, shared workspaces and applications; and
receiving, storing, indexing, ranking, processing said message, message related responses and actions & action associate logged data for making them searchable for other users and/or send to subscribers or connected users of user based on sender & receiver user's privacy settings & preferences, wherein action associate said active links enable said one or more receiver users to participate with sender user.

46. A method of processing an active note(s) and associate concept(s) comprising:
receiving and processing the active note (message) from the active note provider(s) or sender;
determining one or more target responders or receivers;
presenting or sending a representation of the active note (message) to one or more target responder(s) or receiver(s);
receiving and processing one or more multidimensional concept(s) and/or response(s) from one or more target responders or receivers; and
presenting or sending the multidimensional concept(s) and/or response(s) to the active note provider(s) or sender as per preferences.
selecting one or more concept(s);
send one or more concept with active note to related responder(s) and
receiving one or more response(s) from one or more responder(s) based on selected each concept(s) and related active note(s).

47. A method of managing active links comprising:
registering each user and storing each user's profile, connections and privacy settings;
registering and storing one or more active links and profile & metadata of active links by user, application & service providers and central unit;
maintaining in a database a plurality of said active links;
maintaining in a database each user related active links;
allow user to associate or attach one or more active links with message from said active links;
send message to determined one or more targeted receivers;
allow targeted receivers to access said active links or provide response and attaching one or more active link(s) with said response based on at least part of message;
allow user to take one or more actions on said message associate one or more active links and track one or more user actions on said message associate one or more active links; and
storing each message associate one or more active links with said tracked user actions on said message associate one or more active links.

48. A method of managing nodes and connections among nodes in a network comprising:
maintaining in a database a plurality of nodes of a social graph;
maintaining in a database a plurality of connections in the social graph, where each connection represents a connection between two or more nodes in the social graph;
maintaining in a database information about one or more of the nodes and connections;
providing an interface for users of the social network to send content items in one or more communication channels of the social network to determined one or more target receivers and/or responders;
receiving via the interface a said content item from a user of the social network, the said content item including a link referencing a node of the social graph; and
sending or presenting said content items in one or more communication channels of the social network to determined one or more target receivers and/or responders;
allow receivers and/or responders to send content items to sender of content items in response to received said content items including a link referencing a node of the social graph, wherein said referred links based on at least part of received content items;
tracking user actions on said link referencing a node of the social graph; and
receiving, storing, indexing, ranking, mapping, processing said content items, associate one or more links referencing a node(s) of the social graph and related one or more tracked user actions.

49. A method for generating an active note, the method comprising:
allow user to filter pre-defined & pre-categories activities, actions, events, and transactions types;
monitoring a plurality of activities, actions, events, transactions of each user, said each user configurable to act as sender user and a receiver or responder user;
storing a plurality of said activities, actions, events, transactions in a data repository unit;
determine one or more target receivers and/or responders by user and/or auto determined by central unit;
generating a plurality of active notes or messages regarding one or more of the activities, actions, events, transactions of each user with or without associating one or more active links with said active note(s) or message(s), wherein said active links enable receiver or responder users to communicate & collaborate with sender, access active links, provide response(s) & service(s) to sender, enabling workflow, e-commerce transaction and participate in at least one of the activities as performed by the sender;
filtering plurality of active notes for one or more determined receiver or responder users; and
presenting one or more active notes or messages to said determined target receivers or responders.

50. A method for communication in a network(s) environment comprising:
allowing each user to subscribe to each other user for receiving each active note (message) of sender or publisher;
receiving and storing one or more user profiles, preferences, active note (message) subscribers, active note (message) subscriptions, dynamic relationships & connections, selections and privacy settings for sending and receiving active notes (messages) and communication at a central unit;
determining one or more target subscribers by a sender;
allowing the sender to send each active note (message) to the one or more target subscribers via a central unit;
receiving each active note (message) with or without associated with one or more active links from the sender or publisher at the central unit, wherein said active links enables subscribers to access active links, communicate, provide response(s) & service(s), workflow, e-commerce transaction, participate with sender's one or more activities;
storing, indexing and processing said each active note (message) with or without auto attaching one or more active links at the central unit wherein said active links enables subscribers to communicate, provide response(s) & service(s), workflow, e-commerce transaction, participate with sender's one or more activities;
determining one or more target subscribers by the central unit based on one or more preferences and subscriptions;
sending a representation of the each active note (message) to the one or more target subscribers by the central unit;
presenting each active note (message) in chronological order based on the preferences and privacy settings, subscriptions of target subscriber by the central unit; and
receiving, storing, indexing, ranking and processing said each public active note (message), related responses, active links & user actions for making the searchable for users and allow to search & subscribe source of active note (message) publication based on at least part of message content and one or more predetermined criteria.

51. A method for communicating in a social network about active notes and/or activities or actions from an external domain comprising:
maintaining a profile for a plurality of users of the social network, each profile comprising profile data, privacy settings and connections to each of a plurality of other users of the social network;
determine one or more target receivers and/or responders by user and/or auto determined by central unit;
receiving a plurality of user posted active notes with or without attaching one or more active links by user and/or auto attaching by central unit from the external domain, each active notes representing user posted active note or an action taken by a user of the social network in the external domain, wherein said active links enables receiver and/or responder to access active links, communicate, provide response(s) & service(s), workflow, e-commerce transaction, participate with sender's one or more activities;
receiving & processing said active notes and/or logging or recording the actions at the social network, each logged action including information about the action; and
generating one or more messages wherein each of said messages represents one or more of said recorded actions; and
presenting said active note(s) and/or generated messages to each determined target receivers and/or responders.

52. A method for dynamically creating groups for active note(s), related responses, communication in a network environment, the method comprising:
receiving and storing users profiles, real time location information of users, preferences, connections, selections, privacy settings at the central unit;
determining one or more users for dynamically created or user created & updated one or more groups based on active note(s), related responses, active links & user actions and associate categories, keywords & metadata, match making of users preferences, real time location information based on wireless devices and wired devices, date & time, online availability of users, bookmarked active note providers or responders, one or more accepted invitations, permissions for joining the group, conditions, searching & matching, selected connections, subscriptions & selections of users, privacy settings, user profiles & data, interest & activity types, filters and any combinations thereof and/or based on one or more users auto match by the central unit;
allowing members of said one or more groups to post active notes, provide & receive responses, attach and access active links, establish communication, create social network(s), provide service(s), collaborate, bookmark, rank, search and share multimedia contents.

53. The method of displaying active notes, related responses, active links and user actions in a social network, the method comprising:
receiving by a social network a plurality of active notes, related responses, active links and user actions from users of the social network;
providing a user interface to a user of the social network;
displaying in the user interface some of the active notes, related responses, active links and user actions received from users in the social network;
providing to the user one or more selectable filters, each filter specifying a criteria to be applied to the active notes, related responses, active links and user actions;
receiving a selection of a filter from the user; and
updating or presenting said active notes, related responses, active links and user actions based on the said received selected filter and presenting said one or more updated active notes, related responses, active links and user actions.

54. A method for managing unified communications and collaboration for one or more active notes, the method comprising:
receiving from one or more users of a social network a request to initiate a new communication for one or more active notes;
initiating a plurality of new communications responsive to the requests,
for each of a plurality of the communications, receiving requests from one or more users of the social network to join the communications;
attaching users to the communications responsive to the requests to join;
receiving active notes, related responses, active links, user actions & communication data from a plurality of the users in connection with one or more of the active notes related communications,
for each communication, presenting to each member of said communication the plurality of active notes, related responses, active links, user actions & communication data received for the communication in a tree style or format based on one or more preferences and privacy settings.

55. A method of zero click advertisement comprising:
receiving and storing plurality of advertisement requests, each advertisement request comprising an advertisement, advertisement content, targeting criteria and one or more responders on behalf of advertisers to receive one or more active notes (messages) from target customers of the network based on matching at least part of each active note (message) posted by each user including keywords, metadata & attachments with each advertisement keyword(s), advertisement, targeting criteria and contents;
sending or posting active note (message) with or without active link(s) by sender or auto send by central unit to one or more determined target receivers and/or responders by sender and/or to auto determined by central unit;
receiving and processing said active note (message) at the central unit;
matching at least part of active note (message) including keywords, metadata & attachments with each advertisement keyword(s), targeting criteria and contents for enabled to further determine responders including send or present active note (message) to each matched advertisement associate responder(s) and charging each matched advertisement or advertiser based on pay per advertisement related keyword(s) matched in each active note (message) of each sender user and receive said matched & relevant active note (message) from target customers;
sending or presenting active note (message) to determined one or more target receivers and/or responders including one or more responders associate with said matched advertisement content, determined by user and auto matched by central unit;
calculate number of target receivers and/or responders that received said active note (message) for enabled to charging said each matched advertisements;
allow to each receiver to access active note (message) associate active link(s) or allow to each responder to send one or more response with or without active link(s) to sender;
calculate number of responses and communication of all responders of said message for enabled to charging said each matched advertisements;
sending each provided responses with or without Active links from each responders to sender;
enable to sender of active note (message) to access response and associate active link(s); and
receiving, monitoring, tracking & storing each actions taken by sender of active note (message), receiver(s) or responder(s) of active note (message) and central unit on said active note (message), related response(s) and active link(s) and based on that calculating number of actions, number of hits or clicks, amount of transactions, type of actions, interactions & transactions for enabled to charging said each matched advertisements.

56. The method according to claim 55, wherein said advertisement content comprising one or more target criteria, keywords, brand name(s), identities, product and service name, location, language, details, description text, media data including URL or links, video, image, documents, associate registered active links, list of responders, daily budget of advertisement, bid amount for particular keyword(s).

57. The method according to claim 56, wherein said advertisement associate one or more active links enables user(s) to buy & sell products, make payment or transaction, communicate, collaborate, view presentation or media data, search, share, participate, workflow, refer to other users, e-commerce, make order, book tickets, view said advertisement, make deal, bidding for products and services, join group, install application, receives discount vouchers, fill survey forms, subscribe newsletters, bookmark product(s) or service(s), negotiate with advertiser, managing buying and selling process or activities.

58. The method according to claim 56, wherein enable to charging to advertisement of advertiser further based on list of responders mentioned in advertisement content receives number of messages, wherein message or part of message matched with said advertisement content.

59. The method according to claim 55, wherein allow responder to present one or more active links mentioned in said advertisement based on matching part of message or keywords and metadata & attachments of message with each advertisement keyword(s), targeting criteria and contents and allow to attach said one or more active links with response for said message.

60. The method according to claim 58, wherein enable to charging to advertisement of advertiser further based on active links mentioned in advertisement content clicked by responder or response receiver.

61. The method according to claim 55, wherein enable to charging to advertisement of advertiser further based on number of times message, related response(s), associate active links share and forward to other users of network by sender(s) and/or responder(s) including connected & matched users, subscribers, other responders.

62. The method according to claim 1, wherein presenting or attaching an advertisement to a sender of active note (message) and receiver or responder user with or within active note(s) and/or related concepts and/or response during the sending, receiving, selecting, processing and presenting.

63. The method according to claim 1, wherein allowing a responder user accepting an active note(s) to designate the advertisement.

64. The method according to claim 1, wherein advertisers may bid for position and placement and timing of ads associated with keywords on the responder's GUI and the responder(s) can optionally pick which advertisement is presented.

65. A method of prospective customers search engine comprising:
a. receiving, storing, indexing, ordering, ranking and processing active notes and associate data from plurality of users;
b. identifying, storing & processing prospective customers related active notes based on said active notes and associate data including metadata, attachments, privacy settings, list of responders, responses, communications, active links and user actions;
c. receiving search query for searching prospective customers related active notes and associate data & active links;
d. presenting ranked & chronological search results to searching user based on matching search query with said identified prospective customers data for said search query comprising one or more identified active notes & associate data including active links related to one or more prospective customers, wherein said each active link(s) associate with active note enable searching user to provide response, communicate, collaborate, participate, make offer, provide deal, sale product or ecommerce, workflow, make transaction with buyer, negotiate, provide discount, share and provide media data & information to related prospective customer or sender of active note; and
e. notify each author or sender of each active note of search results about searching user searches, selects and received said search results related active notes and allow each author or sender of active note to communicate, collaborate, participate, accept offer, receive deal, buy product or ecommerce, make transaction with seller, negotiate with seller, ask or receive discount, share and receive media data & information with selective one or more active note receiver or seller with receivers based on said active note associate active link(s).

66. The method according to claim 65, wherein said active note (message) associate accessible data & metadata comprising one or more determined responders or receivers, preferences, date & time, title, priority types including high, normal, low, expiration date & time, keywords, categories, types, taxonomies, ontologies, source of active note, sender user profile, location(s), language(s), size, source id, source profile(s), privacy settings & preferences, dynamically attached one or more active links and auto generated active note further comprising motioning, recording, storing user's each activities, actions, events, transactions and identifying associate one or more accessible objects and sources from network.

67. The method according to claim 65, wherein said active links comprising one or more applications, services, objects, multimedia data & contents, people, networks, groups, links or URLs, ID, User Profiles, profile objects, Pages, attachments, informational links, shared workspaces from networks and/or from external domains, applications, networks, services and devices with one or more metadata.

68. A method of searching goods and services comprising:
a. receiving, storing, indexing, ordering, ranking and processing active notes and associate data from plurality of users;
b. identifying offering of goods and services related active notes based on said active notes and associate data including metadata, attachments, privacy settings, list of responders, responses, communications, active links and user actions;
c. receiving search query for searching offering of goods and services related active notes and associate data with active links;
d. presenting ranked & chronological search results to searching user based on matching search query with said identified offering of goods and services data for said search query comprising one or more identified active notes & associate data including active links related to one or more offering of goods and services, wherein said each active link(s) associate with active note enable searching user to communicate, collaborate, participate, accept offer, receive deal, buy product or ecommerce, make transaction with seller, negotiate with seller, ask or receive discount, share and receive media data & information from publisher of active note or seller of goods & services; and
notify each author or sender of each active note of search results about searching user searches, selects and received said search results related active notes and allow each author or sender of active note to provide response, communicate, collaborate, participate, make offer, provide deal, sale product or ecommerce, workflow, make transaction with buyer, negotiate, provide discount, share and provide media data & information to selected one or more active note receiver or buyer of goods & services based on said active note associate active link(s).

69. The method according to claim 70, wherein said active note (message) associate accessible data & metadata comprising one or more determined responders or receivers, preferences, date & time, title, priority types including high, normal, low, expiration date & time, keywords, categories, types, taxonomies, ontologies, source of active note, sender user profile, location(s), language(s), size, source id, source profile(s), privacy settings & preferences, dynamically attached one or more active links and auto generated active note further comprising motioning, recording, storing user's each activities, actions, events, transactions and identifying associate one or more accessible objects and sources from network.

70. The method according to claim 70, wherein said active links comprising one or more applications, services, objects, multimedia data & contents, people, networks, groups, links or URLs, ID, User Profiles, profile objects, Pages, attachments, informational links, shared workspaces from networks and/or from external domains, applications, networks, services and devices with one or more metadata.

71. A method of dynamic e-commerce in which an offer does not become valid until associate dynamic rules & conditions attained, comprising a network server, a microprocessor, a memory and computer software, said computer software being located in said memory and run by said microprocessor, said computer software comprising a dynamic e-commerce algorithm, wherein said dynamic e-commerce algorithm comprises the steps of:
allow seller to determine target receivers;
allow seller to post active note(s) about offering of goods & services with dynamic rules & conditions and one or more active links;
receive and process said active note(s); display said active note with one or more dynamic rules & conditions and active links over a network and send said active notes to user determined or auto matched users of network for a predetermined period of time for potential buyers to review;
allow said target receivers to receive said active note and/or allow users to search, browses, select, bookmark, forward said active note(s) about offering of goods & services;
allow users to accept one or more offering of goods & services;
receiving of acceptance of offering of goods & services by buyer users over the network for the predetermined period of time;
determining if the dynamic rules & conditions has been attained;
allow to further dynamically update the rules & conditions;
dynamically display updated rules & conditions associate status to users; and
informing each buyer that accepted the offer of goods & services whether or not the rules & conditions has been attained.

72. The method according to claim 71, wherein dynamic rules & conditions based on determined number of purchase or determined amount of purchase or determined duration within which purchase made or determined number of times purchases by buyer or group of buyers, total sale in particular duration, date & time range, location, income range, education & qualification, age range, gender, number of buying requests, number of points earned by user or group of users, one or more customize & user defined preferences, rules and conditions and any combination thereof at which time the discount offer price becomes valid.

73. The method according to claim 71, wherein dynamic rules & conditions comprising user's actions & activities, transactions, current location, and events at which time the discount offer price becomes valid.

74. The method according to claim 71, wherein said user's action & activities comprising participating with brand social network by user, win sports & contests, play game and achieve scores by user, pass in exam & get particular percentage of marks or scores, join group by user, install application, subscribe service, fill survey form(s), provide rank & comments, refer, sell, resell, communicate, forward active note(s) to one or more connected users by user.

75. The method according to claim 71, wherein said user's transactions comprising number of transactions, amount of transactions in particular duration, transaction by referred, connected users and any combination thereof.

76. The method according to claim 71, wherein said user's events comprising user's birthday, anniversary, festival, holiday, seasons, any event days, trigger of any events defined by buyer and seller, trigger of events by system including current like minded or matched online users or prospective customers.

77. The method according to claim 71, wherein determining a geographic location of the identified devices; and applying rules & conditions based on current location of one or more or group of users including private or public events like concert, tradeshows, business meetings, sporting event, weddings, rallies, tourist place, work place & class room and number of users at particular location, where the geographic location is provided by an access device or based on the location of an access device.

78. The system of customize, contextual, dynamic, unified and integrated communication comprising:
a. one or more senders adapted to determine target receivers, to dynamically associate one or more identified active links with active note (message) or with response of active note (message) based on at least part of active note (message), to send or post said active note (message) or response of active note (message) with active link(s) to determined target receivers, wherein said active link(s) enables receivers to sell, purchase, transact, communicate, collaborate, search, share, workflow, provide response, participate in same activities as sender and access the active link(s) for message specific purpose in an integrated, contextual, customize and unified manner; and
b. the central unit configured to receive and process said active note (message) or response of active note (message), to present said active note (message) or response of active note (message) to determined target receivers as per preferences & privacy settings.

79. The system according to claim 78, wherein said active note (message) sender and receiver/responder comprising digital sources including mobile, computer, video camera(s), RFID, touch screen, speech & text recognition system and automated sources, communication systems, imports from other systems, applications, services, devices and networks, multimedia content sources including image, video, file, extracts from video or voice, editor, wizard, search engine, survey, historical data, logs, sensor systems, multi Artificial Intelligence Agent(s), languages & translation system, speech or voice source(s) & paper forms, users of social network(s), human mind, experts, user's related groups, connected users, subscribers, 3rd parties and like minded users and one or more individuals, groups, collaboration of one or more pre-identified individuals comprising company, organization, professional and social bodies, web site, governmental bodies and enterprises, service providers, data and application providers and 3rd parties providers on behalf of animals, birds, non living things including tree, products, road, building, location, tourist place.

80. The system according to claim 78, wherein sender is adapted to determine one or more target receivers and/or responders based on selecting one or more connected users, connected users of connected users, subscribers, verified & expert service providers, all users (public) of network and determine by other users including user selected, connected, matched users.

81. The system according to claim 78, wherein central unit is configured to auto determine one or more target receivers by auto match making of receivers/responders based on active note (message) & associate metadata, sender and/or receiver's matchmaking preferences including filters, conditions, ranks, categories, keywords, sender profiles, sender privacy settings, user data, interest, behavior, available responders, responder profiles, responses of responders.

82. The system according to claim 78, wherein active note (message) comprising multimedia content types including text, video, audio, image, file, application, service, URL or links, conditions, rules, structured list, wherein user and connected users on behalf of user is configured to create, update and identify active note (message), select from past active notes (messages).

83. The system according to claim 78, wherein said auto generating and auto posting active note (message) module is configured to monitor, track and record each user's actions, events, current location, transactions & activities and auto generate active notes (messages) and configured to auto select or extract from user's life stream, auto extract from video, auto identify, auto determine, auto detect and auto sense one or more active notes (messages) from one or more sources.

84. The system according to claim 83, wherein said user lifestream is configured to manage user related chronological stream of categories digital resources provided & generated by user, connected users and auto generated, auto identified, auto detected, auto sensed user related resources based on user's activities, actions, events, current locations, transactions, extracted from recorded video, sensed by sensors.

85. The system according to claim 78, wherein said active note (message) associate accessible metadata and applied settings comprising one or more determined responders or receivers, preferences, date & time, title, priority types including high, normal, low, expiration date & time, keywords, categories, types, taxonomies, ontologies, source of active note, sender user profile, location(s), language(s), size, source id, source profile(s), privacy settings & preferences, dynamically attached one or more active links and auto generated active note further comprising motioning, recording, storing user's each activities, actions, events, transactions and identifying associate one or more accessible objects and sources from network.

86. The system according to claim 78, wherein user is configured to create and update one or more categories lists of identified active links which are controlled by user and exist in social network based on user selection, uploaded by user, search & match, suggested & provided by connected & matched users, suggested list or auto generated list by central unit based on user profiles, user data, user activities, recorded user's actions, past responses, interest, list of active links, list of active links of connected users, installed applications and provided by 3^{rd} parties developers, service providers and advertisers based on users privacy settings and preferences.

87. The system according to claim 78, wherein sender is adapted to search, select, identify and manually attach or auto attach one or more active links with said active note (message) or response of active note (message), wherein said one or more attached active links enables receivers and/or responders to provide one or more responses & actions, communicate, collaborate, answer, share, search, workflow, take one or more actions, transact, e-commerce, social networking and participating activities of sender of message.

88. The system according to claim 78, wherein said active link comprising one or more applications, services, objects, multi AI agents, multimedia data & contents, people, networks, groups, links or URLs, ID, User Profiles, profile objects, pages, attachments, informational links, shared workspaces for collaboration from networks and/or from external domains, applications, networks, services and devices with one or more associate data.

89. The system according to claim 78, wherein said associate data of active link comprising URL or namespace of each active link for identifying and allowing to access active link associate objects, applications, services, media data, people, entities, identities, profile, group, network, page & other objects of network, active link related one or more metadata, categories, keywords, sources, providers, details, descriptions, properties, links, attachments, features, upload, created & use date & time, help, identifier & profile(s) of sender & receiver of active link, active link associate tracking status & status, active link associate object related user data and preferences, security policies, authentication information and privacy settings of accessing & sharing active link and active link associate object(s) related user data.

90. The system according to claim 89, wherein said associate tracking status & status of active link and user of active link comprising pending, online, offline, transacting, transaction complete, using, downloading, viewed, install and other active link associate tracking status & status.

91. The system according to claim 89, wherein one or more senders and receivers of active link enabled to share active link & active link associate objects and said object related at least part of user data with one or more users based on privacy settings for communication, grouping, workflow and collaboration.

92. The system according to claim 87, wherein said auto attach & identify one or more active links with active note (message) or response of active note (message) based on active note(s) and associate metadata, user profile, user data.

93. The system according to claim 87, wherein responder of active note (message) configured to attach one or more active links based on sender user's message, sender user's profile, sender user's data, sender user's connections, responder user's analysis, suggestion from other connected users of responders, auto match making and suggested by sender of message.

94. The system according to claim 78, wherein user is enabled to register and verify one or more active links including objects, profiles, accounts, identities, applications, services, multimedia media contents, networks, groups, connections, pages and other objects with central unit.

95. The system according to claim 78, wherein the central unit and/or users and/or 3^{rd} parties developers, service providers and advertisers are configured to said provide and host active links & objects.

96. The system according to claim 78, wherein users are enabled to share selective user profiles and user data with application and services of network, 3^{rd} parties' application and services, connected & matched users based on privacy settings and user preferences.

97. The system according to claim 78, wherein said active links & objects are configured to manage and invoked in an integrated environment.

98. The system according to claim 78, wherein users of network are enabled to send, receive, share, search, bookmark, attach, access one or more active notes (messages), related responses, associate active links and user actions from 3^{rd} party web sites, applications, services, networks and devices.

99. The system according to claim 78, wherein responder of active note (message) can attach or associate one or more active links with response, wherein said one or more attached active links enables sender of active note (message) to communicate, collaborate, share, search, workflow, take one or more actions, transact and participating activities of responder.

100. The system according to claim 78, wherein the central unit is configured to receive and process said active note (message) or response of active note (message) comprising storing, updating, indexing, validating & formatting including editing, clarifying, update details, spell checking, language & spam detecting, translating, transcribing, converting to other formats like voice, text, associating priority types including high, normal, low, expiration, date & time, categories, keywords, locations, advertisements, payment information, profile data, URL, dynamically attaching one or more active links & system data and determining one or more receivers of active note (message) or response of active note (message).

101. The system according to claim 78, wherein said privacy settings and preferences of sender and receiver comprises of receive message only from one or more selected & connected users, receive message as per set date, time and duration range, receive message related to one or more categories, keywords, location, language, age range, education & qualification, income range.

102. The system according to claim 78, wherein receiver of active note (massage) enabled to access said active note (message) associate one or more active links.

103. The system according to claim 78, wherein receiver of active note (massage) enabled to provide response(s) for said received active note (massage), where response comprising media data and dynamically attach one or more identified active links.

104. The system according to claim 78, wherein the central unit is configured to receive, process said each response(s) from each responders of said active note (message) and present to the sender of said active note (message) as per privacy settings and preferences comprising receive response only from one or more selected & connected responders and experts, receive response date, time and duration range, receive response related to one or more categories, keywords, location, language, education & qualification.

105. The system according to claim 78, wherein sender of active note (message) or receiver of response of active note (massage) is enabled to access said response associate one or more active links.

106. The system according to claim 78, wherein one or more responders are enabled to register with one or more service profiles to provide one or more response(s) and attach active links with response(s) for one or more categories & types of active note(s), wherein said service profile comprising service details, categories, keywords, location, language, expertise, subject or domains, availability or date & timings, payment information, conditions or rules, privacy settings, preferences, one or more associated connections and subscription lists.

107. The system according to claim 78, wherein sender and receiver of active note (message) are configured to take one or more actions on each active note (message), related responses and/or active links wherein said actions comprising attach or detach receivers or responders, active links, group members and forward, transfer, assign, search, match, share, filter, sort, order, group, categories, bookmark, add, update, delete one or more active notes, related each responses and active links, view logs, actions, transactions, events, activities & communications details, report spam, abuse & violation, set tracking status, provide comments & ranks, communicate with sender or receiver of messages, accessing of active links related each action details and provide user defined or auto recorded action details.

108. The system according to claim 107, wherein user and central unit are configured to identify, store, rank, process & present said one or more user defined and system generated actions on said each active note (message), related responses and active links based on monitoring, recording, logging user actions & activities and one or more filters & privacy settings with action date & time, action categories, user provided or auto recorded action related details, action related response & message, one or more action source(s) including people, applications, services, shared workspace, media data or contents, objects, groups, networks, pages, items, links and any action related identified objects from network and/or external domains, attachments, lists, tracking status, further communication details, ratings or ranks, comments and user provided and/or dynamically associated one more active links, services, objects, media data, shared workspaces and applications.

109. The system according to claim 78, wherein the central unit is configured to receive, store, index, process active notes (messages), related responses, active links and user actions & action associate logged data to make them searchable for other users based on one or more search criteria and/or send to subscribers or connected users of user based on sender & receiver user's privacy settings & preferences, wherein action associate said active links enable said one or more receiver users to access said active links and participate with sender user.

110. The system of customize, contextual, dynamic, unified and integrated communication comprising:
a. sender is configured to determine one or more target receivers and/or responders, to send active note (message) with or without dynamically attaching one or more identified active links to one or more determined target receivers and/or responders, wherein said active links enables receiver and/or responder to communicate & collaborate with sender, provide response(s) & service(s) to sender, enabling workflow, e-commerce transaction, participate with sender's one or more activities and access active links, to take one or more actions on said active note (message) and/or related responses and/or associate active links;
b. receiver/responder is configured to send one or more responses for said active note (message) to sender of active note (message) with or without attaching one or more active links, wherein said active links enables receiver of response(s) to communicate & collaborate with responder, send active note (message), receive services, enabling workflow, participate with responder(s), make purchase transaction, e-commerce, view, share & search multimedia data & contents, solve any active note (message) specific solution and access active links, to take one or more actions on said active note (message) and/or related responses and/or associate active links; and
c. the central unit is configured to auto determine one or more target receivers and/or responders, to auto identify, auto send active note (message) with or without dynamically attaching one or more identified active links to one or more determined target receivers and/or responders, wherein said active links enables receiver and/or responder to communicate & collaborate with sender, provide response(s) & service(s) to sender, enabling workflow, e-commerce transaction, participate with sender's one or more activities and access active links, to receive and process said active note (message), to present said active note (message) to one or more target receivers and/or responders based on one or more preferences, to process and auto attach one or more active links with response, to identify, monitor, store, record, log said one or more user actions based on one or more filters & privacy settings with action date & time, action categories, user provided or auto recorded action related details, action related data, responses & communications, one or more action source(s) including people, applications, services, shared workspace, media data or contents, objects, groups, networks, pages, items, links and any action related identified objects from network and/or external domains, attachments, lists, tracking status, further communication details, ratings or ranks, comments and user provided and/or dynamically associated one more active links, services, objects, media data, shared workspaces and applications, to receive, store, index, rank, process said message, message related responses and actions & action associate logged data for making them searchable for other users and/or send to subscribers or connected users of user based on sender & receiver user's privacy settings & preferences, wherein action associate said active links enable said one or more receiver users to participate with sender user.

111. A system of zero click advertisement comprising:
a. the central unit (web server) is configured to auto send or post active note (message) with or without active link(s) to one or more determined target receivers and/or responders, to receive and process said active note (message), to send or present active note (message) to determined one or more target receivers and/or responders including one or more responders associate with said matched advertisement content, determined by user and auto matched by central unit, to send each provided responses with or without active links from each responders to sender, to receive, monitor, track & store each actions taken by sender of active note (message), receiver(s) or responder(s) of active note (message) and central unit on said active note (message), related response(s) and active link(s) and based on that calculate number of actions, number of hits or clicks, amount of transactions, type of actions, interactions & transactions for enabled to charging said each matched advertisements;
b. the advertisement server coupled with central unit (web server) is configured to receive and store plurality of advertisement requests, each advertisement request comprising an advertisement, advertisement content, targeting criteria and one or more responders on behalf of advertisers to receive one or more active notes (messages) from target customers of the network based on matching at least part of each active note (message) posted by each user including keywords, metadata & attachments with each advertisement keyword(s), advertisement, targeting criteria and contents, to match at least part of active note (message) including keywords, metadata & attachments with each advertisement keyword(s), targeting criteria and contents for enabled to further determine responders including send or present active note (message) to each matched advertisement associate responder(s) and charging each matched advertisement or advertiser based on pay per advertisement related keyword(s) matched in each active note (message) of each sender user and receive said matched & relevant active note (message) from target customers, to calculate number of target receivers and/or responders that received said active note (message) for enabled to charging said each matched advertisements, to calculate number of responses and communication of all responders of said message for enabled to charging said each matched advertisements;
c. sender is configured to send or post active note (message) with or without active link(s) to one or more determined target receivers and/or responders, to access each response and associate active link(s) from each responder; and
d. receiver is configured to receive and access active note (message) associate active link(s), to send one or more response with or without active link(s) to sender.

112. The system according to claim 111, wherein said advertisement content comprising one or more target criteria, keywords, brand name(s), identities, product and service name, location, language, details, description text, media data including URL or links, video, image, documents, associate registered active links, list of responders, daily budget of advertisement, bid amount for particular keyword(s).

113. The system according to claim 112, wherein user is enabled to access advertisement associate one or more active links to buy & sell products, make payment or transaction, communicate, collaborate, view presentation or media data, search, share, participate, workflow, refer to other users, e-commerce, make order, book tickets, view said advertisement, make deal, bidding for products and services, join group, install application, receives discount vouchers, fill survey forms, subscribe newsletters, bookmark product(s) or service(s), negotiate with advertiser, managing buying and selling process or activities.

114. The system according to claim 112, wherein advertisement server coupled to central unit (web server) is enabled to charging to advertisement based on list of responders mentioned in advertisement content receives number of messages, wherein message or part of message matched with said advertisement content.

115. The system according to claim 111, wherein responder is enabled to present one or more active links mentioned in said advertisement based on matching part of message or keywords and metadata & attachments of message with each advertisement keyword(s), targeting criteria and contents and allow to attach said one or more said active links with response for said message.

116. The system according to claim 115, wherein advertisement server coupled to central unit (web server) is enabled to charging to advertisement based on active links mentioned in advertisement content clicked by responder or response receiver.

117. The system according to claim 111, wherein advertisement server coupled to central unit (web server) is enabled to charging to advertisement of advertiser based on number of times message, related response(s), associate active links share and forward to other users of network by sender(s) and/or responder(s) including connected & matched users, subscribers, other responders.
